(19) United States
(12) Patent Application Publication
(10) Pub. No.: US 2010/0021776 A1
(43) Pub. Date: Jan. 28, 2010

(54) COMPOSITES AND ELECTRODES FOR ELECTROCHEMICAL DEVICES AND PROCESSES FOR PRODUCING THE SAME

(75) Inventors: Ralph C. Dougherty, Tallahassee, FL (US); Matthew D. Merrill, Tallahassee, FL (US)

Correspondence Address: BRYAN CAVE LLP, 211 NORTH BROADWAY, SUITE 3600, ST. LOUIS, MO, 63102-2750, US

(73) Assignee: FLORIDA STATE UNIVERSITY RESEARCH FOUNDATION, INC., Tallahassee, FL (US)

(21) Appl. No.: 12/447,695

(22) PCT Filed: Nov. 1, 2007
(86) PCT No.: PCT/US07/83328

§ 371 Date: Jun. 5, 2009

Related U.S. Application Data
(60) Provisional application No. 60/856,409, filed on Nov. 3, 2006.
(60) Provisional application No. 60/856,429, filed on Nov. 3, 2006.

(51) Int. Cl. H01M 8/10; B05D 5/12; C25D 11/02; B32B 9/04; H01M 4/90

(52) U.S. Cl. 429/13; 427/126.3; 427/126.5; 427/126.6; 205/333; 428/704; 429/30; 429/40

(57) ABSTRACT

The present invention is directed to a composite including a substrate and a film deposited on a surface of the substrate, and processes for producing the composites. The deposited film includes at least one metal oxide having the formula: MₓO_{y}, wherein M is a first, second, or third row transition metal, x is a positive integer from 1 to 7. The film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K). Composites of the present invention may be used, for example, as electrodes in electrochemical devices.

### FIELD OF THE INVENTION

The present invention generally relates to composites, electrochemical catalysts, electrodes, electrochemical devices incorporating composites, and processes for producing composites for electrochemical devices.

### BACKGROUND OF THE INVENTION

Various types of electrochemical devices have been developed over the past few years for the production of electrical energy by electrochemical reaction and obversely for the consumption of electrical energy to effectuate electrochemical reactions. Many of these devices rely upon a reaction involving oxygen (e.g., air) or hydrogen as part of the mechanism to accomplish the desired result. For example, such devices may contain oxygen electrodes which are oxygen reducing cathodes in which oxygen is catalytically electroreduced, or such devices may contain hydrogen electrodes which are hydrogen oxidizing anodes in which hydrogen is catalytically electrooxidized. Alternatively, such devices may contain oxygen electrodes which catalyze the evolution of oxygen from water and/or may contain hydrogen electrodes which catalyze the evolution of hydrogen from water. In general, these electrodes are known in the art as oxygen electrodes and hydrogen electrodes. Thus, metal-oxygen batteries, metal-hydride batteries, metal-air batteries, electrolytic cells, fuel cells, electrolyzers, metal electrowinning devices, etc., are among the well-known electrochemical devices which may contain oxygen and/or hydrogen electrodes.

The voltage or potential that is required in the operation of an electrochemical cell such as an electrolytic cell includes the total of (1) the decomposition voltage of the compound being electrolyzed, (2) the voltage required to overcome the resistance of the electrolyte, and (3) the voltage required to overcome the resistance of the electrical connections within the cell. In addition, a potential known as “over-voltage” or “over-potential” is typically required in the operation of the cell. The electrode over-voltage is the difference between the thermodynamic potential of the oxygen and/or hydrogen evolving electrode (for instance, when utilized for water electrolysis in a strongly alkaline electrolyte) when the electrode is at equilibrium and the potential of an electrode on which oxygen and/or hydrogen is evolved due to an impressed electric current. The electrode over-voltage is related to such factors as the mechanism of oxygen and/or hydrogen evolution and desorption, the current density, the temperature and the composition of the electrolyte, the electrode material, and the surface area of the electrode.

In recent years, increasing attention has been directed toward improving the oxygen and/or hydrogen over-voltage characteristics of electrolytic cell electrodes, particularly those electrodes utilized in fuel cells and in the electrolysis of water. It has previously been proposed to use various compounds, commonly called electrochemical catalysts or electrocatalysts, both in order to increase the reaction rate of electrolytic reactions and also to make them take place closer to their thermodynamically predicted potentials. For example, the incorporation of such electrocatalysts into fuel cells enables the cells to operate near to their theoretical potentials even when substantial current is drawn from them, the electrocatalyst reducing the over-voltage for electrode reactions. Similarly, in water electrolysis cells, the incorporation of electrocatalysts reduces the minimum voltage necessary for electrolysis to occur and enables the voltage to be kept low as the rate of electrolysis is increased, thereby facilitating high operational efficiencies.

A water electrolysis cell having an alkaline electrolyte in which the electrode reactions may be written as:

2H₂O+2e⁻→H₂+2OH⁻

for hydrogen evolution, and

4OH⁻→O₂+2H₂O+4e⁻

for oxygen evolution, the overall cell reaction being,

2H₂O→2H₂+O₂

typically has a theoretical working voltage of 1.48 volts (25° C.). A hydrogen/oxygen fuel cell, in which the above electrolyte reactions are reversed and the net reaction is the formation of water, has a theoretical power producing voltage of 1.23 volts. Over-voltage in conventional cells performing the above electrochemical reactions can range from 0.2 to 0.5 V, or greater.

In addition to having a reduced or otherwise relatively low oxygen and/or hydrogen over-voltage, electrode substrates and catalysts for the above-described purposes are preferably constructed from materials which are stable, inexpensive, easy to fabricate, mechanically strong, and capable of withstanding the environmental conditions of the electrolytic cell, and particularly capable of resisting dissolution in an alkaline electrolyte. In general, the stability of a catalyst is a measure of the catalyst's ability to retain useful life, activity, and selectivity above predetermined levels in the presence of factors (such as, but not limited to, coking, poisoning, oxidation, reduction, thermal run-away, expansion-contraction, flow, handing, and charging of the catalyst) that can cause chemical, thermal, or mechanical degradation or decomposition.

The above problems are particularly acute in electrochemical cells used, for example, for the electrolysis of water to produce hydrogen and oxygen. Hydrogen is a versatile raw material and a desirable source of fuel and energy due to the clean and non-toxic nature of its combustion products. In addition, it is used, for example, in the fertilizer, metallurgical, and petrochemical industries. While demand for hydrogen is increasing, production costs from conventional sources are also increasing. Water is a natural resource which is readily and abundantly available and from which hydrogen can be produced by electrolysis. However, the cost, efficiency, and stability of the electrochemical catalysts used hitherto have detracted from the commercial viability of the water electrolysis technology. The poor efficiency, high over-voltage, and low levels of operational current density are also responsible for the high capital costs of water electrolyzers and the consequent high production costs of electrolytically produced hydrogen.

Although a variety of electrocatalytic compounds and electrodes including such compounds have been developed over the past several years, there are limitations on their effectiveness. In particular, oxygen over-voltage remains the largest source of energy loss in water electrolysis, and the electrochemical catalyst coatings on conventional electrodes are often compromised after only a few uses. Accordingly, a need remains for unique, highly stable electrocatalysts and electrodes incorporating the same which reduce the oxygen and/or hydrogen over-voltage and which are stable over a relatively long period of time.

### SUMMARY OF THE INVENTION

Among the various aspects of the present invention is the provision of a composite and a process for preparing the same. The composite includes a substrate or support, and a film containing at least one metal oxide having the formula: MₓO_{y}, wherein M is a first, second, or third row transition metal, x is a positive integer from 1 to 3, and y is a positive integer from 1 to 7. The film is ferromagnetic, ferrimagnetic, or both ferromagnetic and ferrimagnetic at temperatures greater than 0° C. and has a zero field magnetization of 0.001 emu/g at a temperature of 26.85° C. (300 K).

Briefly, therefore, the present invention is directed to a composite comprising a substrate having an electrically conductive region and a film deposited on a surface of the electrically conductive region, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

Another aspect of the present invention is directed to an electrode, the electrode comprising a layer deposited on a surface of an electrically conductive support, the layer containing at least one metal oxide having the formula: MₓO_{y}, wherein M is a first, second, or third row transition metal, x is a positive integer from 1 to 3, and y is a positive integer from 1 to 7, wherein the layer is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

Another aspect of the present invention is directed to a fuel cell comprising an anode, a cathode, a proton exchange membrane between the anode and the cathode, and an electrocatalyst for the catalytic oxidation of a hydrogen-containing fuel, the fuel cell characterized in that the electrocatalyst comprises a film deposited on a surface of an electrically conductive region of (i) the anode, (ii) the cathode, or (iii) both the anode and the cathode, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

Another aspect of the present invention is directed to a method for the electrochemical conversion of a hydrogen-containing fuel and oxygen to water and electricity in a fuel cell comprising an anode, a cathode, a proton exchange membrane between the anode and the cathode, and an electrically conductive external circuit connecting the anode and the cathode, the method comprising contacting the hydrogen-containing fuel with an electrocatalyst to catalytically oxidize the fuel, the method characterized in that the electrocatalyst comprises a film deposited on a surface of an electrically conductive region of (i) the anode, (ii) the cathode, or (iii) both the anode and the cathode, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

Other objects and features will be in part apparent and in part pointed out hereinafter.

### BRIEF DESCRIPTION OF THE DRAWINGS

FIG. 1A is a graph showing the transfer coefficient, α, of the Butler-Volmer model is determined by angles of the intersecting classical harmonic oscillators.

FIG. 1B depicts the α values for various scenarios where harmonic oscillators intersect (boxes) although the α value does not necessarily reflect reduction or oxidation reactions as illustrated.

FIG. 2 is graph showing a Tafel plot presenting the relationship of the log of current density, log(J), with over-potential considering a midpoint potential, V₀, of 0.399 V for water oxidation. The experimental data is generated from a linear voltammetry scan of a NiFe oxide electrode at a rate of 1 mV/sec in 1 M KOH.

FIG. 3 is graph showing a chrono potentiometry scan at a constant current density of 500 mA/cm² during one hour in 1 M KOH.

FIG. 4 is a graph showing the relationships of current density, J, to applied working potential as demonstrated by linear voltammetry scans at a rate of 1 mV/sec for selected composites and the platinum support in 1 M KOH. In the graph, each electrode includes an electrocatalytic film including a mixture of metal oxides having the formulae M¹O, (M²)₂O₃, (M³)₃O₄, and (L³)₃O₄. For the CoFe oxide electrode, M¹, M², M³, and L³ are selected from Co and Fe, provided L³ and M³ are not the same. For the NiFe oxide electrode, M¹, M², M³, and L³ are selected from Ni and Fe, provided L³ and M³ are not the same. For the NiCo oxide electrode, M¹, M², M³, and L³ are selected from Ni and Co, provided L³ and M³ are not the same. For the FeMn oxide electrode, M¹, M², M³, and L³ are selected from Fe and Mn, provided L³ and M³ are not the same. Pt refers to a platinum control.

FIG. 5 is a graph showing the relationships of current density, J, to applied working potential as demonstrated by linear voltammetry scans at a rate of 1 mV/sec of a NiFe oxide electrode in various electrolytes.

FIG. 6 is a graph showing a linear voltammetry scan at a rate of −5 mV/sec of a NiFe oxide electrode in 0.01 M KOH plus 1.0 M KCl solution.

FIG. 7 is a graph showing a Tafel plot for a NiFe₍ₐ₎ oxide catalyst and the kinetic data was collected with a linear voltammetry scan at a scan rate of 1 mV/sec in 1 M KOH, where E₀ was 0.399 V.

FIG. 8 is a graph showing the effect of electrodeposition current density on oxygen evolution catalytic performance by NiFe oxides in 1 M KOH. The NiFe oxides were deposited for 30 sec with a current density of: A=50 mA/cm² B=500 mA/cm².

FIG. 9 is a graph showing the relation of NiFe oxide oxygen evolution catalytic kinetics to the composition of hard anions in the electrodeposition solutions reported in Table 4. The catalysts created from compositions A-E were deposited at 250 mA/cm² for 30 sec and kinetics measured in 1 M KOH.

FIG. 10 is a graph showing a hydrogen evolution Tafel plot for a NiFe₍ₐ₎ oxide catalyst prepared from the electrodeposition conditions described in Table 1 and the kinetic data was collected with a linear voltammetry scan at a scan rate of −1 mV/sec in 1 M KOH, where E₀ was −0.945 V.

FIG. 11 is a graph showing the reciprocal of Rₗᵢₘ with respect to the molar concentration of the KOH electrolyte for oxygen evolution on a NiFe_{(b)} oxide catalyst.

FIG. 12 is a graph showing the cyclic voltammetry, 1 M KOH of a NiFe₍ₐ₎ oxide catalyst prepared according to Table 1 at: 1) 1 mV/sec between 0.600 and −1.300 V; 2) 200 mV/sec between 0.200 and −0.200 V; and 3) 200 mV/sec between −0.700 and −1.000 V.

FIG. 13 is a graph showing the relationship of current density, J, with respect to cyclic voltammetry velocity on a NiFe₍ₐ₎ oxide in 1 M KOH.

FIG. 14 is a graph showing a chrono potentiometry scan of a NiFe_{(b)} oxide catalyzing oxygen evolution at a current density of 500 mA/cm² for one hour in 1 M KOH

FIGS. 15A, 15B, 15C, and 15D are graphs showing electrical impedance spectroscopy (EIS) Nyquist plots of a NiFe oxide electrode in 1 M KOH at low working potentials (FIG. 15A), at medium working potentials (FIG. 15B), and the inductive loop (FIG. 15C). FIG. 15D is an EIS Nyquist plot of the pure platinum control in 1 M KOH.

FIG. 16 is a graph showing a plot of the resistance of charge transfer, R_{ct}, with respect to the reciprocal of current density, 1/J, as determined by EIS on a NiFe oxide electrode in 1 M KOH.

FIGS. 17A and 17B are graphs showing Bode plots of a NiFe oxide electrode in 1 M KOH which present the phase angle, θ (FIG. 17A), and the impedance resistance, Z (FIG. 17B), with respect to the log of frequency and the working potential.

FIG. 18 is a graph showing a plot of impedance potential, Q, against frequency and applied working potential on a NiFe oxide electrode in 1 M KOH.

FIGS. 19A and 19B are graphs showing electromagnetic wave signals from a NiFe oxide electrode in 1 M KOH with a 0.440 V applied working potential at high (FIG. 19A) and low (FIG. 19B) frequencies.

FIGS. 20A and 20B are scanning electron microscope (SEM) images showing the surface of a NiFe oxide electrode at 100× (FIG. 11A) and 2000× (FIG. 11B) magnification.

FIG. 21 is a graph showing a linear voltammetry scan at −1 mV/sec of a NiCu oxide electrode (i.e., the electrode includes an electrocatalytic film including a mixture of metal oxides having the formulae M¹O, (M²)₂O₃, (M³)₃O₄, and (L³)₃O₄, wherein M¹, M², M³, and L³ are selected from Ni and Cu, provided L³ and M³ are not the same) and of the platinum control in 1 M KOH.

FIG. 22 is a graph showing a Tafel plot considering a midpoint potential of −0.885 V for water reduction. The experimental data is generated from a linear voltammetry scan of a NiCu oxide electrode at a rate of −1 mV/sec in 1 M KOH.

FIG. 23 is a graph showing a comparison of the solution impedance potential, Qₛₒₗₙ, to the applied working potential on a NiFe oxide electrode in 1 M KOH.

FIG. 24 is a graph showing the proposed catalytic mechanisms of oxygen evolution on a NiFe oxide electrode in 1 M KOH.

FIGS. 25A and 25B are graphs showing the electric and magnetic components with respect to the log of frequency (FIG. 25A) and the applied working potential (FIG. 25B). The solution impedance potential, Qₛₒₗₙ, has been subtracted from FIGS. 25A and 25B.

FIG. 26A is a graph showing the XPS Ni 2p^{3/2} multiplet of the NiFe oxide catalysts of Table 5.

FIG. 26B is a graph showing the XPS Fe 2p^{3/2} multiplet of the NiFe oxide catalysts of Table 5.

FIG. 26C is a graph showing the XPS O 1s multiplet of the NiFe oxide catalysts of Table 5.

FIG. 27 is a graph showing the X-ray powder crystallography of the NiFe₍ₐ₎ oxide with and without the platinum support.

FIG. 28 is an image of the TEM diffraction pattern of an NiFe oxide

FIGS. 29A and 29B are TEM images of (A) an NiFe oxide at 1×10⁶× magnification and (B) the NiFe oxide deposited at 25 mA/cm² and without ammonium sulfate at 2×10⁵× magnification.

FIGS. 30A, 30B, and 30C are SEM images of the NiFe_{(b)} oxide catalyst at (A) 1×10² magnification (FIG. 30A) and (B) 2×10³ magnification (FIG. 30B), and the bare platinum support at (C) 2×10³ magnification (FIG. 30C).

FIG. 31 is a graph of SQUID field sweeps of NiFe oxide catalysts prepared according to Table 5 where A was prepared with ammonium sulfate, B was prepared with high current density, and C was prepared with both ammonium sulfate and high current density. The inset provides an enhanced perspective of the scale of magnetization of sample A.

FIG. 32 is a graph of SQUID temperature sweep at 100 gauss for the NiFe oxide sample C of Table 5.

FIG. 33 is a graph showing the phase angle, θ, with respect to both frequency and working potential for a NiFe oxide catalyst in 1 M KOH. The solid lines indicate the electrochemical potential of nickel and/or iron half-reactions while the dashed lines mark the ±5 mV boundary of the impedance signal amplitude. The grey area could not be measured due to current disjunction by the electrochemical workstation.

FIG. 34 is a graph showing a Tafel plot presenting the relationship of the log of current density, log(J), with over-potential considering a midpoint potential, V₀, of −0.945 V for water reduction. The experimental data is generated from a linear voltammetry scan of a NiV oxide electrode at a rate of 1 mV/sec in 1 M KOH.

FIG. 35 is graph showing a chrono potentiometry scan at a constant current density of 500 mA/cm² during one hour in 1 M KOH.

FIG. 36 is a graph showing the relationships of current density, J, to applied working potential as demonstrated by linear voltammetry scans at a rate of 1 mV/sec for selected composites and the platinum support in 1 M KOH.

FIGS. 37A, 37B, 37C, and 37D are graphs showing electrical impedance spectroscopy (EIS) Nyquist plots of a NiV oxide electrode in 1 M KOH at low working potentials (FIG. 37A), at medium working potentials (FIG. 37B), and the inductive loop (FIG. 37C). FIG. 37D is an EIS Nyquist plot of the pure platinum control in 1 M KOH.

FIG. 38 is a graph showing the phase angle measured during impedance spectroscopy with respect to the log of frequency and the working potential

FIG. 39 is a graph showing the effect of discharging the catalyst. A NiCo oxide catalyst is electrodeposited from a solution containing 9 mM NiSO₄, 9 mM CoSO₄, 75 mM NH₄ClO₄, and pH 5.7 at 250 mA/cm² for 30 s. Efficiency is measured with linear voltammetry scans at 3 mV/sec in 1 M KOH.

FIG. 40 is a graph showing the effect of the pH of the electrodeposition on hydrogen evolution catalytic efficiency for NiCo oxide catalysts. NiCo oxide catalysts are electrodeposited from solution containing 9 mM NiSO₄, 9 mM CoSO₄, 75 mM NH₄ClO₄, and various pHs (adjusted with NH₄OH or H₂SO₄) at 250 mA/cm² for 30 s. Efficiency is measured with linear voltammetry scans at 3 mV/sec in 1 M KOH after discharging the catalyst.

FIG. 41 is a graph showing the effect of the ammonium electrolyte concentration of the electrodeposition on hydrogen evolution catalytic efficiency for NiCo oxide catalysts. NiCo oxide catalyst is electrodeposited from a solution containing 9 mM NiSO₄, 9 mM CoSO₄, pH 5.7, and various concentrations of NH₄ClO₄, at 250 mA/cm², for 30 s. Efficiency is measured with a linear voltammetry scan at 3 mV/sec, in 1 M KOH; after discharging the catalyst.

FIG. 42 is a graph showing the hydrogen evolution catalytic efficiencies resulting from the initial screening process of first row transition metal elemental compositions. All catalysts were created under standard electrodeposition conditions and efficiency was measured with linear voltammetry scans at 3 mV/sec, in 1 M KOH, after discharging the catalyst.

FIG. 43 is a graph showing a Tafel plot of the NiV oxide hydrogen evolution catalytic efficiency after advanced screening. The NiV oxide was deposited at 250 mA/cm2 for 30 s from an electrodeposition solution containing 9 mM NiSO₄, 9 mM VOSO₄, 37.5 mM (NH₄)₂SO₄, and 50 mM C₂H₅OH adjusted to pH 2.5 with H₂SO₄. Efficiency is measured with linear voltammetry scans at 3 mV/sec, in 1 M KOH, after discharging the catalyst.

FIG. 44 is a graph showing the efficiency of water electrolysis using a NiV oxide cathode catalyst and a NiFe oxide anode catalyst deposited onto 20 cm² of platinum foil.

FIG. 45 is a graph showing exemplary inductive loop plots from electrochemical impedance spectroscopy (EIS) analysis of the composites of the present invention.

### DETAILED DESCRIPTION OF THE INVENTION

The present invention is directed to improved composites for use, e.g., in electrochemical devices. Among the various aspects of the present invention is a composite having a substrate or support and a film or layer containing at least one metal oxide, preferably a mixture of metal oxides, deposited on a surface of the support. The film (or at least a portion thereof) is ferromagnetic, ferrimagnetic, or both ferromagnetic and ferrimagnetic, and also has a zero field magnetization of 0.001 emu/g or greater at a temperature of 26.85° C. (300 K). The composites of the present invention may be used as electrodes (e.g., as an oxygen and/or a hydrogen electrode) in electrochemical devices such as water electrolyzers and fuel cells. Among the advantages of the present invention is the ability to efficiently catalyze a variety of electrochemical reactions. Further, over-voltage (e.g., oxygen over-voltage and/or hydrogen over-voltage) is substantially reduced in electrochemical devices through the use of the composites described herein, and the composites allow for the easy removal of hydrogen and oxygen in electrolysis devices such as water electrolyzers. In addition, the composites provide a relatively small contact resistance, and stably operate over a relatively long period of time.

Electrochemical Catalysts

The composites of the present invention include a deposited coating (e.g., a film or layer) on the surface of a substrate or support. As noted above, the deposited films contain at least one metal oxide, and preferably a mixture of metal oxides (i.e., multiple metal oxides such as two or more metal oxides, three or more metal oxides, four or more metal oxides, and so on). Where the film includes a mixture of metal oxides, the film may contain more than one oxide of the same metal, and may also contain one or more oxides of different metals.

All or substantially all of the metals of the metal oxides are transition metals; that is, groups 3 through 12 (according to the IUPAC Group numbering format) or groups IIIB through IIB (according to the Chemical Abstracts Service (CAS) numbering format). Preferably, the metal oxides are first, second, and third row transition metal oxides (i.e., oxides of chemical elements 21 to 30, 39 to 48, and 71 to 80, respectively). Accordingly, the transition metals for the various transition metal oxides may be selected from the group consisting of scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lanthanum (La), hafnium (Hf), tungsten (W), rhenium (Re), osmium (Os), iridium (Ir), platinum (Pt), gold (Au), and mercury (Hg).

The deposited films contain at least one metal oxide having the formula: MₓO_{y}, wherein M is a first, second, or third row transition metal, x is a positive integer from 1 to 3, and y is a positive integer from 1 to 7. The values for x and y generally vary depending on the oxidation state(s) of the particular metal(s) of the metal oxide (i.e., multiple oxidation states for a single metal ion are possible, and hence multiple metal oxides of the same metal may be present in the film). For each metal oxide having the formulae: MₓO_{y}, therefore, each x may independently be 1, 2, or 3, and each y may independently be 1, 2, 3, 4, 5, 6, or 7. Typically, x is 1, 2, or 3, and y is 1, 2, 3, 4, or 5. For identification purposes, multiple or mixtures (i.e., two or more) metal oxides having the formula: MₓO_{y} may be designated as (M¹)ₓO_{y}, (M²)ₓO_{y}, (M³)ₓO_{y}, (M⁴)ₓO_{y}, and so on, wherein each M, i.e., M¹, M², M³, M⁴, etc. are selected from first, second, and third row transition metals, each x is 1 to 3, respectively, and each y is 1 to 7, respectively.

In one embodiment, the deposited film contains a mixture of metal oxides, MₓO_{y}, corresponding to the formulae M¹O, (M²)₂O₃, and (M³)₃O₄, wherein each M, i.e., M¹, M², and M³, is independently selected from first, second, and third row transition metals, x is 1, 2, and 3, respectively, and y is 1, 3, and 4, respectively. In a particular embodiment in which the film contains a mixture of metal oxides, MₓO_{y}, corresponding to the formulae M¹O, (M²)₂O₃, and (M³)₃O₄, each M, i.e., M¹, M², and M³, is independently selected from first row transition metals, x is 1, 2, and 3, respectively, and y is 1, 3, and 4, respectively; more preferably in this embodiment M¹, M², and M³ are independently selected from the group consisting of Mn, Fe, Co, Ni, and Cu and combinations thereof. In another particular embodiment in which the film contains a mixture of metal oxides, MₓO_{y}, corresponding to the formulae M¹O, (M²)₂O₃, and (M³)₃O₄, each M, i.e., M¹, M², and M³, is independently selected from the group consisting of V, Cr, Mn, Fe, Co, Ni, and Cu. For example, M¹, M², and M³ may be selected from Ni, Co, and Fe and combinations thereof.

As noted above, M¹, M², and M³ of the formulae M¹O, (M²)₂O₃, and (M³)₃O₄ are independently selected from first, second, and third row transition metals. Thus, M¹, M², and M³ may be the same transition metal, M¹, M², and M³ may each be a different transition metal, or two of M¹, M², and M³ may be the same transition metal and the third of M¹, M², and M³ may be a different transition metal. In the latter two instances, i.e., where M¹, M², and M³ are different or where two of M¹, M², and M³ are the same and the third of M¹, M², and M³ is different, additional metal oxides may form during use of the composite (e.g., in an electrochemical device). By way of example, a composite of the present invention at rest (i.e., in stand-by mode) may include M¹O, (M²)₂O₃, and (M³)₃O₄, wherein M¹l, M², and M³ are different transition metals. During use of this composite, additional metal oxides may form in the mixture, the additional metal oxides having the formulae M²O, M³O, (M¹)₂O₃, (M³)₂O₃, (M¹)₃O₄, and (M²)₃O₄ due to the change in the oxidation state of the particular transition metal ion (i.e., one or more of M¹, M², and M³). The formation of additional metal oxides in this manner may further improve the catalytic efficiency of the film.

In a particular embodiment in which the film contains a mixture of metal oxides, MₓO_{y}, corresponding to the formulae M¹O, (M²)₂O₃, and (M³)₃O₄, each M, i.e., M¹, M², and M³, is the same and is selected from first row transition metals, x is 1, 2, and 3, respectively, and y is 1, 3, and 4, respectively; more preferably in this embodiment, M¹, M², and M³ are the same and are selected from the group consisting of Mn, Fe, Co, Ni, and Cu. Thus, for example, the film may contain one or more of (a) MnO, Mn₂O₃, and Mn₃O₄; (b) FeO, Fe₂O₃, and Fe₃O₄; (c) CoO, Co₂O₃, and Co₃O₄; (d) NiO, Ni₂O₃, and Ni₃O₄; and (e) CuO, Cu₂O₃, and Cu₃O₄. That is, the film may contain a mixture of metal oxides having the formulae: M¹O, (M²)₂O₃, and (M³)₃O₄, wherein (a) M¹, M², and M³ are Mn; (b) M¹, M², and M³ are Fe; (c) M¹

, M², and M³ are Co; (d) M¹, M², and M³ are Ni; and/or (e) M¹, M², and M³ are Cu.

In another particular embodiment in which the film contains a mixture of metal oxides, MₓO_{y}, corresponding to the formulae M¹O, (M²)₂O₃, and (M³)₃O₄, M¹, M², and M³ are the same and are selected from the group consisting of V, Cr, Mn, Fe, Co, Ni, and Cu, x is 1, 2, and 3, respectively, and y is 1, 3, and 4, respectively. Thus, for example, the film may contain one or more of (a) VO, V₂O₃, and V₃O₄; (b) CrO, Cr₂O₃, and Cr₃O₄; (c) MnO, Mn₂O₃, and Mn₃O₄; (d) FeO, Fe₂O₃, and Fe₃O₄; (e) CoO, Co₂O₃, and Co₃O₄; (f) NiO, Ni₂O₃, and Ni₃O₄; and/or (g) CuO, Cu₂O₃, and Cu₃O₄. That is, the film may contain a mixture of metal oxides having the formulae: M¹O, (M²)₂O₃, and (M³)₃O₄, wherein (a) M¹, M², and M³ are V; (b) M¹, M², and M³ are Cr; (c) M¹, M², and M³ are Mn; (d) M¹, M², and M³ are Fe; (e) M¹, M², and M³ are Co; (f) M¹, M², and M³ are Ni; and/or (g) M¹, M², and M³ are Cu.

In another embodiment, the film contains a mixture of metal oxides, MₓO_{y}, corresponding to the formulae M¹O, (M²)₂O₃, (M³)₃O₄, and (M⁴)O₂, wherein each M, i.e., M¹, M², M³, and M⁴, is independently selected from first, second, and third row transition metals, x is 1, 2, 3, and 1, respectively, and y is 1, 3, 4, and 2, respectively. In a particular embodiment in which the deposited film contains a mixture of metal oxides, MₓO_{y}, corresponding to the formulae: M¹O, (M²)₂O₃, (M³)₃O₄, and (M⁴)O₂, each M, i.e., M¹, M², M³, and M⁴, is independently selected from first row transition metals, x is 1, 2, 3, and 1, respectively, and y is 1, 3, 4, and 2, respectively; more preferably in this embodiment M¹, M², M³, and M⁴ are independently V, Cr, Mn, Fe, Co, Ni, and Cu. In another particular embodiment in which the deposited film contains a mixture of metal oxides, MₓO_{y}, corresponding to the formulae: M¹O, (M²)₂O₃, (M³)₃O₄, and (M⁴)O₂, each M, i.e., M¹, M², M³, and M⁴, is the same and is selected from the group consisting of V, Cr, Mn, Fe, Co, Ni, and Cu, x is 1, 2, 3, and 1, respectively, and y is 1, 3, 4, and 2, respectively. Thus, for example, the film may contain one or more of (a) VO, V₂O₃, V₃O₄, and VO₂; (b) CrO, Cr₂O₃, Cr₃O₄, and CrO₂; (c) MnO, Mn₂O₃, Mn₃O₄, and MnO₂; (d) FeO, Fe₂O₃, Fe₃O₄, and FeO₂; (e) CoO, Co₂O₃, Co₃O₄, and CoO₂; (f) NiO, Ni₂O₃, Ni₃O₄, and NiO₂; and/or (g) CuO, Cu₂O₃, Cu₃O₄, CuO₂. That is, the film may contain a mixture of metal oxides having the formulae: M¹O, (M²)₂O₃, (M³)₃O₄, and (M⁴)O₂, wherein (a) M¹, M², M³, and M⁴ are V; (b) M¹, M², M³, and M⁴ are Cr; (c) M¹, M², M³, and M⁴ are Mn; (d) M¹, M², M³, and M⁴ are Fe; (e) M¹, M², M³, and M⁴ are Co; (f) M¹, M², M³, and M⁴ are Ni; and/or (g) M¹, M², M³, and M⁴ are Cu.

In addition to the at least one metal oxide having the formula MₓO_{y} noted above, in some embodiments the film further contains at least one metal oxide having the formula: LₓO_{y}, wherein L is a first, second, or third row transition metal, x is a positive integer from 1 to 3, and y is a positive integer from 1 to 7, provided that M and L are not the same transition metal. Similar to the values for x and y in formula MₓO_{y} discussed above, the values for x and y in formula LₓO_{y} generally vary depending on the oxidation state(s) of the particular metal(s) present in the metal oxide (i.e., multiple oxidation states for a single metal ion are possible, and hence multiple metal oxides of the same metal may be present in the film). For each metal oxide having the formulae: LₓO_{y}, therefore, each x may independently be 1, 2, or 3, and each y may independently be 1, 2, 3, 4, 5, 6, or 7. Typically, x is 1, 2, or 3, and y is 1, 2, 3, 4, or 5. For identification purposes, multiple or mixtures (i.e., two or more) metal oxides having the formula: LₓOy may be designated as (L¹)ₓO_{y}, (L²)ₓO_{y}, (L³)ₓO_{y}, (L⁴)ₓO_{y}, and so on, wherein each L, i.e., L¹, L², L³, L⁴, etc. are selected from first, second, and third row transition metals, each x is 1 to 3, respectively, and each y is 1 to 7, respectively.

In one preferred embodiment, the film contains at least one metal oxide, MₓO_{y}, corresponding to the formulae: M¹O, (M²)₂O₃, (M³)₃O₄, and (M⁴)O₂; and at least one metal oxide LₓO_{y}, corresponding to the formulae: L¹O, (L²)₂O₃, (L³)₃O₄, and (L⁴)O₂; wherein each M and each L, i.e., M¹, M², M³, M⁴, L¹, L², L³, and L⁴, is independently selected from first, second, and third row transition metals, each x is 1, 2, 3, and 1, respectively, and each y is 1, 3, 4, and 2, respectively, provided that (i) M¹ and L¹; (ii) M² and L²; (iii) M³ and L³; and (iv) L⁴ and M⁴ are not the same transition metal. More preferably in this embodiment, M¹, M², M³, M⁴ L¹, L², L³, and L⁴ are independently selected from first row transition metals.

In another preferred embodiment, the film contains a mixture of metal oxides, MₓO_{y} and LₓO_{y}, corresponding to the formulae M¹O, (M²)₂O₃, (M³)₃O₄, and (L³)₃O₄, wherein M¹, M², M³, and L³ are independently selected from first, second, and third row transition metals, provided, however, that L³ and M³ are not the same transition metal.

Although L³ may not be the same transition metal as M³ in this embodiment, L³ may be the same transition metal as M¹ and M², or L³ may be a different transition metal than one or both of M¹ and M². In a particular embodiment, M¹ and M³ are the same and are selected from first, second, and third row transition metals, and M² and L³ are the same and are selected from first, second, and third row transition metals provided, however, that (i) M¹ and M², and (ii) M³ and L³ are not the same transition metal; preferably in this embodiment, M¹, M², M³, and L³ are selected from first row transition metals; more preferably from the group consisting of V, Cr, Mn, Fe, Co, Ni, and Cu and combinations thereof. For example, M¹ and M³ could be Ni and M² and L³ could be Fe, and vice versa. Similar to M¹, M², and M³ described above, where one or more of M¹, M², M³, and L³ are different, additional metal oxides may form in the films during use due to the change in oxidation state of the various transition metals (i.e., M¹, M², M³, and L³).

When the film contains a mixture of metal oxides, MₓO_{y} and LₓO_{y}, corresponding to the formulae: M¹O, (M²)₂O₃, (M³)₃O₄, and (L³)₃O₄, M¹ and M³ are preferably the same transition metal and M² and L³ are preferably the same transition metal, provided that (i) M¹ and M² and (ii) M³ and L³ are not the same transition metal. In a particular embodiment, M¹ and M³ are the same transition metal and are selected from first row transition metals; and M² and L³ are the same transition metal are selected from first row transition metals, provided that (i) M¹ and M² and (ii) M³ and L³ are not the same transition metal. In another particular embodiment, M¹ and M³ are the same transition metal and are selected from V, Cr, Mn, Fe, Co, Ni, and Cu; and M² and L³ are the same transition metal are selected from V, Cr, Mn, Fe, Co, Ni, and Cu, provided that (i) M¹ and M² and (ii) M³ and L³ are not the same transition metal.

In a preferred embodiment in which the film contains a mixture of metal oxides, MₓO_{y} and LₓO_{y}, corresponding to the formulae M¹O, (M²)₂O₃, (M³)₃O₄, and (L³)₃O, the film contains one or more of (1a) MnO, Fe₂O₃, Fe₃O₄, and Mn₃O₄; (1b) FeO, Mn₂O₃, Mn₃O₄, and Fe₃O₄; (2a) CoO, Fe₂O₃, Co₃O₄, and Fe₃O₄; (2b) FeO, Co₂O₃, Fe₃O₄, and Co₃O₄; (3a) NiO, Fe₂O₃, Ni₃O₄, and Fe₃O₄; (3b) FeO, Ni₂O₃, Fe₃O₄, and Ni₃O₄; (4a) NiO, Co₂O₃, Ni₃O₄, and Co₃O₄; (4b) CoO, Ni₂O₃, Co₃O₄, and Ni₃O₄; (5a) CuO, Fe₂O₃, Cu₃O₄, and Fe₃O₄; (5b) FeO, Cu₂O₃, Fe₃O₄, and Cu₃O₄; (6a) CuO, Ni₂O₃, Cu₃O₄, and Ni₃O₄; and (6b) NiO, Cu₂O₃, Ni₃O₄, and Cu₃O₄. For example, the film may contain a mixture of (3a) NiO, Fe₂O₃, Ni₃O₄, and Fe₃O₄ and (3b) FeO, Ni₂O₃, Fe₃O₄, and Ni₃O₄. That is, the film may contain a mixture of metal oxides having the formulae M¹O, (M²)₂O₃, (M³)₃O₄, and (L³)₃O₄, wherein (1a) M¹ and M³ are Mn, and M² and L³ are Fe; (1b) M¹ and M³ are Fe, and M² and L³ are Mn; (2a) M¹ and M³ are Co, and M² and L³ are Fe; (2b) M¹ and M³ are Fe, and M² and L³ are Co; (3a) M¹ and M³ are Ni, and M² and L³ are Fe; (3b) M¹ and M³ are Fe, and M² and L³ are Ni; (4a) M¹ and M³ are Ni, and M² and L³ are Co; (4b) M¹ and M³ are Co, and M² and L³ are Ni; (5a) M¹ and M³ are Cu, and M² and L³ are Fe; (5b) M¹ and M³ are Fe, and M² and L³ are Cu; (6a) M¹ and M³ are Cu, and M² and L³ are Ni; and/or (6b) M¹ and M³ are Ni, and M² and L³ are Cu.

In another preferred embodiment, the film contains a mixture of metal oxides, MₓO_{y} and LₓO_{y}, corresponding to the formulae: (M²)₂O₃, (M⁴)O₂, (L²)₂O₃, and (L⁴)O₂, wherein M², M⁴, L², and L⁴ are independently selected from first, second, or third row transition metals, provided that (i) M² and L², and (ii) M⁴ and L⁴ are not the same transition metal; more preferably in this embodiment, M², M⁴, L², and L⁴ are independently selected from first row transition metals, provided that (i) M² and L², and (ii) M⁴ and L⁴ are not the same transition metal. In a particular embodiment in which the film contains a mixture of metal oxides, MₓO_{y} and LₓO_{y}, corresponding to the formulae: (M²)₂O₃, (M⁴)O₂, (L²)₂O₃, and (L⁴)O₂, M² and M⁴ are the same transition metal and are selected from V, Cr, Mn, Fe, Co, Ni, and Cu; and L² and L⁴ are the same transition metal and are selected from V; Cr, Mn, Fe, Co, Ni, and Cu, provided that M² and L² are not the same transition metal. Thus, for example, the film may contain one or more of the group consisting of (7) Ni₂O₃, VO₂, NiO₂, and V₂O₃; (8) Ni₂O₃, CrO₂, NiO₂, and Cr₂O₃; (9) Co₂O₃, CuO₂, CoO₂, and Cu₂O₃; (10) Mn₂O₃, NiO₂, MnO₂, and Ni₂O₃; (11) Ni₂O₃, FeO₂, NiO₂, and Fe₂O₃; (12) Ni₂O₃, CoO₂, NiO₂, and Co₂O₃; and (13) Cu₂O₃, NiO₂, CuO₂, and Ni₂O₃. For example, the film may contain a mixture of (7) Ni₂O₃, VO₂, NiO₂, and V₂O₃. That is, the film may contain a mixture of metal oxides having the formulae (M²)₂O₃, (M⁴)O₂, (L²)₂O₃, and (L⁴)O₂, wherein (7) M² and L² are Ni and M⁴ and L⁴ are V; (8) M² and L² are Ni and M⁴ and L⁴ are Cr; (9) M² and L² are Co and M⁴ and L⁴ are Cu; (10) M² and L² are Mn and M⁴ and L⁴ are Ni; (11) M² and L² are Ni and M⁴ and L⁴ are Fe; (12) M² and L² are Ni and M⁴ and L⁴ are Co; and/or (13) M² and L² are Cu and M⁴ and L⁴ are Ni.

The amount of metal oxide contained in the film is not narrowly critical, provided that at least some metal oxide having the formulae: MₓO_{y}, wherein M, x, and y are defined above, is present. Similarly, in the embodiments in which the film contains a mixture of metal oxides (e.g., at least one metal oxide having the formula: M¹O, (M²)₂O₃, (M³)₃O₄, and (M⁴)O₂; and at least one metal oxide having the formula: L¹O, (L²)₂O₃, (L³)₃O₄, and (L⁴)O₂), varying amounts of each metal oxide may be present. During use of the composite in an electrochemical device, the amount of each metal oxide (i.e., M¹O, (M²)₂O₃, (M³)₃O₄ and (M⁴)O₂ and LO, (L²)₂O₃, (L³)₃O₄, and (L⁴)O₂, if present) may increase and decrease as the oxidation states of the various metal ions change and different and/or additional metal oxides are formed.

It has been discovered that deposited films containing the metal oxides and mixtures of metal oxides set forth in the various embodiments described herein can be employed as highly efficient and stable electrochemical catalysts for electrochemical reactions. As discussed in further detail below, the films may be used as electrocatalysts for hydrogen electrodes, for oxygen electrodes, or for both hydrogen and oxygen electrodes of an electrochemical device.

In addition to the mixture of metal oxides described above (e.g., one or more metal oxides having the formulae: MₓO_{y} and LₓO_{y} such as M¹O, (M²)₂O₃, (M³)₃O₄, and (M⁴)O₂, and L¹O, (L²)₂O₃, (L³)₃O₄, and (L⁴)O₂), the film may also include a variety of additional components, provided the additional components do not substantially affect the desirable properties of the film during stand-by mode or during operation. For instance, the film may include additional cations such as H⁺, Li⁺, Na⁺, K⁺, Mg²⁺, Ca²⁺, and the like. Typically, these cations are present in the film in relatively small amounts (for example, less than about half of the amount of oxygen atoms present in the film (e.g., in the mixture of metal oxides)). Additional components that may be present in the film include, for example, carbon atoms, nitrogen atoms, phosphorous atoms, sulfur atoms, and halide atoms such as chlorine, bromine, fluorine, and iodine. Typically, these additional components are present in relatively small amounts (e.g., less than about 5 atomic percent). These (and other) cations and additional components may be present in the film due to the particular processes and parameters thereof utilized to form the composites of the present invention.

The presence of the above-described metal oxide(s) and mixtures of metal oxides (e.g., one or more of M¹O, (M²)₂O₃, (M³)₃O₄, and (M⁴)O₂, and one or more of L¹O, (L²)₂O₃, (L³)₃O₄, and (M⁴)O₂, if present) may be detected, on the surface of the substrate or support, for example, by conventional electron impedance spectroscope (EIS) techniques. Characteristically, electrochemical catalysts including the mixture of metal oxides described above will demonstrate an inductive loop when analyzed by EIS. In general, the inductive loop occurs in EIS analysis of the electrochemical catalysts of the present invention at a frequency of about 10⁶ Hz, or less (e.g., 10⁵ Hz, 10⁴ Hz, 10³ Hz, or 10² Hz). In a particular embodiment, the inductive loop occurs in EIS analysis at a frequency of about 10⁵ Hz or less; more preferably in this embodiment, at a frequency of about 10^{4.5} Hz or less.

Suitable electrochemical impedance spectroscopy (EIS) techniques include, for example, potential EIS, galvanic EIS, and potential dynamic EIS. Potential electrochemical impedance spectroscopy, for example, is a technique where the working potential is applied as a voltage sine wave with specified amplitude and the resulting current sine wave is measured. The relationship between the resulting current sine wave and the applied voltage sine wave may then be compared. Generally, the peak of a sine wave provides a reference point on the wave. A vector may be used to mathematically define (e.g., by trigonometry) the relationship of the current sine wave peak with respect to the voltage sine wave peak. Impedance may then be measured through a range of frequencies and is therefore considered a spectroscopy. Alternatively, galvanic EIS refers to a technique in which the current is generally oscillated around a defined current and the oscillating voltage response is measured. Potential dynamic EIS refers to the technique in which the frequency is generally fixed and impedance is measured through a range of frequencies.

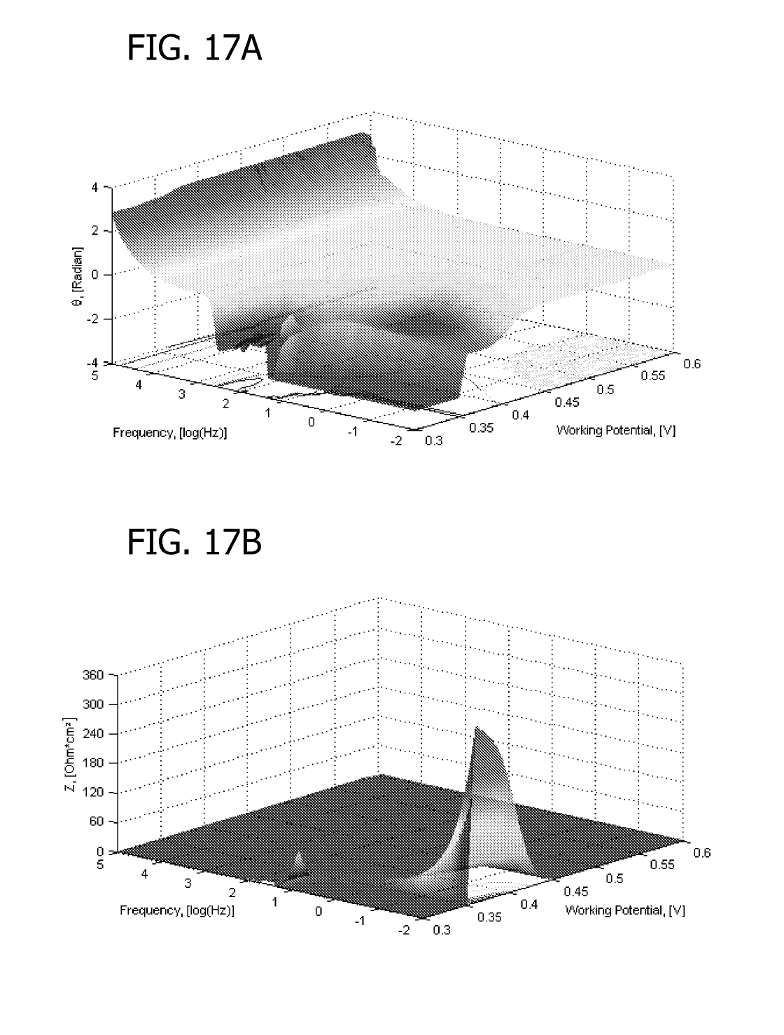

Data calculated by EIS are preferably presented in Nyquist plots, whereby the inductive loop can be visualized. In general, when the resulting current sine wave and the applied voltage sine wave are compared in a Nyquist plot, real impedance (Zᵣ) (Ohm*cm²) is plotted on the X-axis (where Zᵣ=Z*cos Θ) and imaginary impedance (−Zi) (Ohm*cm²) is plotted on the Y-axis (where Zᵢ=Z*sin Θ)). The inductive loop is characterized in that it forms an semi-circular arc around the point of intersection of two coordinate axes (i.e., at a 0,0 origin), a portion of the arc including coordinate values which are (a) negative, positive; (b) negative, negative; (c) positive, negative; and (d) positive, positive. That is, among the coordinate values for the inductive loop plot, (a) Zr is negative and −Zᵢ is positive; (b) Zᵣ is negative and Zᵢ is negative; (c) _{Zr} is positive and Zᵢ is negative; and (d) Zᵣ is positive and Zᵢ is negative. Thus, for example, the composites of the present invention may exhibit one or more of the inductive loops generally corresponding to A, B, C, and D in FIG. 17.

Other techniques that may be useful in detecting the presence of the above-described metal oxide(s) and mixtures of metal oxides are X-ray powder crystallography, electron spin resonance (ESR), electron paramagnetic resonance, neutron diffraction, Mossbauer spectroscopy, and scanning electron microscopy.

Without being bound to any particular theory, it appears that the film or layer containing the above-described metal oxide(s) and mixtures thereof is characterized as having spontaneous magnetic properties at temperatures greater than 0° C. (e.g., at least 5° C., at least 10° C., at least 15° C., at least 20° C., at least 25° C., at least 30° C., or greater); that is, the film or layer has a net magnetization in the absence of a magnetic field. In addition, it appears that there is more than one magnetic ion per primitive cell of the film material. Thus, the film (or at least a portion or region thereof) is ferromagnetic, ferrimagnetic, or both ferromagnetic and ferrimagnetic. In ferromagnetic portions of the film, if present, the electron spins in all or substantially all sites of a domain are aligned parallel. In ferrimagnetic portions of the film, if present, the electron spins in tetrahedral and octahedral sites of a domain are aligned antiparallel; the different numbers of electrons in the two sites generally leads to magnetic domains. The ferrimagnetic portions of the film exhibit spontaneous magnetism and other properties similar to the ferromagnetic portions of the film, but the spontaneous magnetization for the ferrimagnetic portions of the film typically does not correspond to the value expected for full parallel alignment of the magnetic dipoles in the film material.

The ferromagnetic, ferrimagnetic, or both ferromagnetic and ferrimagnetic films of the invention possess magnetization even in the absence of an applied magnetic field (i.e., a “zero field” magnetization). Typically, the film or layer has a zero field magnetization of 0.001 emu/g or greater at a temperature of 26.85° C. (300 K). Thus, for example, the film may have a zero field magnetization of about 0.01 emu/g, about 0.1 emu/g, about 1.0 emu/g, about 3.0 emu/g, about 5.0 emu/g, or about 10.0 emu/g at a temperature of 26.85° C. (300 K). In one embodiment, the film has a zero field magnetization of about 0.1 emu/g or greater at a temperature of 26.85° C. (300 K). In another embodiment, the film has a zero field magnetization of about 1.0 emu/g or greater at a temperature of 26.85° C. (300 K). Without being bound to any particular theory, it appears that the zero field magnetization of the films described herein is the result of the sum of the domain moments of all or substantially all of the domains in the film material (i.e., ferromagnetic, ferrimagnetic, or both ferromagnetic and ferrimagnetic domains as described above, as well as other anti-ferromagnetic domains, non-magnetic domains, paramagnetic domains, and the like, if present), which are randomly oriented and may, in some instances, cancel each other out.

Techniques and equipment for measuring the magnetization of the above-described films can include, for example, use of a SQUID (Superconducting QUantum Interference Device) magnetometer and other precision magnetometers.

Electrically Conductive Substrates

In the composites of the present invention, the above-described films are deposited on a surface of a substrate or support. At least some portion or region of the substrate is an electrically conductive material. Typically, a substantial portion of the substrate consists of an electrically conductive material; in some instances, the substrate or support is an electrically conductive material. The electrically conductive portions or regions are capable of containing movable charges of electricity when a current is applied thereto.

The choice of material for the substrate will generally depend on the particular application in which the composite will be used. A variety of electrically conductive materials may be included in the substrate to form an electrically conductive region including, but not limited to, metals such as aluminum, titanium, vanadium, chromium, manganese, iron, cobalt, nickel, copper, zinc, zirconium, niobium, molybdenum, ruthenium, rhodium, palladium, silver, tantalum, tungsten, osmium, iridium, platinum, gold, tin, and bismuth and metal oxides, mixtures of said metals and metal oxides, and alloys of said metals. For example, the electrically conductive material could be a nickel/iron alloy, a nickel/copper alloy, or stainless steel. In a particular embodiment, the electrically conductive material is platinum, titanium, nickel, stainless steel, and alloys thereof. Alternatively, electrically conductive non-metals such as graphite, ceramics, or electrically conductive plasmas and polymers may also be employed, alone or in combination with the electrically conductive metals discussed above.

Regardless of the particular electrically conductive material selected, the substrate is preferably constructed from materials which are, among a variety of attributes, inexpensive, mechanically strong, and capable of withstanding the environmental conditions of an electrochemical cell, and particularly capable of resisting dissolution in an alkaline electrolyte during stand-by mode or during operation and/or capable of resisting dissolution during the evolution of gas during operation. The electrochemical catalyst film may also be protective of the underlying substrate material (e.g., during current carrying conditions and/or stand-by mode) against the corrosive influence of an alkaline electrolyte.

In general, the substrate may be of any desired mechanical configuration depending on the technology employed or the use intended; that is, the substrate may be optionally adjusted to conform to the desired structure of an electrochemical device in which the composite will be used. For instance, the substrate may be in the form of a plate, a foraminous sheet, a foil sheet, a foam sheet, a net (e.g., an expanded metal), or a parallel screen type, each of which may be flat, curved, or cylindrical.

The thickness of the film is not narrowly critical. Thicker films are generally preferred, but may tend to be less mechanically stable over a certain thickness (e.g., over 1,000,000 nanometers (1 mm)). Other factors in the thickness of the film include the proportionally greater manufacturing costs and preparation times that may be employed to prepare thicker films. Typically, the thickness of the film will range from a few nanometers to several hundreds, thousands, tens of thousands, hundreds of thousands, or millions of nanometers. In one preferred embodiment, the film has a thickness of from about 5,000 to about 5,000,000 nanometers; more preferably in this embodiment, from about 50,000 to about 500,000 nanometers.

The porosity of the substrate generally depends on the particular substrate material chosen. In general, substrates having a greater surface area are preferred; excessive porosity, however, tends to lead to poor mechanical strength. Where the substrate material is not inherently porous, the substrate may be treated as described below (e.g., by etching) to roughen the substrate surface.

The chemical structure of the film is relatively disordered and the film contains a vast number of defects. In general, the disorder and/or the defects contribute to the electrical and ionic conductivity of the film when in use (e.g., as a catalyst). The disorder and/or the defects also contribute to the degeneracy of the film (that is, the film material includes metal oxides having a variety of energetically equivalent states), which can promote chemical activity and reactivity. Among other techniques, X-ray photoelectron spectroscopy (XPS), X-ray powder crystallography, and scanning electron microscopy (SEM) may be utilized to observe the defectiveness and the degeneracy of the film.

Electrochemical Devices Containing Composites

The composites of the present invention contain the above-described films as an electrocatalyst material. Advantageously, the films included in the composites are highly efficient catalysts for conventional electrolytic uses. More specifically, the composites may be used as electrodes containing the films as an electrocatalytic material. Thus, another aspect of the present invention is directed to an electrode, the electrode comprising a layer deposited on a surface of an electrically conductive support (i.e., a substrate as described above).

In the electrodes of the present invention, the electrocatalytic layer contains at least one metal oxide having the formula: MₓO_{y}, wherein M is a first, second, or third row transition metal, x is a positive integer from 1 to 3, and y is a positive integer from 1 to 7, wherein the layer is ferromagnetic, ferrimagnetic, or both ferromagnetic and ferrimagnetic at temperatures greater than 0° C. and has a zero field magnetization of 0.001 emu/g or greater at a temperature of 26.85° C. (300 K). Thus, for example, the layer may have a zero field magnetization of about 0.01 emu/g, about 0.1 emu/g, about 1.0 emu/g, about 3.0 emu/g, about 5.0 emu/g, or about 10.0 emu/g at a temperature of 26.85° C. (300 K). In one embodiment, the layer has a zero field magnetization of about 0.1 emu/g or greater at a temperature of 26.85° C. (300 K). In another embodiment, the layer has a zero field magnetization of about 1.0 emu/g or greater at a temperature of 26.85° C. (300 K).

In one particular embodiment, the electrocatalytic layer of the electrode contains a mixture of metal oxides having the formulae M¹O, (M²)₂O₃, and (M³)₃O₄, wherein M¹, M², and M³ are independently selected from first, second, and third row transition metals; more preferably in this embodiment from first row transition metals, and still more preferably M¹, M², and M³ are the same transition metal and are selected from V, Cr, Mn, Fe, Co, Ni, and Cu.

In another particular embodiment, the electrocatalytic layer of the electrode contains a mixture of metal oxides having the formulae: M¹O, (M²)₂O₃, (M³)₃O₄, and (M⁴)O₂, wherein M¹, M², M³, and M⁴ are independently selected from first, second, and third row transition metals; more preferably in this embodiment from first row transition metals, and still more preferably M¹, M², M³, and M⁴ are the same transition metal and are selected from V, Cr, Mn, Fe, Co, Ni, and Cu.

In addition to the at least one metal oxide having the formula MₓO_{y} noted above, in some embodiments, the electrocatalytic layer further contains at least one metal oxide having the formula: LₓO_{y}, wherein L is a first, second, or third row transition metal, x is a positive integer from 1 to 3, and y is a positive integer from 1 to 7, provided that M and L are not the same transition metal. By way of example, the electrochemical catalyst layer on the surface of an electrically conductive support may contain at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, M⁴, L¹, L², L³, and L⁴ are independently selected from first row transition metals, provided that (i) M¹ and L¹; (ii) M² and L²; (iii) M³ and L³; and (iv) L⁴ and M⁴ are not the same transition metal.

In another particular embodiment, the electrocatalytic layer of the electrode contains a mixture of metal oxides having the formulae: M¹O, (M²)₂O₃, (M³)₃O₄, and (L³)₃O₄, wherein M¹, M², M³ and L³ are independently selected from first, second, and third row transition metals, provided that L³ and M³ are not the same transition metal; more preferably in this embodiment from first row transition metals, and still more preferably M¹ and M³ are the same transition metal and are selected from V, Cr, Mn, Fe, Co, Ni, and Cu; and M² and L³ are the same transition metal and are selected from V, Cr, Mn, Fe, Co, Ni, and Cu, provided that (i) M¹ and M², and (ii) M³ and L³ are not the same transition metal.

In another particular embodiment, the electrocatalytic layer of the electrode contains a mixture of metal oxides having the formulae: (M²)₂O₃, (M⁴)O₂, (L²)₂O₃, and (L⁴)O₂, wherein M², M⁴, L², and L⁴ are independently selected from first, second, and third row transition metals, provided that (i) M² and L², and (ii) M⁴ and L⁴ are not the same transition metal. More preferably in this embodiment, M², M⁴, L², and L⁴ are independently selected from first, second, and third row transition metals, provided that (i) M² and L², and (ii) M⁴ and L⁴ are not the same transition metal; still more preferably M² and M⁴ are the same transition metal and are selected from V, Cr, Mn, Fe, Co, Ni, and Cu; and L² and L⁴ are the same transition metal and are selected from V, Cr, Mn, Fe, Co, Ni, and Cu, provided that (i) M² and L², and (ii) M⁴ and L⁴ are not the same transition metal.

In general, the composites may be employed as a hydrogen electrode and/or as an oxygen electrode in various electrochemical devices. In one embodiment, the composite is employed as an oxygen electrode. In another embodiment, the composite is employed as a hydrogen electrode.

The composites, therefore, may be employed as an electrode in any electrochemical device having an oxygen electrode including, for example, metal-oxygen batteries, metal-air batteries, other types of batteries containing one or more oxygen electrodes, fuel cells, and electrolyzers (such as water electrolyzers). These include both the oxygen-reducing electrode devices as well as the oxygen-producing electrode devices. For example, such devices include those which contain oxygen-reducing cathodes which consume or electrocatalytically reduce oxygen in an oxygen-containing gas. Also included are the oxygen-producing anode devices wherein oxygen is produced by electrocatalytic oxidation of oxygen-bearing compounds. The electrochemical devices in which the composites of the present invention are employed as the oxygen electrode may be the same as conventional devices which are known in the art. Thus, the present invention contemplates all known electrochemical devices having oxygen electrodes except that the composites of the present invention are used as the oxygen electrode.

The composites may additionally or alternatively be employed in any device having a hydrogen electrode including, for example, metal-hydride batteries, metal-air batteries, other types of batteries containing one or more hydrogen electrodes, fuel cells, and electrolyzers (such as water electrolyzers). These include both the hydrogen-oxidizing electrode devices as well as the hydrogen-producing electrode devices. For example, such devices include those which contain hydrogen-oxidizing anodes which consume or electrocatalytically oxidize hydrogen in a hydrogen-containing gas. Also included are the hydrogen-producing cathode devices wherein hydrogen is produced by electrocatalytic reduction of hydrogen-bearing compounds. The electrochemical devices in which the composites of the present invention are employed may be the same as conventional devices which are known in the art. Thus, the present invention contemplates all known electrochemical devices having hydrogen electrodes except that the composites of the present invention are used as the hydrogen electrode.

By way of example, the electrocatalytic material present as the film or layer on the surface of the substrate may be used as the catalytically active material for the anode and/or as the catalytically active material for the cathode of any fuel cell. Examples of fuel cells include proton exchange membrane (PEM) fuel cells, alkaline fuel cells (AFC), phosphoric acid fuel cells (PAFC), molten carbonate fuel cells (MCFC), and solid oxide fuel cells (SOFC). In most cases, while the electrolyte and sub-reactions at the electrodes can be different, the basic concept of H₂ gas dissociation to form water with release of current is common.

The film or layer containing the metal oxide(s), preferably a mixture of metal oxides, may be used, for example, as the catalytically active material for the anode of a fuel cell. Alternatively, the film or layer containing the metal oxide(s), preferably a mixture of metal oxides, may be used, for example, as the catalytically active material for the cathode of a fuel cell. The film or layer containing the metal oxide(s), preferably a mixture of metal oxides, may also be used as the catalytically active material for both the cathode and the anode of a fuel cell. It will be understood that the metal oxide(s) (and mixtures thereof may differ depending on whether the composites including the catalytically active material are utilized as the anode or as the cathode of the fuel cell.

In general, the film may be the catalytically active material for the cathode, for the anode, or for both the cathode and the anode of the fuel cell, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K). Thus, for example, the film may have a zero field magnetization of about 0.01 emu/g, about 0.1 emu/g, about 1.0 emu/g, about 3.0 emu/g, about 5.0 emu/g, or about 10.0 emu/g at a temperature of 26.85° C. (300 K). In one embodiment, the film has a zero field magnetization of about 0.1 emu/g or greater at a temperature of 26.85° C. (300 K). In another embodiment, the film has a zero field magnetization of about 1.0 emu/g or greater at a temperature of 26.85° C. (300 K).

The catalytically active film for the anode and/or the cathode of the fuel cell may further contain at least one metal oxide having the formula LₓO_{y}, wherein L is a first, second, or third row transition metal, x is a positive integer from 1 to 3, and y is a positive integer from 1 to 7, provided that M and L are not the same transition metal. Thus, for example, in one embodiment the film contains at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, M⁴, L¹, L², L³, and L⁴ are independently selected from first row transition metals, provided that (i) M¹ and L¹; (ii) M² and L²; (iii) M³ and L³; and (iv) L⁴ and M⁴ are not the same transition metal.

For example, in one particular embodiment the film is the catalytically active material for the cathode of the fuel cell, the film containing a mixture of metal oxides having the formulae: M¹O, (M²)₂O₃, (M³)₃O₄, and (L³)₃O₄, wherein M¹, M², M³, and L³ are independently selected from first row transition metals, provided that L³ and M³ are not the same transition metal. More preferably in this embodiment, M¹ and M³ are the same transition metal and are selected from V, Cr, Mn, Fe, Co, Ni, and Cu; and M² and L³ are the same transition metal and are selected from V, Cr, Mn, Fe, Co, Ni, and Cu, provided that (i) M¹ and M², and (ii) M³ and L³ are not the same transition metal; still more preferably in this embodiment, (1a) M¹ and M³ are Mn, and M² and L³ are Fe; (1b) M¹ and M³ are Fe, and M² and L³ are Mn; (2a) M¹ and M³ are Co, and M² and L³ are Fe; (2b) M¹ and M³ are Fe, and M² and L³ are Co; (3a) M¹ and M³ are Ni, and M² and L³ are Fe; (3b) M¹ and M³ are Fe, and M² and L³ are Ni; (4a) M¹ and M³ are Ni, and M² and L³ are Co; (4b) M¹ and M³ are Co, and M² and L³ are Ni; (5a) M¹ and M³ are Cu, and M² and L³ are Fe; (5b) M¹ and M³ are Fe, and M² and L³ are Cu; (6a) M¹ and M³ are Cu, and M² and L³ are Ni; and/or (6b) M¹ and M³ are Ni, and M² and L³ are Cu.

In another particular embodiment, the film is the catalytically active material for the anode of the fuel cell, the film containing a mixture of metal oxides having the formulae: (M²)₂O₃, (M⁴)O₂, (L²)₂O₃, and (L⁴)O₂, wherein M², M⁴, L², and L⁴ are independently selected from first row transition metals, provided that (i) M² and L², and (ii) M⁴ and L⁴ are not the same transition metal. More preferably in this embodiment, M² and M⁴ are the same transition metal and are selected from V, Cr, Mn, Fe, Co, Ni, and Cu; and L² and L⁴ are the same transition metal and are selected from V, Cr, Mn, Fe, Co, Ni, and Cu, provided that (i) M² and L², and (ii) M⁴ and L⁴ are not the same transition metal; still more preferably in this embodiment, (7) M² and L² are Ni and M⁴ and L⁴ are V; (8) M² and L² are Ni and M⁴ and L⁴ are Cr; (9) M² and L² are Co and M⁴ and L⁴ are Cu; (10) M² and L² are Mn and M⁴ and L⁴ are Ni; (11) M² and L² are Ni and M⁴ and L⁴ are Fe; (12) M² and L² are Ni and M⁴ and L⁴ are Co; and/or (13) M² and L² are Cu and M⁴ and L⁴ are Ni.

Conventional fuel cells generally include an anode, a cathode, and a porous non-conducting matrix (e.g., a proton exchange membrane) positioned between the anode and the cathode. The resulting anode-matrix-cathode sandwich is generally connected to an electrically conductive external circuit (e.g., current collectors). Potassium hydroxide is commonly used as the electrolyte, though other electrolytes may be employed in place of (or in addition to) potassium hydroxide such as, for example, potassium chloride, sodium hydroxide, lithium hydroxide, calcium hydroxide, magnesium hydroxide, strontium hydroxide, barium hydroxide, rubidium hydroxide, cesium hydroxide, and the like.

In operation, a hydrogen-containing fuel is fed to the anode and oxygen gas is fed to the cathode. These reactants diffuse through the electrodes to react with the electrolyte in the presence of the electrocatalyst material to produce water, heat, and electricity. At the anode, hydrogen is electrochemically oxidized and gives up electrons according to the reaction

H₂(g)+2OH⁻→2H₂O+2e⁻ (in a basic electrolyte (i.e., above pH ˜7))

or H₂(g)→2H⁺+2e⁻ (in an acidic electrolyte (i.e., below pH ˜7))

The electrons so generated are conducted from the anode through a circuit to the cathode. At the cathode, electrons are electrochemically combined with the oxidant according to the reaction

½O₂(g)+H₂O+2e⁻→2OH⁻ (in a basic electrolyte (i.e., above pH ˜7)

or O₂(g)+4H⁺+4e⁻→2H₂O (in an acidic electrolyte (i.e., below pH ˜7)

A flow of hydroxyl (OH⁻) ions through the electrolyte completes the circuit.

The electrocatalytic material present as the film or layer on the surface of the substrate may be used, for example, as the catalytically active material for the anode of a water electrolysis cell. Alternatively, the film or layer containing the metal oxide(s), preferably a mixture of metal oxides, may be used, for example, as the catalytically active material for the cathode of a water electrolysis cell. The film or layer containing the metal oxide(s), preferably a mixture of metal oxides, may also be used as the catalytically active material for both the cathode and the anode of a water electrolysis cell. It will be understood that the metal oxide(s) (and mixtures thereof) may differ depending on whether the composites including the catalytically active material are utilized as the anode or as the cathode or as the anode of the water electrolysis cell.

In general, the film may be the catalytically active material for the cathode, for the anode, or for both the cathode and the anode of the water electrolysis cell, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K). Thus, for example, the film may have a zero field magnetization of about 0.01 emu/g, about 0.1 emu/g, about 1.0 emu/g, about 3.0 emu/g, about 5.0 emu/g, or about 10.0 emu/g at a temperature of 26.85° C. (300 K). In one embodiment, the film has a zero field magnetization of about 0.1 emu/g or greater at a temperature of 26.85° C. (300 K). In another embodiment, the film has a zero field magnetization of about 1.0 emu/g or greater at a temperature of 26.85° C. (300 K).

The catalytically active film for the anode and/or the cathode of the fuel cell may further contain at least one metal oxide having the formula LₓO_{y}, wherein L is a first, second, or third row transition metal, x is a positive integer from 1 to 3, and Y is a positive integer from 1 to 7, provided that M and L are not the same transition metal. Thus, for example, in one embodiment the film contains at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, and L⁴ are independently selected from first row transition metals, provided that (i) M¹ and L¹; (ii) M² and L²; (iii) M³ and L³; and (iv) L⁴ and M⁴ are not the same transition metal.

For example, in one particular embodiment the film is the catalytically active material for the cathode of the water electrolysis cell, the film containing a mixture of metal oxides having the formulae: M¹O, (M²)₂O₃, (M³)₃O₄, and (L³)₃O₄, wherein M¹, M², M³, and L³ are independently selected from first row transition metals, provided that L³ and M³ are not the same transition metal. More preferably in this embodiment, M¹ and M³ are the same transition metal and are selected from V, Cr, Mn, Fe, Co, Ni, and Cu; and M² and L³ are the same transition metal and are selected from V, Cr, Mn, Fe, Co, Ni, and Cu, provided that (i) M¹ and M², and (ii) M³ and L³ are not the same transition metal; still more preferably in this embodiment, (1a) M¹ and M³ are Mn, and M² and L³ are Fe; (1b) M¹ and M³ are Fe, and M² and L³ are Mn; (2a) M¹ and M³ are Co, and M² and L³ are Fe; (2b) M¹ and M³ are Fe, and M² and L³ are Co; (3a) M¹ and M³ are Ni, and M² and L³ are Fe; (3b) M¹ and M³ are Fe, and M² and L³ are Ni; (4a) M¹ and M³ are Ni, and M² and L³ are Co; (4b) M¹ and M³ are Co, and M² and L³ are Ni; (5a) M¹ and M³ are Cu, and M² and L³ are Fe; (5b) M¹ and M³ are Fe, and M² and L³ are Cu; (6a) M¹ and M³ are Cu, and M² and L³ are Ni; and/or (6b) M¹ and M³ are Ni, and M² and L³ are Cu.

In another particular embodiment, the film is the catalytically active material for the anode of the water electrolysis cell, the film containing a mixture of metal oxides having the formulae: (M²)₂O₃, (M⁴)O₂, (L²)₂O₃, and (L⁴)O₂, wherein M², M⁴, L², and L⁴ are independently selected from first row transition metals, provided that (i) M² and L², and (ii) M⁴ and L⁴ are not the same transition metal. More preferably in this embodiment, M² and M⁴ are the same transition metal and are selected from V, Cr, Mn, Fe, Co, Ni, and Cu; and L² and L⁴ are the same transition metal and are selected from V, Cr, Mn, Fe, Co, Ni, and Cu, provided that (i) M² and L², and (ii) M⁴ and L⁴ are not the same transition metal; still more preferably in this embodiment, (7) M² and L² are Ni and M⁴ and L⁴ are V; (8) M² and L² are Ni and M⁴ and L⁴ are Cr; (9) M² and L² are Co and M⁴ and L⁴ are Cu; (10) M² and L² are Mn and M⁴ and L⁴ are Ni; (11) M² and L² are Ni and M⁴ and L⁴ are Fe; (12) M² and L² are Ni and M⁴ and L⁴ are Co; and/or (13) M² and L² are Cu and M⁴ and L⁴ are Ni.

Another aspect of the present invention is directed to methods for the electrochemical conversion of water to hydrogen in a water electrolysis cell comprising an anode and a cathode as described above, and also comprising an electrolyte. Operation of a conventional water-electrolysis cell generally involves supplying water to an anode and a cathode in an electrochemical cell containing an electrolyte and applying a current to the electrochemical cell. When a current is applied to the cell, water is electrolyzed at the anode according to the formula

2H₂O→O₂+4H⁺+4e⁻

generating hydrogen ions and oxygen, with electrons given to the anode. The hydrogen ions pass through the electrolyte to the cathode and are given electrons from the cathode. As a result, hydrogen is generated at the cathode according to the formula

2H⁺+2e⁻→H₂

In the water electrolysis cell, therefore, oxygen can be generated from the anode, whereas hydrogen can be generated from the cathode. Thus, methods of the invention comprise passing a current through the water electrolysis cell to dissociate water into hydrogen ions and hydroxide ions. Where the electrolysis cell comprises an anode with the above-described electrocatalyst films deposited thereon, the hydroxide ions are contacted with the electrocatalyst and are catalytically oxidized. Similarly, where the electrolysis cell comprises a cathode with the above-described electrocatalyst films deposited thereon, the hydrogen ions are contacted with the electrocatalyst and are catalytically reduced. Suitable electrolytes for water electrolysis cells are well known in the art, and include potassium hydroxide, sodium hydroxide, hydrochloric acid, and sulfuric acid, among others. In general, the pH of the electrolyte may range from 0 to 14.0 (e.g., 0, 1, or 13.8).

Without being bound to any particular theory, it is believed that, among other factors, the zero field magnetization associated with the electrocatalyst film material described above (i.e., ferromagnetic, ferrimagnetic, or both ferromagnetic and ferrimagnetic) plays a role in an oxygen evolution reaction. In such a reaction, oxygen, a ground state triplet molecule, is prepared from water, a ground state singlet molecule. The electrons in molecules are Fermions, and have a quantized spin of ±½. A summed spin of zero is a singlet state. A summed spin of one is a triplet state. The interconversion of singlet and triplet states is formally forbidden. For instance, this is the mechanism that protects mammals and plants from the high reactivity of oxygen gas. Among other factors, it is also the mechanism responsible for the substantial over-voltage for oxygen evolution in water electrolysis. The magnetic field associated with the ferromagnetic, ferrimagnetic, or both ferromagnetic and ferrimagnetic films described above catalyze the interconversion of different electron spin states. In particular, they catalyze the conversion of a singlet system, two water molecules, to a triplet system, an oxygen molecule with four protons.

For these and other reasons, use of the composites of the present invention in electrochemical devices such as those described herein (e.g., for catalytic oxidation) advantageously lowers oxygen over-potential in such devices. For instance, where the composites of the present invention are used as oxygen electrodes, oxygen over-potential may be less than 0.1 V, less than 0.01 V, or, in some cases, less than 0.001 V. In a particular embodiment in which the composites of the present invention are used as oxygen electrodes, the oxygen over-voltage during catalytic oxidation in a water electrolysis cell or a fuel cell having a composite of the present invention as the cathode is from about 0.01 to about 0.1 V. In some instances, no detectable amount of oxygen over-potential is observed. Similarly, where the composites of the present invention are used as hydrogen electrodes, hydrogen over-potential may be less than 0.1 V, less than 0.01 V, or, in some cases, less than 0.001 V. In a particular embodiment in which the composites of the present invention are used as hydrogen electrodes, the hydrogen over-voltage during catalytic reduction in a water electrolysis cell or a fuel cell having a composite of the present invention as the anode is from about 0.01 to about 0.1 V. In some instances, no detectable amount of oxygen over-potential is observed.

Processes for Producing Composites

Another aspect of the present invention is a process for the preparation of a composite. In general, the composites are prepared by a deposition process. Advantageously, the processes described herein enable the formation of the above-described composites including a substrate and a film or layer containing at least one metal oxide having the formula: MₓO_{y}, wherein M is a first, second, or third row transition metal, x is a positive integer from 1 to 3, and y is a positive integer from 1 to 7, wherein the layer is ferromagnetic, ferrimagnetic, or both ferromagnetic and ferrimagnetic at temperatures greater than 0° C. and has a zero field magnetization of 0.001 emu/g or greater at a temperature of 26.85° C. (300 K). In one embodiment, each M is a first row transition metal; more preferably in this embodiment, each M is selected from the group consisting of V, Cr, Mn, Fe, Co, Ni, and Cu.

The processes described herein also enables the formation of the above-described composites including a film or layer further containing at least one metal oxide having the formula: LₓO_{y}, wherein L is a first, second, or third row transition metal, x is a positive integer from 1 to 3, and y is a positive integer from 1 to 7, provided that M and L are not the same transition metal. By way of example, the deposited film or layer may contain at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, M⁴, L¹, L², L³, and L⁴ are independently selected from first row transition metals, provided that (i) M¹ and L¹; (ii) M² and L²; (iii) M³ and L³; and (iv) L⁴ and M⁴ are not the same transition metal. In one embodiment, each M is a first row transition metal; more preferably in this embodiment, M¹, M², M³, M⁴, L¹, L², L³, and L⁴, if present, are selected from the group consisting of V, Cr, Mn, Fe, Co, Ni, and Cu (subject to proviso (i), (ii), (iii), and (iv) above).

The composites are preferably prepared according to an electrolytic deposition (i.e., electrodeposition) process. Preferably, the electrodeposition process is a cathodic electrodeposition process. Alternatively, however, the electrodeposition process may be an anodic electrodeposition process. According to the electrodeposition process, an applied current drives redox chemistry such that the above-described film is deposited on an electrically conductive region of a substrate. Alternatively, however, other methods may be employed to deposit the film on the substrate, provided the particular method chosen is sufficient to prepare a film containing at least one metal oxide having the formula: MₓO_{y}, or a mixture of metal oxides (e.g., at least one metal oxide having the formula: M¹O, (M²)₂O₃, (M³)₃O₄, and (M⁴)O₂; and at least one metal oxide having the formula: L¹O, (L²)₂O₃, (L³)₃O₄, and (L⁴)O₂). Particular alternative methods that may be used to deposit the film on the substrate include, for example, spin coating, dip coating, surface coating a porous structure, powder pressing, casting, screen printing, tape forming, precipitation, sol-gel forming, curtain deposition, physical sputtering, reactive sputtering, physical vapor deposition (PVD), chemical vapor deposition (CVD), ion beam deposition, e-beam deposition, molecular beam epitaxy, laser deposition, plasma deposition, electrophoretic deposition, magnetophoretic deposition, thermophoretic deposition, stamping, cold pressing, hot pressing, pressing with an additive and then removal of the additive with heat, solvents, or supercritical fluids, centrifugal casting, gel casting, investment casting, extrusion, electroless deposition, stacking and laminating, brush-painting, or self-assembly.

Preparing the composites by electrodeposition generally entails immersing all or part of the substrate in an electrolytic deposition (i.e., electrodeposition) bath. At least an electrically conductive region of the substrate is preferably immersed in the electrodeposition bath. Typically, the entire substrate is immersed in the bath. The electrodeposition bath contains metal ions (e.g., ions of M¹, M², M³, M⁴, L¹, L², L³, and L⁴ as defined above). In one preferred embodiment, the electrodeposition bath contains ions of V, Cr, Mn, Fe, Co, Ni, and Cu. The substrate is subjected to an electric current (i.e., an electric current is passed through the electrically conductive region of the substrate) to adherently electrodeposit the film containing one or more metal oxides or a mixture of metal oxides on exposed surfaces of the electrically conductive region. The electrically conductive region of the substrate typically comprises a metal selected from the group consisting of aluminum, titanium, vanadium, chromium, manganese, iron, cobalt, nickel, copper, zinc, zirconium, niobium, molybdenum, ruthenium, rhodium, palladium, silver, tantalum, tungsten, osmium, iridium, platinum, gold, tin, and bismuth and metal oxides, mixtures of said metals and metal oxides, and alloys of said metals. In one embodiment, the substrate subjected to the electric current is selected from the group consisting of platinum, titanium, nickel, stainless steel, and alloys thereof.

By way of example, the deposited film may contain at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, M⁴, L¹, L², L³, and L⁴ are independently selected from first row transition metals, provided that (i) M¹ and L¹; (ii) M² and L²; (iii) M³ and L³; and (iv) L⁴ and M⁴ are not the same transition metal. In one embodiment, for example, the film contains a mixture of metal oxides having the formulae M¹O, (M²)₂O₃, and (M³)₃O₄, wherein M¹, M², and M³ are selected first row transition metals. In another embodiment, for example, the film contains a mixture of metal oxides having the formulae: M¹O, (M²)₂O₃, (M³)₃O₄, and (M⁴)O₂, wherein M¹, M², M³, and M⁴ are selected from first row transition metals. In another embodiment, for example, the film contains a mixture of metal oxides having the formulae: M¹O, (M²)₂O₃, (M³)₃O₄, and (L³)₃O₄, wherein M¹, M², M³, and L³ are independently selected from first row transition metals, provided that L³ and M³ are not the same transition metal. In yet another embodiment, for example, the film contains a mixture of metal oxides having the formulae: (M²)₂O₃, (M⁴)O₂, (L²)₂O₃, and (L⁴)O₂, wherein M², M⁴, L², and L⁴ are independently selected from first row transition metals, provided that (i) M² and L², and (ii) M⁴ and L⁴ are not the same transition metal. In certain of these embodiments, M¹, M², M³, M⁴, L¹, L², L³, and L⁴, if present, are selected from the group consisting of V, Cr, Mn, Fe, Co, Ni, and Cu (subject to the above provisos).

In one particular embodiment, the deposited film includes one or more of (a) VO, V₂O₃, and V₃O₄; (b) CrO, Cr₂O₃, and Cr₃O₄; (c) MnO, Mn₂O₃, and Mn₃O₄; (d) FeO, Fe₂O₃, and Fe₃O₄; (e) CoO, Co₂O₃, and Co₃O₄; (f) NiO, Ni₂O₃, and Ni₃O₄; and/or (g) CuO, Cu₂O₃, and Cu₃O₄. In another particular embodiment, the deposited film includes one or more of (a) VO, V₂O₃, V₃O₄, and VO₂; (b) CrO, Cr₂O₃, Cr₃O₄, and CrO₂; (c) MnO, Mn₂O₃, Mn₃O₄, and MnO₂; (d) FeO, Fe₂O₃, Fe₃O₄, and FeO₂; (e) CoO, Co₂O₃, Co₃O₄, and CoO₂; (f) NiO, Ni₂O₃, Ni₃O₄, and NiO₂; and/or (g) CuO, Cu₂O₃, Cu₃O₄, CuO₂. In yet another particular embodiment, the deposited film includes one or more of (1a) MnO, Fe₂O₃, Fe₃O₄, and Mn₃O₄; (1b) FeO, Mn₂O₃, Mn₃O₄, and Fe₃O₄; (2a) CoO, Fe₂O₃, Co₃O₄, and Fe₃O₄; (2b) FeO, Co₂O₃, Fe₃O₄, and Co₃O₄; (3a) NiO, Fe₂O₃, Ni₃O₄, and Fe₃O₄; (3b) FeO, Ni₂O₃, Fe₃O₄, and Ni₃O₄; (4a) NiO, Co₂O₃, Ni₃O₄, and Co₃O₄; (4b) CoO, Ni₂O₃, Co₃O₄, and Ni₃O₄; (5a) CuO, Fe₂O₃, Cu₃O₄, and Fe₃O₄; (5b) FeO, Cu₂O₃, Fe₃O₄, and Cu₃O₄; (6a) CuO, Ni₂O₃, Cu₃O₄, and Ni₃O₄; and (6b) NiO, Cu₂O₃, Ni₃O₄, and Cu₃O₄. In yet another embodiment, the deposited film includes one or more of (7) Ni₂O₃, VO₂, NiO₂, and V₂O₃; (8) Ni₂O₃, CrO₂, NiO₂, and Cr₂O₃; (9) Co₂O₃, CuO₂, CoO₂, and Cu₂O₃; (10) Mn₂O₃, NiO₂, MnO₂, and Ni₂O₃; (11) Ni₂O₃, FeO₂, NiO₂, and Fe₂O₃; (12) Ni₂O₃, CoO₂, NiO₂, and Co₂O₃; and (13) Cu₂O₃, NiO₂, CuO₂, and Ni₂O₃. In one particular embodiment, the film includes (3a) NiO, Fe₂O₃, Ni₃O₄, and Fe₃O₄; (3b) FeO, Ni₂O₃, Fe₃O₄, and Ni₃O₄; and combinations thereof. In another particular embodiment, the film includes (7) Ni₂O₃, VO₂, NiO₂, and V₂O₃.

The electrodeposition bath generally acts as an electrolyte during the electrodeposition process. The substrate containing the electrically conductive region acts as a cathode in the electrodeposition process, and an oppositely-charged counter electrode (i.e., an anode) completes the circuit. Conventional power sources (e.g., a battery or standard DC power source) may be used to supply the necessary current density to cause the adherent deposition of the metal oxide(s) or mixture of metal oxides on the surface of the electrically conductive region. A reference electrode may also be present in the electrodeposition system to measure electrochemical potential. Commercially available electrodeposition systems that may be used in the electrodeposition process of the present invention include, for instance, the Voltalab 10 (PGZ100) electrochemical workstation (Radiometer Analytical, Lyon, France) with VoltMaster 4 software installed. Substantially equivalent electrodeposition systems may also be employed.

In the step of passing an electric current through the electrically conductive region of the substrate, a current density of a few tens, a few hundreds, or even a few thousands of mA/cm² may be suitably applied, or other electrical conditions to deposit the above-described metal oxide(s) and mixtures of metal oxides on the appropriate surfaces of the substrate. The pH of the electrodeposition bath may affect the amount of current density that is passed through the electrically conductive region of the substrate. For instance, the pH can affect the interaction of the metal ions with other components in the electrodeposition bath (e.g., electrolytes, nucleophiles, and/or complexing agents described below), for example, through protonation/deprotonation of one or more bath components and/or by changing the strength of competing water ligands also in the bath. In general, where the pH of the electrodeposition bath is lower (i.e., more acidic), a higher current density is applied. The concentration of metal ions in the electrodeposition bath may also affect the amount of current density passed through the electrically conductive region. For example, as the concentration of metal ions increases, a higher current density is generally applied.

The current density at the electrically conductive surface of the substrate is typically at least 25 mA/cm². In various embodiments, the current density is from about 50 mA/cm² to about 5,000 mA/cm²; more preferably in these embodiments the current density is from about 250 mA/cm² to about 1,000 mA/cm². For example, the current density may be about 300 mA/cm², about 400 mA/cm², about 500 mA/cm², about 600 mA/cm², about 700 mA/cm², about 800 mA/cm², or about 900 mA/cm². Within the above ranges, higher current densities are generally preferred.

To carry the electrical charge in the electrodeposition bath during electrodeposition, the bath includes a precursor to the mixture of metal oxides contained in the deposited film. In general, the precursor contains one or more metal ions that will be deposited on the surface of the substrate as metal oxides. Particular ions for inclusion in the bath include those described above in connection with M¹, M², M³, M⁴, L¹, L², L³, and L⁴ (i.e., first, second, and third row transition metals; preferably first row transition metals; more preferably V, Cr, Mn, Fe, Co, Ni, and Cu and combinations thereof). The source of the metal ions is typically one or more metal salts. That is, one or more metal salts of the same or different transition metal are introduced into the bath and dissociate into the metal ion and a counterion used in the formation of the metal salt. The counterion involved in the formation of the metal salt is generally used to form an aqueous solution of the salt. Alternatively, however, counterions that form molten (i.e., melted) or fused salts may also be employed. Particular counterions or other compounds may be selected to provide the metal ion in a particular oxidation state in the bath upon dissociation of the metal salt. Non-limiting examples of suitable counterions for the metal salt(s) include sulfide (S²⁻), sulfate (SO₄²⁻), nitrate (NO₃⁻), nitrite (NO₂⁻), phosphate (PO₄³), halides (e.g., chloride (Cl⁻), bromide (Br⁻)), perchlorate (ClO₄⁻), oxide (O²⁻), hydroxide (OH⁻), carbonate (CO₃²⁻), chromate (CrO₄²⁻), organic ions such as acetate (CH₃COO⁻) and citrate (C₆H₅O₇³⁻), and other ions such as, hydrogen (H⁺), lithium (Li⁺), sodium (Na⁺), potassium (K⁺), rubidium (Rb⁺), cesium (Cs⁺), and ammonium (NH₄⁺).

The oxidation states of the metal ions in the electrodeposition bath may depend on the stability of the metal ion in the bath and/or by what metal ions are generally available (e.g., commercially or otherwise). For instance, metal ion oxidation state stability for a particular metal ion may be limited to a certain pH ranges (see, e.g., Pourbaix, Atlas of Electrochemical Equilibria in Aqueous Solution, Brussels, Cebelcor, 1974). The oxidation state of the metal ions may range, for example, from 1⁺ to 9⁺ (i.e., 1⁺, 2⁺, 3⁺, 4⁺, 5⁺, 6⁺, 7⁺, 8⁺, and/or 9⁺), or higher, with multiple oxidation states for a single metal ion being possible. Typically, the oxidation state of the metal ions ranges from 1⁺ to 7⁺ (i.e., 1⁺, 2⁺, 3⁺, 4⁺, 5⁺, 6⁺, and/or 7⁺) For example, V may have an oxidation state of 2⁺, 3⁺, 4⁺ and/or 5⁺; Cr may have an oxidation state of 2⁺, 3⁺, 4⁺, 5⁺, and/or 6⁺; Mn may have an oxidation state of 2⁺, 3⁺, 4⁺, 5⁺, and/or 7⁺; Fe may have an oxidation state of 2⁺ and/or 3⁺; Co may have an oxidation state of 2⁺ and/or 3⁺; Ni may have an oxidation state of 2⁺ and/or 3⁺; and Cu may have an oxidation state of 1⁺ and/or 2⁺.

To maintain a satisfactory deposition of the mixture of metal oxides on.the electrically conductive region of the substrate, it is generally preferred that the electrodeposition bath have a total metal ion concentration (i.e., for a single metal ion or a mixture of metal ions) of between about 1 mM and about 1,000 mM. For example, the total metal ion concentration may be about 5 mM, about 50 mM, about 100 mM, about 150 mM, about 200 mM, about 250 mM, about 300 mM, about 350 mM, about 400 mM, about 450 mM, about 500 mM, about 550 mM, about 600 mM, about 650 mM, about 700 mM, about 750 mM, about 800 mM, about 850 mM, about 900 mM, or about 950 mM. In a particular embodiment, the total metal ion concentration in the electrodeposition bath is from about 10 mM to about 50 mM. In another particular embodiment, the total metal ion concentration in the electrodeposition bath is from about 5 mM to about 50 mM. For example, the total metal ion concentration in the electrodeposition bath may be about 5 mM, about 10 mM, about 15 mM, about 20 mM, about 25 mM, about 30 mM, about 35 mM, about 40 mM, or about 45 mM.

Where two or more different metal ions are included in the electrodeposition bath, the concentration of metal ions relative to each other is preferably equal or substantially equal (i.e., the ratio of the concentration of different metal ions is about 1:1, about 1:1:1, about 1:1:1:1, and so forth). It may be desirable in some instances, however, to provide a higher concentration of one or more metal ions over another metal ion (e.g., about 2:1, about 10:1, about 100:1, and so forth, or higher; or, about 2:1:1, about 3:1:1, about 4:1:1, about 3:2:1, about 4:2:1, and so forth).

In addition to the metal ions, the electrolytic deposition bath preferably includes an aqueous solution comprising water. Generally, the water functions as a co-reactant with the metal ions during the electrodeposition process, and can also provide buffering capabilities to the electrodeposition bath and the metal ions contained therein. It is believed that when current is applied to the system, the protons from the water are reduced and turn to hydrogen gas, and the metal ion is bound to the remaining oxygen from water and deposits on the electrically conductive regions of the substrate as a film or coating containing the above-described metal oxides. Additionally or alternatively, the various counterions present in the electrodeposition bath (e.g., those used in the formation of the metal salt or other salts described below) may be a source of the oxygen atoms for the metal oxides.

Besides water, the aqueous solution preferably includes one or more electrolytes; that is, one or more chemical compounds that dissociate (i.e., ionize) when dissolved or molten to produce an electrically conductive medium. Depending on the particular electrolyte(s) selected, the electrolyte may also serve to adjust the pH of the electrodeposition bath, buffer the electrodeposition bath pH, increase the ionic conductivity of the electrodeposition bath, and/or ligate or complex the metal ions to provide, among other features, improved deposition and composites that possess one or more of the advantageous properties described herein. Further, as the ionic strength of the electrodeposition bath increases through the use of the electrolyte(s), less voltage may be necessary to maintain the same amount of current density during the electrodeposition process.

The aqueous solution may include, for instance, a strong electrolyte, a weak electrolyte, or mixtures thereof. In general, strong electrolytes dissociate completely (i.e., about 100%) or nearly completely into their component ions when included in the aqueous solution; that is, nearly every molecule dissolved generates ions that contribute to electrical conductivity. Weak electrolytes, on the other hand, generally only partially ionize or dissociate into their component ions; thus, the weak electrolyte exists in the aqueous solution as a mixture of individual ions and intact molecules. In a particular embodiment, the aqueous solution includes at least one strong electrolyte and at least one weak electrolyte.

As noted above, strong electrolytes are characterized in that they substantially dissociate in the aqueous solution. Exemplary strong electrolytes that may be included in the aqueous solution include, for instance, mineral acids such as hydrochloric acid, hydrobromic acid, hydroiodic acid, nitric acid, phosphoric acid, sulfuric acid, combinations thereof, and the like. Additionally or alternatively, ammonium salts may be employed as a strong electrolyte in the aqueous solution. Suitable counterions that may be used with ammonium ions to form the ammonium salts include, for example, sulfates (SO₄²⁻), sulfites (SO₃²⁻), thiosulfates (S₂O₃²⁻), persulfates (S₂O₈²⁻), sulfamates (SO₃NH₂⁻), hydroxides (OH⁻), chlorides (Cl⁻), perchlorates (ClO₄⁻), mono/dibasic phosphates (H₂PO₄⁻/HPO₄²⁻), carbonates (CO₃²⁻), bicarbonates (HCO₃⁻), nitrates (NO₃⁻), acetates (CH₃COO⁻), and the like.

Weak electrolytes (i.e., compounds that only partially dissociate in the aqueous solution) that may be used include, for instance, relatively weak acids such as citric, lactic, malonic, tartaric, succinic, malic, acetic, and oxalic acids, and the like; and relatively weak bases such as ammonia.

Additionally or alternatively, the aqueous solution may include an alcohol (such as C₁ to C₆ alkanols (e.g., methanol, ethanol, or propanol), ethylene glycol, polyethylene glycol, catechol, other polyhydroxylated alcohols, and the like). In one particular embodiment, the aqueous solution further comprises an alcohol. It is believed that such alcohols may function in the aqueous solution as weak electrolytes by partially dissociating and increasing the ionic conductivity of the electrodeposition bath. Among the preferred alcohols are C₁ to C₆ alkanols such as methanol and ethanol. In a particular embodiment, the alcohol is selected from methanol, ethanol, and mixtures thereof.

In addition to the metal ions and the various electrolytes noted above, the electrodeposition bath may include one or more complexing agents (e.g., ligands) which interact with the metal ions in the electrodeposition bath to form complexes that facilitate deposition of the metal oxides on the surface of the substrate. These interactions may be covalent or non-covalent interactions, and/or may also include hydrophobic, van der Waals, and/or hydrogen interactions.

In general, any conventional monodentate, bidentate, tridentate, tetradentate, hexadentate, or otherwise multidentate ligand may be used as the complexing agent in the electrodeposition bath. For instance, the complexing agent may be selected from phosphines, halides (e.g., bromide, chloride, and iodide), nitrogen-containing compounds, and other common chelating agents such as crown ethers, cryptands (such as 1,10-diaza-4,7,13,16,21,24-hexaoxabicyclo[8.8.8]hexacosane (i.e., [2.2.2] cryptand)), and the like, and combinations thereof. In a particular embodiment, the complexing agent is selected from the group consisting of a phosphine, a halide, a nitrogen-containing compound, a crown ether, a cryptand, and combinations thereof.

Non-limiting examples of nitrogen-containing compounds include, for instance, ammonium, ammonium ions, or quaternary ammonium salts; pyridines and bipyridines (e.g., 2,2′-bipyridine); pyrimidines (e.g., 1,8-diazabicyclo[5.4.0]undec-7-ene); phenanthrolines (e.g., 1,10-phenanthroline); triazacyclononanes (e.g., 1,4,7-triazacyclononane); alkylene amines and polyalkyleneamines (such as ethylenediamine, diethylenediamine, triethylenetetraamine, tetraethylenepentamine, and acids and salts thereof (e.g., EDTA and salts thereof), imidazoles, acetonitrile, nitriloacetic acid and salts thereof, dimethylglyoxime and salts thereof, and the like. Non-limiting examples of phosphines include, for instance triphenylphosphene, 1,2-bis(diphenylphosphino)ethane, and the like.

Preferably, the electrodeposition bath includes one or more nucleophiles. The source of the nucleophile may be from one or more of the strong electrolyte, weak electrolyte, alcohol, and complexing agent, or the nucleophile may be a distinct component added to the electrodeposition bath alone or in combination with the other components described above. Generally speaking, the nucleophile(s) preferred for use in the electrodeposition bath having a least one (and possibly more than one) of the following characteristics: a relatively large atomic radius, a relatively low effective nuclear charge, relatively low electronegativity, relatively high polarizability, relatively easy oxidizability, and empty low lying levels. The bath may include, for example, relatively “hard,” “soft,” and “borderline” nucleophiles. Representative “hard” nucleophiles that may be included in the electrodeposition bath include, for example, H₂O, HO—, F⁻, H₃C—C(═O)O—, PO₄³⁻, SO₄²⁻, Cl⁻, CO₃²⁻, ClO₄⁻, NO₃^{-, R—OH, R}₂O, NH₃, R—NH₂, and H₂N—NH₂, among others, wherein each R represents an alkyl (e.g., —CH₃, —C₂H₅, etc.). Representative “borderline” nucleophiles that may be included in the electrodeposition bath include, for example, C₅H₅N, C₆H₅NH₂, [N₃]⁻, Br⁻, SO₃2-, N₂, and NO₂—, among others, wherein each R represents an alkyl (e.g., —CH₃, —C₂H₅, etc.). Representative “soft” nucleophiles that may be included in the electrodeposition bath include, for example, R₂S, R—SH, R—S⁻, I⁻, SCN⁻, R₃P, R₃-Arsine, (H₃CO)₃P, CN⁻, R⁻NC, CO, H₂C═CH₂, C₆H₆, H⁻, and R⁻, among others, wherein each R represents an alkyl (e.g., —CH₃, —C₂H₅, etc.). A thorough discussion of “hard,” “soft,” and “borderline” nucleophiles can be found, for example, in Pearson, “Hard and Soft Acids and Bases,” J. Am. Chem. Soc. 85 (22) 3533-3539 (1963); Pearson, “Hard and soft acids and bases, HSAB,” J. Chem. Educ. (45), 581643 (1968). In one particular embodiment, the nucleophile chosen for inclusion in the electrodeposition bath has a relatively high ligand nucleophilicity towards Pd²⁺. A thorough discussion of ligand nucleophilicity can be found, for example, in Cotton, F. A., and Wilkinson, G., Advanced Inorganic Chemistry, third ed., 588-597 (Interscience, New York, 1972).

Where the electrodeposition bath includes both the metal ions (e.g., derived from metal salts) and the aqueous solution comprising water (and, optionally, one or more electrolytes, nucleophiles, and/or complexing agents discussed above), the electrodeposition bath is formed by combining the metal ion source (e.g., metal salts) and the aqueous solution. The bath components are typically combined in a conventional electrodeposition tank or vessel; alternatively, however, the electrodeposition bath components may be combined in another vessel and the resulting solution transferred to a suitable electrodeposition tank or vessel. By way of example, a solution of metal salts may be dispersed in or otherwise added to a vessel containing the aqueous solution, and vice versa. Or, the solution of metal salts and the aqueous solution may be added simultaneously or substantially simultaneously to the electrodeposition tank or vessel. Regardless of the order of mixing, the electrodeposition bath is preferably agitated prior to performing the electrodeposition. The electrodeposition bath can be prepared in advance or may be mixed immediately prior to immersion of the substrate to be coated.

The order of mixing of the above-described electrodeposition bath components is not narrowly critical. Depending on a variety of factors such as, for example, the particular metal ion(s) and corresponding salt-forming anion, the nucleophile(s), and/or the electrolyte(s) selected, the desired pH of the electrodeposition bath, and/or the desired current density for electrodeposition, numerous mixing combinations may be employed. For instance, the electrodeposition bath may be formed by combining a first metal salt, a first electrolyte, a second electrolyte, a second metal salt, and a third electrolyte, in that order. Alternatively, the electrodeposition bath may be formed by combining a first electrolyte, a first metal salt, a second electrolyte, a second metal salt, and a third electrolyte, in that order. By way of another alternative example, the electrodeposition bath may be formed by combining a first electrolyte, a second electrolyte, a first metal salt, a third electrolyte, and a second metal salt, in that order. In yet another example, the electrodeposition bath may be formed by combining a first electrolyte, a second electrolyte, a third electrolyte, a first metal salt, and a second metal salt. Other combinations may also be used. In any one or more of the above combinations, the first, second, and third electrolyte may also serve to adjust the pH of the bath within a desired range (e.g., where the electrolyte is an acid). Additionally or alternatively, one or more of the first, second, and third electrolytes may be an alcohol as noted above (e.g., a C₁ to C₆ alkanol such as methanol and ethanol).

The electrodeposition bath is preferably free or substantially free of any components that may reduce the efficiency of the composites of the present invention when employed as an electrode in an electrochemical cell. The inclusion of thiol-containing compounds, alkali metals, and/or alkaline earth metals, for example, is generally less preferred. For instance, the electrodeposition bath preferably contains less than 1,000 mM of thiol-containing compounds, alkali metals, and alkaline earth metals. Preferably, no detectable amount of thiol-containing compounds, alkali metals, and alkaline earth metals are present in the electrodeposition bath.

As noted above, the pH of the electrodeposition bath may affect the current density applied to the substrate to deposit the film on the substrate. In general, the pH of the electrodeposition may vary depending on a variety of factors. For instance, for the electrodeposition of metal oxides including transition metals to the left side of the Periodic table (i.e., wherein one or more of M¹, M², M³, M⁴, L¹, L², L³, and L⁴ if present, are selected from transition metals on the left side of the Periodic table), the pH of the electrodeposition bath is preferably lower (i.e., more acidic). The electrodeposition bath may have a pH of from about 0 to about 14. For example, the electrodeposition bath may have a pH of about 1, about 2, about 3, about 4, about 5, or about 6, about 7, about 8, about 9, about 10, about 11, about 12, or about 13. In a particular embodiment, the electrodeposition bath has a pH of from about 1 to about 4. In another particular embodiment, the electrodeposition bath has a pH of from about 0 to 7. In another particular embodiment, the electrodeposition bath has a pH of from about 0.5 to 7. In another particular embodiment, the electrodeposition bath has a pH of from about 2 to about 12. If desired, the pH of the electrodeposition bath may be adjusted within the above ranges by the inclusion of organic and inorganic acids in the electrodeposition bath. Examples of suitable inorganic acids are hydrobromic acid, hydrochloric acid, sulfuric acid, perchloric acid, phosphoric acid, and the like. Examples of suitable organic acids are acetic acid, oxalic acid, formic acid, and the like.

The preparation of the electrodeposition bath and the electrodeposition process itself (i.e., the immersion of substrate in the bath and the passage of an electric current through the electrically conductive region of the substrate) are generally carried out at room temperature (22-25° C.) and in ambient air. If appropriate, however, the temperature may be increased or decreased (e.g., to facilitate dissolution of the electrodeposition bath components) and/or the bath preparation and electrodeposition may be carried out in an atmosphere of argon or nitrogen or other gas which is unreactive to the various components and/or which will not otherwise affect the electrodeposition process.

Electrodeposition time (i.e., the length of time an electric current is passed through the electrically conductive region of the substrate) may depend on a variety of factors such as, for example, electrodeposition bath temperature and/or pH, bath components and concentrations thereof (e.g., metal ion concentration), aqueous solution composition and concentrations thereof, and the like. Electrodeposition time typically varies from a few seconds to hundreds or even thousands of seconds. In general, longer electrodeposition times result in a relatively thicker film on the surface of the substrate. As noted above, thicker films tend to be less desirable because they can be less stable in use than thinner films. Thus, electrodeposition times may be optimized to provide a film of any desired thickness. In a particular embodiment, the electrodeposition time is from about 1 second to about 200 seconds; more preferably in this embodiment from about 3 seconds to about 180 seconds. For example, electrodeposition time may be about 5 seconds, about 20 seconds, about 35 seconds, about 50 seconds, about 65 seconds, about 80 seconds, about 95 seconds, about 110 seconds, about 135 seconds, about 150 seconds, or about 165 seconds.

The application of the current may be repeated a number of times until a desired amount of the film deposits on the substrate. It is preferred, however, to deposit an effective amount of the catalytic film in a single application.

Optional pre- and post-treatment measures may also be performed on the substrate and/or the electrically conductive region thereof before and/or after deposition. For example, the substrate may be roughened prior to contact with the electrodeposition bath in order to increase the mechanical adhesion of the film as well as to increase the effective surface area of the resulting composite. Increased surface area may further reduce over-voltage in use of the composite (e.g., as an electrode in an electrochemical device). Suitable methods for roughening the surfaces of the substrates and regions thereof include, for example, sandblasting, chemical etching, and the like. The use of chemical etchants is known and such etchants include most strong acids such as hydrochloric acid, sulfuric acid, nitric acids, and phosphoric acid. These and other strong acids may also be generally used to prepare the substrate surface for electrodeposition (e.g., by removing dirt or fingerprints, or to remove previously deposited films, from the surface of the substrate) without substantially etching the surface of the substrate.

The substrate may also be degreased prior to roughening. The removal of grease from the surfaces of the substrate may be desirable, for instance, to allow chemical etchants to contact the substrate and uniformly roughen the surfaces thereof. The removal of grease may also allow for good contact between the substrate and the electrodeposition bath to obtain a substantially uniform electrodeposition of the above-described films containing the mixture of metal oxides. Grease removal can also be useful even where surface roughening is not desired. Suitable degreasing agents are known and include alkaline solutions and common organic solvents such as acetone and lower alcohols.

Additionally or alternatively, prior to and/or after deposition, the substrate may be simply mechanically and/or chemically cleaned in accordance with conventional methods. Preferably, the composites are rinsed (e.g., with water or the electrolyte with which the composite will be used in an electrochemical cell) after deposition of the film.

After the formation of the film according to the above-described process, it is preferable to avoid exposing the film to compounds which react with metal oxides or any other catalyst-poisoning agents. Thus, for example, exposure of the composite to hydrogen sulfide, strong acids, and the like is preferably avoided.

It will be appreciated that the conditions under which the electrodeposition bath is formed and under which the electrodeposition is carried out may be varied so as to control the structure and/or properties of the electrodeposited film in the composite of the present invention. For example, any one or more such variables as electrodeposition time, current density, electrodeposition bath components and concentrations thereof, electrodeposition bath temperature and pH, the presence or absence of the electrolyte(s) and/or complexing agents and concentrations thereof, and others, may be varied to provide the composites of the present invention. Example 1

### Oxygen Evolution Catalysts

1.1 Kinetic Parameters

Among other variables, the cathodic electrodeposition techniques described herein included use of electrolytes other than strong acids in the electrodeposition solution as well as the effects of higher power densities. Electrolytes such as ammonium salts and organic acids were included in the electrodeposition solution as mimics of catalytic site ligands observed in enzyme examples. It has been discovered that ligands of these types are nucleophilic toward transition metal ions and alter the electrode preparation chemistry. The use of relatively high electrodeposition current densities increased electrocatalytic activity by promoting the presence of defects in the metal oxide matrix of the catalyst (see, e.g., Lankhorst et al., H., J. Amer. Chem. Soc. 1997, 80(9), 2175-98; and Merkle et al., Topics in Catalysis 2006, 38, 141-145). The catalytic properties of the metal oxides were also influenced through other variables of the electrodeposition reaction such as the total and relative concentration(s) and composition(s) of dissolved metal salts and extra electrolytes, the pH, and the duration of the electrodeposition current, among other factors. The cathodic electrodeposition reaction was a simple method by which large numbers of catalyst compositions were explored quickly and efficiently.

The assessment of catalyst performance was based on four catalyst kinetic parameters. Two kinetic parameters described how current was exponential with respect to working potential at low current densities and two kinetic parameters described how current was linear with respect to working potential at high current densities. Water electrolysis at high current densities are preferred for some practical applications. The catalytic kinetics at low currents are called Butler-Volmer kinetics and the kinetics at high currents are called resistive kinetics.

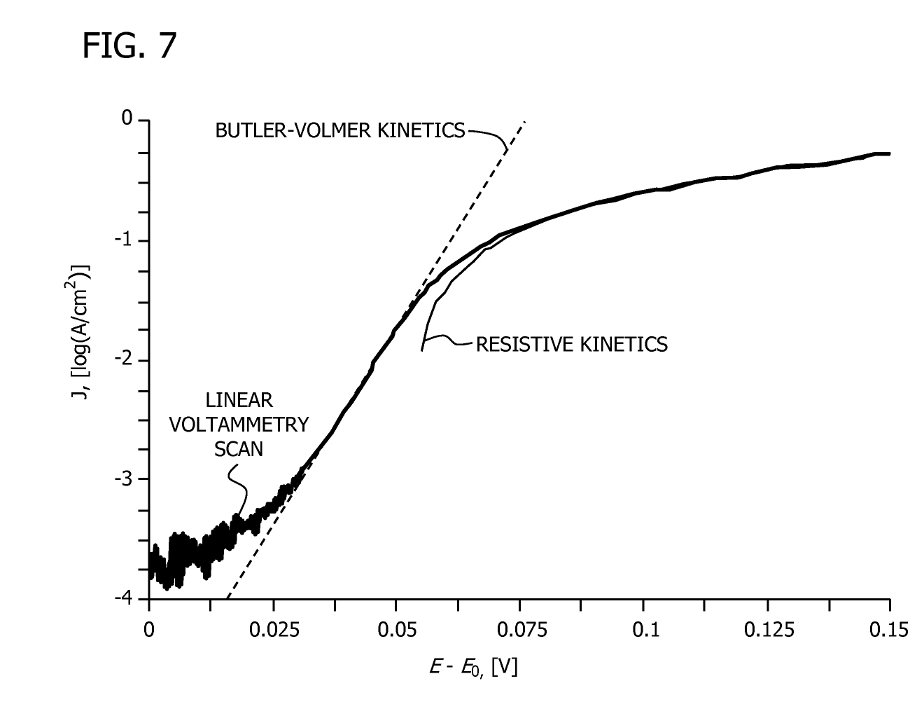

Butler-Volmer kinetics use equations (1) and (2). These equations are used for the oxygen evolution and hydrogen evolution reactions, respectively. See also Example 2. Butler-Volmer models assume a relatively negligible reverse current, where J is current density, J₀ is exchange current density, α is the electron transfer coefficient, n is the # of e⁻ per reaction, F is Faraday's constant, R is ideal gas law constant, T is absolute temperature, E is working potential, E₀ is the calculated equilibrium potential. The α and J₀ values are the two Butler-Volmer kinetic performance parameters and were determined through linear regression of a Tafel plot (see FIG. 7) where the kinetics demonstrated a linear free energy relationship. The J₀ pre-exponential factor preferably has a relatively high value for improved kinetic performance.

$$\begin{matrix}J = {J}_{o} \times {e}^{\frac{( 1 - {α}_{a} ) n F ( E - {E}_{0} )}{RT}} & ( 1 ) \\ J = {J}_{o} \times {e}^{\frac{( {α}_{c} ) n F ( E - {E}_{0} )}{RT}} & ( 2 )\end{matrix}$$

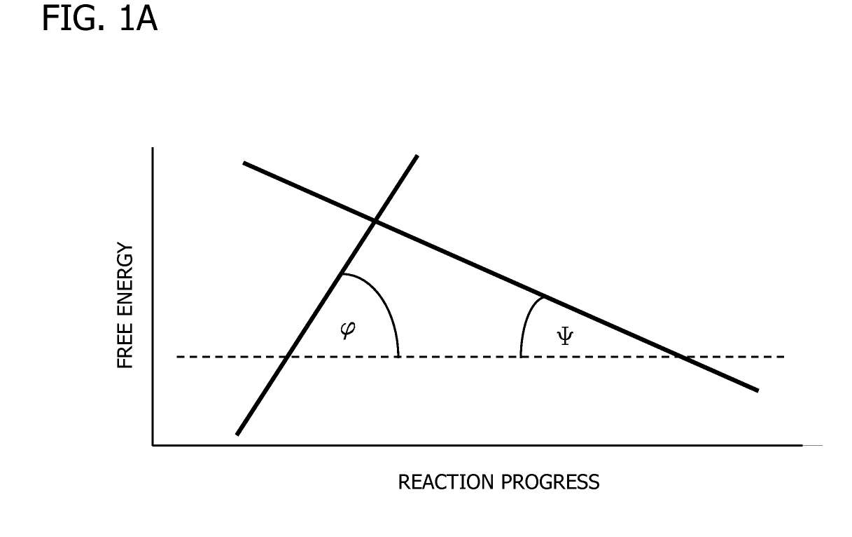

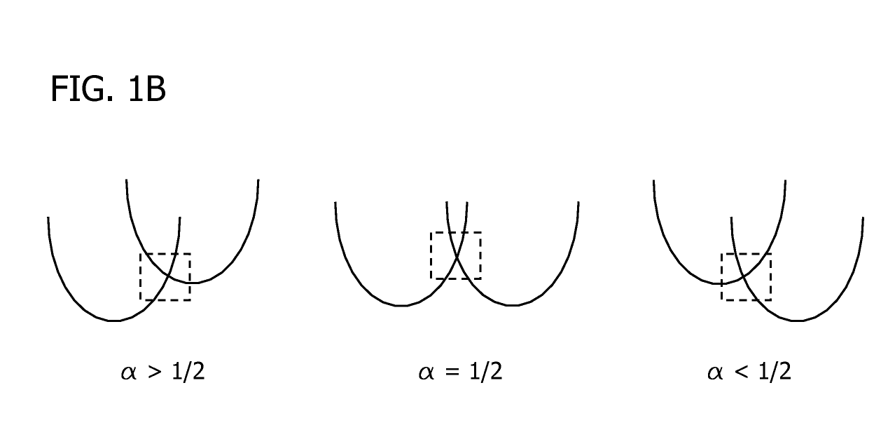

The transfer coefficient, α, of the Butler-Volmer model classically describes the symmetry of the electron transfer energy barrier. The α value represents the symmetry of interacting harmonic oscillators according to equation (3) where φ and ψ refer to the angles illustrated in FIG. 1A. The angles of FIG. 1A represent the angles of the intersecting harmonic oscillators illustrated in the boxes of FIG. 1B. The angles of the intersections themselves do not necessarily indicate whether transfer is to higher or lower energy oscillators as represented in FIG. 1B. The ideal α value for the anodic oxygen evolution reaction is 0 and the ideal α value for the cathodic hydrogen evolution reaction is 1. An ideal α value represents the angles at which φ and ψ produce the smallest energy barrier possible. Anodic and cathodic electron transfer coefficients are designated as αₐ and as α_{c}, respectively.

$$α = \frac{tan ( φ )}{tan ( φ ) + tan ( ψ )} \qquad ( 3 )$$

The catalytic kinetics at high current densities was referred to as resistive because current was linear with respect to voltage. The Butler-Volmer model as described by equations (1) and (2) did not necessarily describe the catalytic kinetics at high current densities. Equation (4) is a form of Ohm's law used for describing high current kinetics where J is current density, E is working potential, E₀ is the calculated equilibrium potential, Rₗᵢₘ is the limiting resistance area, and J_{b} is the Y-intercept current density value. The Rₗᵢₘ and J_{b} values are the two resistive performance parameters and were determined by linear regression where the relationship of current density with respect to working potential was linear at high current densities. Preferably, Rₗᵢₘ is as small as possible and J_{b} is as small as possible.

$$J = \frac{E - {E}_{0}}{{R}_{lim}} + {J}_{b} \qquad ( 4 )$$

1.2 Catalyst Synthesis

Catalysts were synthesized from an electrodeposition solution containing a final concentration of 18 mM M²⁺ (where M=Mn²⁺, Fe²⁺, Co²⁺, Ni²⁺, or Cu²⁺) for oxides composed of one transition metal element and 9 mM M²⁺ of each metal ion for oxides composed of transition metal pairs. The electrodeposition solutions also contained a final concentration of 25-250 mM NH₄A (where A=SO₄²⁻, NO₃⁻, PO₄³⁻, Cl⁻, or ClO₄⁻) electrolyte buffer and a final pH 0.0-9.0. The metal oxide catalysts were deposited with a >100 mA/cm² current density for 3-180 sec onto a square 1 cm²×25 μm pure platinum foil (Hauser and Miller) cathode. The back side of the Pt electrode and the 30 ga Pt connecting wire (Hauser and Miller) were insulated with Starbrite Liquid Electrical Tape. Water electrolysis was performed in 100 ml samples of KOH electrolyte at room temperature (22-25° C.) and pressure and in contact with the atmosphere (1 atm) during performance testing. All solutions were prepared with purified water (Barnstead, EASYpure UV).

Electrochemical experiments were performed on a Radiometer Analytical PGZ100 potentiostat/galvanostat using VoltaMaster 4.0 software with a Fisher Scientific saturated Ag/AgCl reference electrode. The three-electrode electrochemical cell consisted of a working (1 cm²), a counter electrode (1 cm²), and an Accument saturated Ag/AgCl reference electrode (13-620-53). The tip of the reference electrode was placed in contact with the catalyst/electrolyte interface of the working electrode. The working and counter electrodes were square 1 cm×1 cm×25 μm platinum foil with Starbrite Liquid Electrical Tape insulating the back side of the platinum and the 30 ga platinum connecting wire so that only one flat surface, 1 cm², is exposed to the electrolyte. Larger samples of catalysts were deposited by an Agilent N2766A power source onto both sides of a 4 cm×2.5 cm×25 μm platinum foil with two parallel, equally sized counter electrodes placed 0.5 cm away on both sides. Platinum (Hauser and Miller) was selected for use as both a control and a recyclable, conductive support for deposition of the catalysts. Fresh, concentrated sulfuric acid was used to dissolve the catalysts from the platinum after use and to polish the platinum immediately prior to use.

Linear voltammetry scans at a rate of 1 mV/sec were used to measure the relationship of current density generated from oxygen evolution with respect to the working potential. The scan rate was considered slow enough to approximate equilibrium conditions above a current density of 1 mA/cm². Linear voltammetry scans of freshly prepared electrodes were preceded by an identical scan to polarize and discharge the electrode. The electrochemical impedance data was collected over the range of 0.300-0.600 V in 10 mV steps with each step proceeded by a 1.0 minute chronocoulometry scan. Impedance was measured from 10⁵-10⁻² Hz with a 5 mV signal perturbation. Cyclic voltammetry oscillation signals were measured with three cycles from 0.200 to −0.200 V and from 10 mV/sec to 200 mV/sec in 10 mV increments. The capacitance of the catalysts was measured by cyclic voltammetry with three cycles from −0.700 to −1.000 V and from 1 mV/sec to 200 mV/sec. A Jeol JSM-5900 Scanning Electron Microscope operating at 30 KeV was used for scanning electron microscopy.

As noted above, all experimental procedures concerning efficiency were carried out in 1M KOH at room temperature (22-25° C.) and pressure. Ambient 1M KOH was considered to have a pH of 13.84 as determined theoretically and experimentally by the ionic activity coefficients correlated with the Khoshkbarchi-Vera equation and New Hydration Theory (Rodil et al., AlChE Journal, (2001) 47(12): 2807-2818). Equation (5) was used to calculate the water oxidation midpoint potential, E⁰_{O2}, of 0.399 V when considering an atmospheric O₂ partial pressure of 0.2095 atm (Pourbaix, supra). Equation (6) is used to calculate the water reduction equilibrium potential, E⁰_{H2}, of −0.945 V when considering an atmospheric H₂ partial pressure of 5×10⁻⁵ atm (see, e.g., Pourbaix, M., Atlas of Electrochemical Equilibria in Aqueous Solution, 1974, Cebelcor, Brussels; Broeker, W. S., How to Build a Habitable Planet, 2002, Eldigo Press, NY). The E⁰_{H2} is offset 1.481 V from E⁰_{O2} in alkaline conditions because the thermodynamic requirement for water electrolysis is considered to be the ΔH of water formation (see, e.g., Onda et al., Journal of Power Sources, 2004, 132, 64-70; Roy et al., International Journal of Hydrogen Energy, 2006, 31, 1964-1979).

E⁰_{O2}=1.228 V−0.0591·pH+0.0147·log(pO₂)=0.399 V (5)

E⁰_{H2}=1.228 V−0.0591·pH−1.481 V−0.0295·log(pH₂)=−0.945 V (6)

The metal oxide catalysts were created by cathodic electrodeposition of the electrodeposition solution compositions indicated in Table 1 at 250 mA/cm² for 30 sec.

TABLE 1
ELECTRODEPOSITION SOLUTION CONDITIONS

| oxide | metal salt(s) | electrolyte(s) | pH |
|---|---|---|---|
| Mn | 18 mM MnSO₄ | 125 mM NH₄ClO₄ | 1.5 w/H₂SO₄ |
| Fe | 18 mM FeSO₄ | 100 mM NH₄ClO₄ | 1.5 w/H₂SO₄ |
| Co | 18 mM CoSO₄ | 35 mM NH₄ClO₄ | 6.8 w/NH₄OH |
| Ni | 18 mM NiSO₄ | 25 mM NH₄ClO₄ | 6.0 w/NH₄OH |
| Cu | 10 mM CuSO₄ | 30 mM NH₄ClO₄ | 5.0 w/NH₄OH |
| FeMn | 9 mM FeSO₄ | 87.5 mM NH₄ClO₄ | 2.5 w/H₂SO₄ |
| | and 9 mM | | |
| | MnSO₄ | | |
| CoFe | 10 mM CoSO₄ | 30 mM NH₄ClO₄ | 5.4 w/NH₄OH |
| NiFe₍ₐ₎ | 9 mM NiSO₄ | 25 mM (NH₄)₂SO₄ | 2.5 w/NH₄OH |
| | and 9 mM | | |
| | FeSO₄ | | |
| NiFe_{(b)} | 9 mM NiSO₄ | 25 mM (NH₄)₂SO₄ | 5.9 w/NH₄OH |
| | and 9 mM | | |
| | FeSO₄ | | |
| NiCo | 9 mM NiSO₄ | 25 mM NH₄ClO₄ | 6.6 w/NH₄OH |
| | and 9 mM | | |
| | CoSO₄ | | |
| CuFe | 9 mM CuSO₄ | 50 mM NH₄ClO₄ | 4.2 w/H₂SO₄ |
| | and 9 mM | | |
| | FeSO₄ | | |
| CuNi | 9 mM CuSO₄ | 30 mM NH₄ClO₄ | 7 w/NH₄OH |
| | and 9 mM | | |
| | NiSO₄ | | |

The relationship of water oxidation kinetics with respect to electrochemical equilibria produced by the linear voltammetry scans is applied to the Butler-Volmer equation to characterize and quantify the efficiency of catalysis. The Butler-Volmer model relates electrolysis kinetics with applied working potential based on semi-classical concepts according to equation (7) in which the rate of the reverse reaction is considered negligible, α is the electron transfer coefficient, I₀ is the exchange current density, and (V−V₀) is the over-potential (Bard et al., Electrochemical Methods: Fundamentals and Applications (2d ed., 2001, John Wiley and Sons)):

log(I)=[α n F/2.303 R T](V−V₀)+log(I₀) (7)

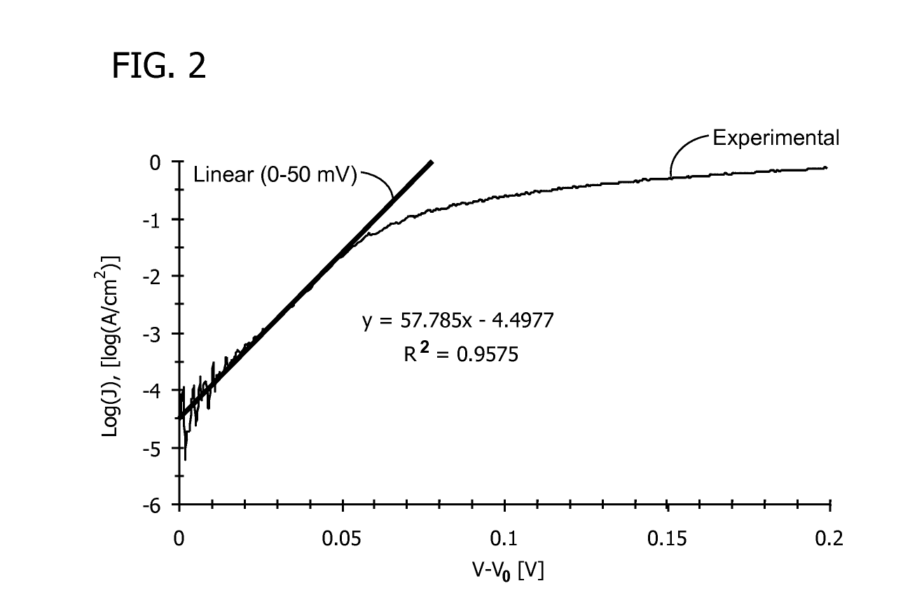

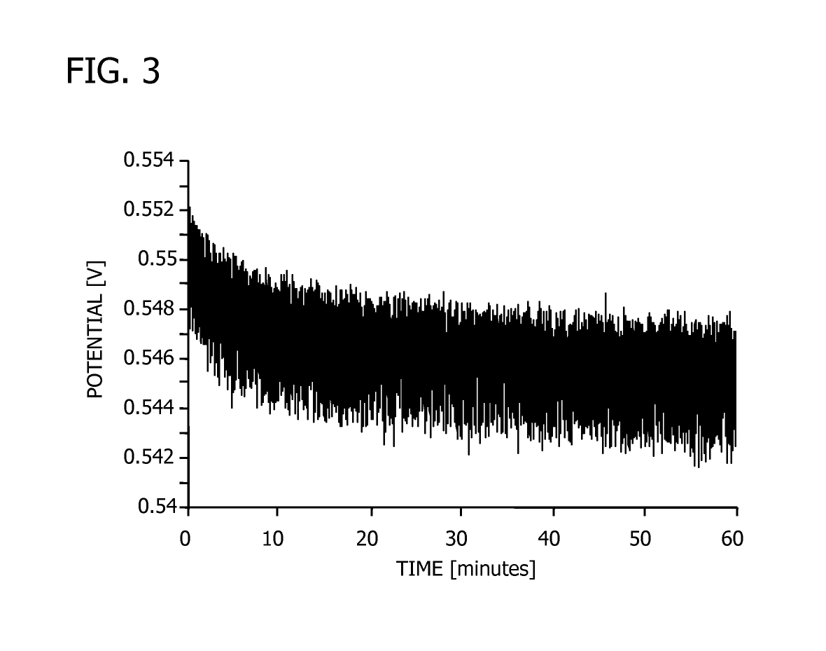

Current density was plotted against the difference between the midpoint potential for a reaction and the working potential applied to the electrode as a Tafel plot. A Tafel plot considering an oxygen evolution midpoint potential, V₀, of 0.399 V is presented in FIG. 2 for the NiFe oxide electrode (i.e., an electrode including an electrocatalytic film including a mixture of metal oxides having the formulae M¹O, (M²)₂O₃, (M³)₃O₄, and (L³)₃O₄, wherein M¹, M², M³, and L³ are selected from Ni and Fe, provided L³ and M³ are not the same). Linear regression is performed on the experimental values for the over-potential in the range of 0.000 to 0.050 V where the kinetics follow a linear free energy relationship. The linear regression trendline and the corresponding equation are also presented in FIG. 2. The slope and Y-intercept of the Tafel plot trendline are applied to equation (7) where n=4 and produces an α of 0.854 and an exchange current, I₀, of 3.18×10⁻² mA/cm². The 99.9% pure platinum support alone yielded an α of 0.155 from 0.95-1.00 V and an α of 0.017 from 1.25-1.60 V. The NiFe oxide catalyst was analyzed for stability with chrono potentiometry at a constant current density of 500 mA/cm² (see FIG. 3).

1.3 Catalyst Analysis

Metal oxide catalysts were formed by cathodic deposition of first row transition metal elements as mixed oxides, singly or in pairs, onto one side of a platinum foil electrode (1 cm²). Electrodeposition variables that were explored included: buffer composition; buffer concentration; pH; metal ion concentration; metal ion oxidation state; metal salt counter-ion; current density; and current duration. All commercially available first row transition metal ion oxidation states were examined. Ratios were explored from 1:10 to 10:1 for electrodeposition solutions containing two different transition metal elements or oxidation states. The list of metal counter anions explored included sulfate, nitrate, phosphate, chloride, perchlorate, and acetate. The majority of experiments focused on electrolytes including ammonium, sodium, and potassium cations and sulfate, sulfite, thiosulfate, persulfate, sulfamate, hydroxide, chloride, perchlorate, (mono/dibasic) phosphate, bicarbonate, carbonate, nitrate, and acetate anions. Organic compounds such as acetic acid, ethanol, methanol, citric acid, acetyl acetate, and ethylenediamine were also examined.

The catalytic kinetic parameters of the metal oxides and pure platinum support were measured with linear voltammetry scans at a potential scan rate of 1 mV/sec in 1 M KOH. Exploration of the electrodeposition variables yielded Mn, Fe, Co, Ni, Cu, FeMn, CoFe, NiFe, NiCo, CuFe, and CuNi oxides that demonstrated improved catalytic performance as compared to a pure platinum support.

Mn, Fe, Co, Ni, Cu, FeMn, CoFe, NiFe, NiCo, CuFe, and CuNi oxide catalysts were produced which demonstrated improved catalytic efficiency than the pure platinum control. That is, the electrode included an electrocatalytic film including a mixture of metal oxides having the formulae M¹O, (M²)₂O₃, (M³)₃O₄, and, in some cases, (L³)₃O₄. For the Mn oxide catalysts, M¹, M², and M³ were Mn; for the Fe oxide catalysts, M¹, M², and M³ were Fe; for the Co oxide catalysts, M¹, M², and M³ were Co; for the Ni oxide catalysts, M¹, M², and M³ were Ni; and for the Cu oxide catalysts, M¹, M², and M³ were Cu. For the FeMn oxide electrode, M¹, M², M³, and L³ are selected from Fe and Mn, provided L³ and M³ are not the same; for the CoFe oxide electrode, M¹, M², M³, and L³ are selected from Co and Fe, provided L³ and M³ are not the same; for the NiFe oxide electrode, M¹, M², M³, and L³ are selected from Ni and Fe, provided L³ and M³ are not the same; for the NiCo oxide electrode, M¹, M², M³, and L³ are selected from Ni and Co, provided L³ and M³ are not the same; for the CuFe oxide electrodes, M¹, M², M³, and L³ are selected from Cu and Fe, provided L³ and M³ are not the same, and for the CuNi oxide electrodes, M¹, M², M³, and L³ are selected from Cu and Ni, provided L³ and M³ are not the same.

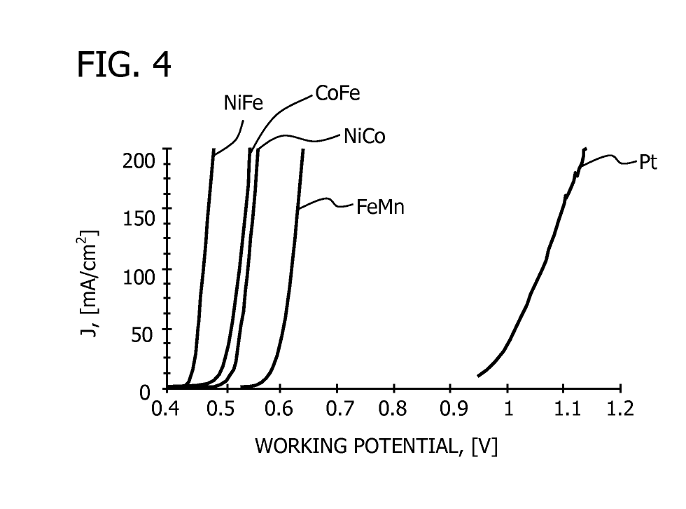

The NiFe oxide was found to have a particularly high catalytic efficiency and is thereby characterized as an example. The efficiencies of four selected thin metal oxide compositions are illustrated in FIG. 4. The 60 and I₀ values of all eleven optimized metal compositions are provided in Table 1 so that the linear free energy relationship portion of Tafel plots can be reconstructed according to equation (5) for all metal compositions. The αₐ, J₀, Rₗᵢₘ, and J_{b} values for the optimized electrodeposition conditions of the eleven metal compositions are provided in Table 2:

TABLE 2
LINEAR FREE ENERGY RELATIONSHIP A AND LOG(I₀)
PARAMETERS FOR OXYGEN EVOLUTION.

| Catalyst | | |
|---|---|---|
| composition | α | Log (I₀) |
| Mn | 0.159 | −4.39 |
| Fe | 0.695 | −10.02 |
| Co | 0.340 | −4.86 |
| Ni | 0.306 | −4.43 |
| Cu | 0.205 | −5.99 |
| FeMn | 0.409 | −6.92 |
| CoFe | 0.454 | −4.94 |
| NiFe | 0.854 | −4.59 |
| NiCo | 0.485 | −5.66 |
| CuFe | 0.465 | −8.44 |
| CuNi | 0.222 | −4.00 |

TABLE 3
BUTLER-VOLMER AND RESISTIVE KINETIC
DATA FOR OXYGEN EVOLUTION IN 1 M KOH.

| Catalyst | | J₀, | Rₗᵢₘ, | J_{b}, |
|---|---|---|---|---|
| Composition | αₐ | [A/cm²] | [ohm · cm²] | [A/cm²] |
| Mn | 0.841 | 4.05 × 10⁻⁵ | 0.181 | −0.328 |
| Fe | 0.305 | 9.66 × 10⁻¹¹ | 0.209 | −0.163 |
| Co | 0.660 | 1.39 × 10⁻⁵ | 0.209 | −0.158 |
| Ni | 0.694 | 3.73 × 10⁻⁵ | 0.183 | −0.149 |
| Cu | 0.795 | 1.12 × 10⁻⁶ | 0.581 | −0.309 |
| FeMn | 0.591 | 1.19 × 10⁻⁷ | 0.187 | −0.205 |
| CoFe | 0.546 | 1.16 × 10⁻⁵ | 0.149 | −0.130 |
| NiFe₍ₐ₎ | 0.008 | 9.04 × 10⁻⁶ | 0.183 | −0.053 |
| NiCo | 0.515 | 2.17 × 10⁻⁶ | 0.137 | −0.140 |
| CuFe | 0.535 | 3.31 × 10⁻⁹ | 0.168 | −0.225 |
| CuNi | 0.778 | 1.01 × 10⁻⁴ | 0.190 | −0.194 |

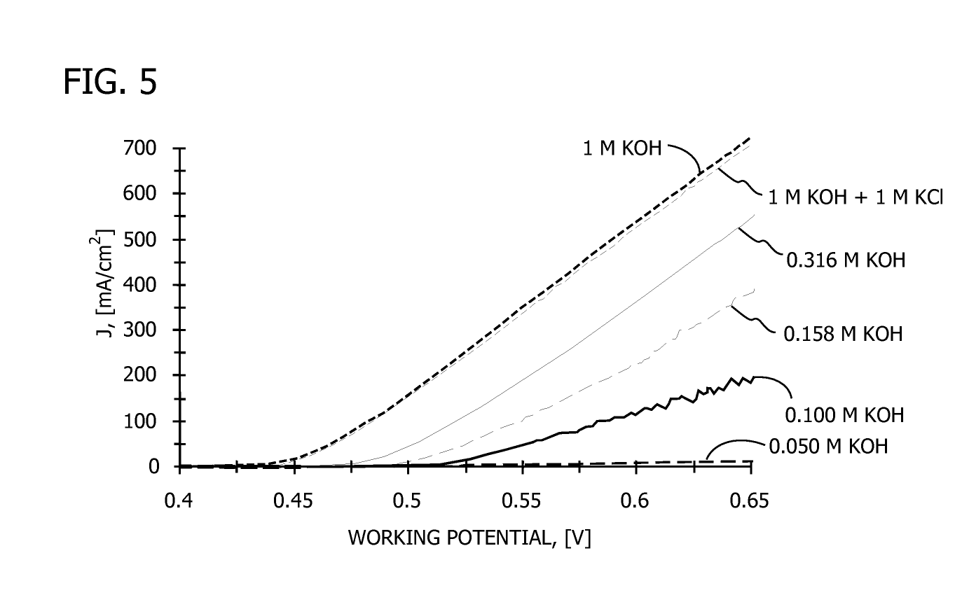

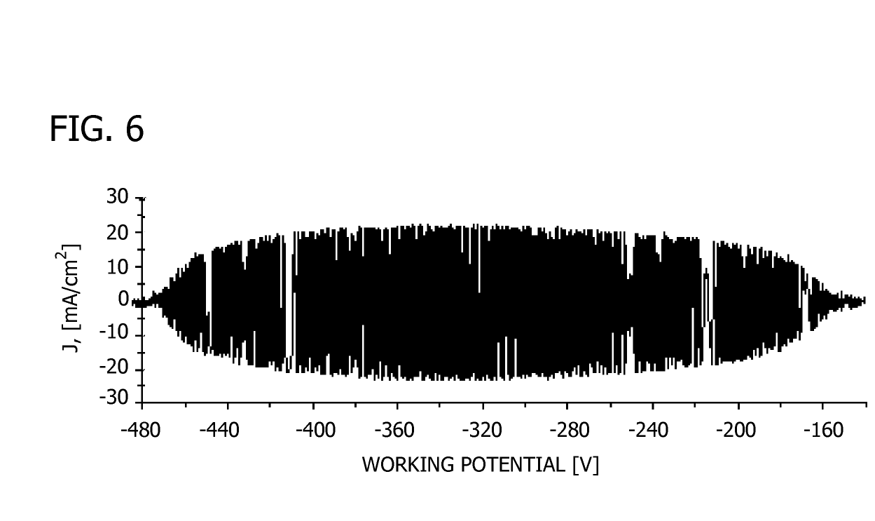

The catalytic efficiency of a NiFe oxide was compared in 1, 0.316, 0.158, 0.100, and 0.050 M KOH and in 1 M KOH+1 M KCl electrolytes (see FIG. 5). The experimental oxygen evolution midpoint potential remained consistent with the calculated midpoint potential for each pH. The solution resistance was found to be constant above 0.316 M KOH while dropping linearly with respect to pH below 0.316 M KOH. The electron transfer coefficient and exchange current density did not change with electrolyte composition. The presence of chloride ions did not appear to significantly affect the kinetics of oxygen evolution when [OH⁻]±[Cl⁻]. A relaxation signal containing definite structure was obtained from the NiFe oxide matrix after high current electrolysis. FIG. 6 illustrates this signal in 1 M KOH+1 M KCl. There was no net current during the observed signal and may be indicative of electron exchange between two or more metal oxidation states upon achieving a new equilibrium at lower potentials.

The NiFe oxides demonstrated the best overall catalytic performance for the oxygen evolution reaction because it demonstrates the smallest αₐ values in combination with one of the greatest J₀ values and was therefore selected for further characterization. Similar catalytic parameters were obtained for NiFe oxide catalysts deposited in acidic (pH 2.5) and more basic (pH 5.9) electrodeposition conditions and were identified as NiFe₍ₐ₎ and NiFe_{(b)}, respectively. The catalytic performance of the NiFe₍ₐ₎ conditions were consistently reproducible while the catalysts deposited from NiFe_{(b)} required immediate deposition after solution preparation due to iron precipitation at pH 5.9. In the case of each analytical method, the NiFe₍ₐ₎ and NiFe_{(b)} oxide underwent a 1 mV/s linear voltammetry scan in 1 M KOH after electrodeposition in order to polarize the catalyst for oxygen evolution and to ensure that the αₐ was less than 0.05. FIG. 7 illustrates a Tafel plot of a NiFe₍ₐ₎ oxide with an αₐ value of 0.008. An αₐ value of 0.008 represents a >99% ideal electron transfer efficiency. The pure platinum foil support alone yielded a αₐ of 0.155 from 0.95-1.00 V and a second αₐ of 0.017 from 1.25-1.60 V. FIG. 7 illustrates how the four kinetic parameter values (α, J₀, Rₗᵢₘ, and J_{b}) gave a reasonably complete description of the electrode kinetics at a given overpotential for the oxygen evolution reaction.

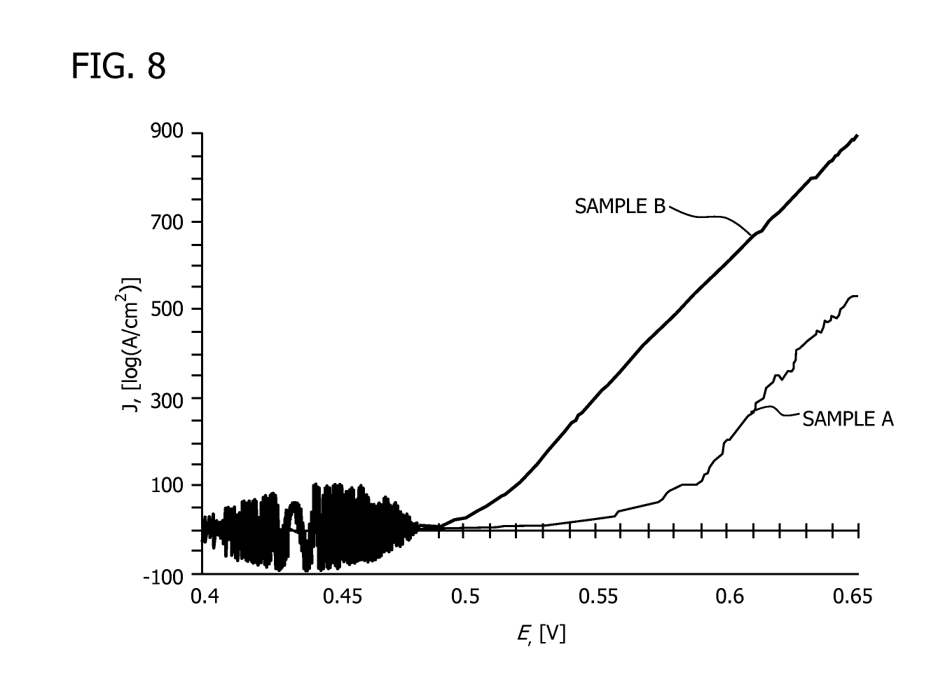

The inclusion of extra electrolytes in the electrodeposition solution and the use of relatively greater electrodeposition current densities were among the variables explored. In general, cathodic electrodeposition at high current densities yielded catalysts were preferred from a performance standpoint. The effect of electrodeposition current densities on the kinetics of a NiFe oxide created from solutions containing 5.15 mM Fe(ClO₄)₂, 12.85 mM Ni(ClO₄)₂, and 100 mM NH₄ClO₄, with adjusted to pH 0.5 with H₂SO₄ is illustrated in FIG. 8.

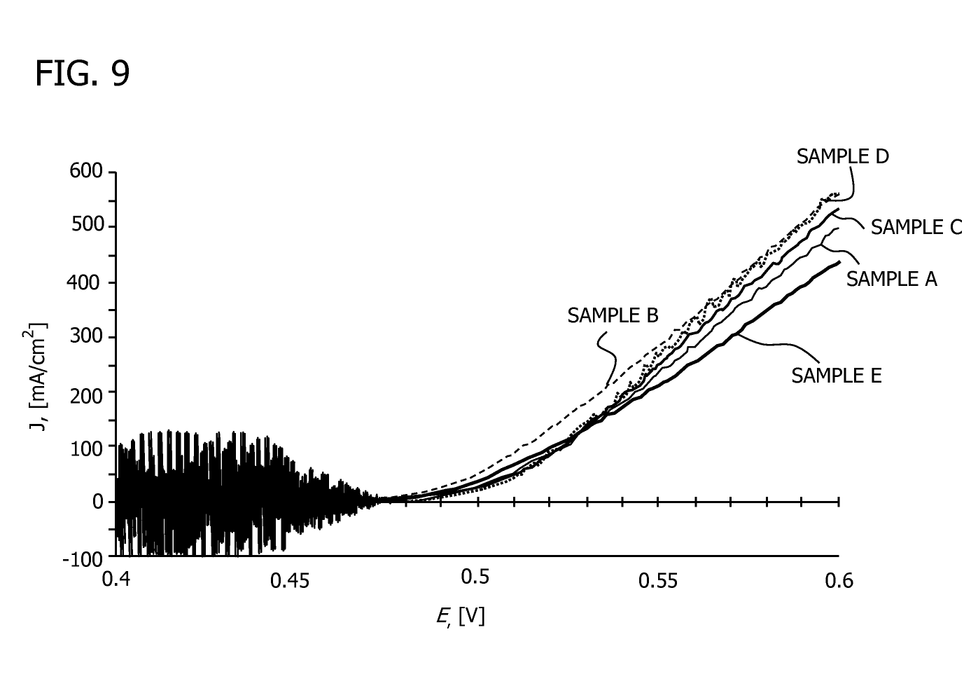

The inclusion of electrolytes in the electrodeposition solution refers to the electrolytes in addition to the metal salts and the acids or bases used to adjust pH. FIG. 9 and Table 1 indicate how catalysts with optimal kinetic performance were created from electrodeposition solutions containing ammonium and hard anions. The hardest anions behaved similarly in the majority of conditions although changes in catalytic kinetics were often correlated with the pKa's of the conjugate acids of the anions. FIG. 9 illustrates how similar catalytic kinetics resulted when the anions all had only one negative charge due to pH and were at least 1.0 pH unit away from a pKa when the electrodeposition solution contained only Fe²⁺ ions and had the same ammonium concentration. The electrodeposition conditions of the NiFe oxide catalysts illustrated in FIG. 9 are reported in Table 4.

TABLE 4
THE ELECTRODEPOSITION SOLUTION CONDITIONS
FOR THE NIFE OXIDES ILLUSTRATED IN FIG. 9.

| | | | | |
|---|---|---|---|---|
| Catalyst A: | 9 mM | 9 mM | 50 mM | pH 3.0 w/ |
| | FeCl₂ | NiCl₂ | NH₄Cl | HCl |
| Catalyst B: | 9 mM | 9 mM | 25 mM | pH 3.0 w/ |
| | FeSO₄ | NiSO₄ | (NH₄)₂SO₄ | H₂SO₄ |
| Catalyst C: | 9 mM | 9 mM | 50 mM | pH 3.0 w/ |
| | Fe(ClO₄)₂ | Ni(NO₃)₂ | NH₄NO₃ | HNO₃ |
| Catalyst D: | 9 mM | 9 mM | 50 mM | pH 3.0 w/ |
| | Fe(ClO₄)₂ | Ni(ClO₄)₂ | NH₄ClO₄ | HNO₃ |
| Catalyst E: | 9 mM | 3 mM | 50 mM | pH 3.0 w/ |
| | FeSO₄ | Ni₃(PO₄)₂ | H₂NH₄PO₄ | H₃PO₄ |

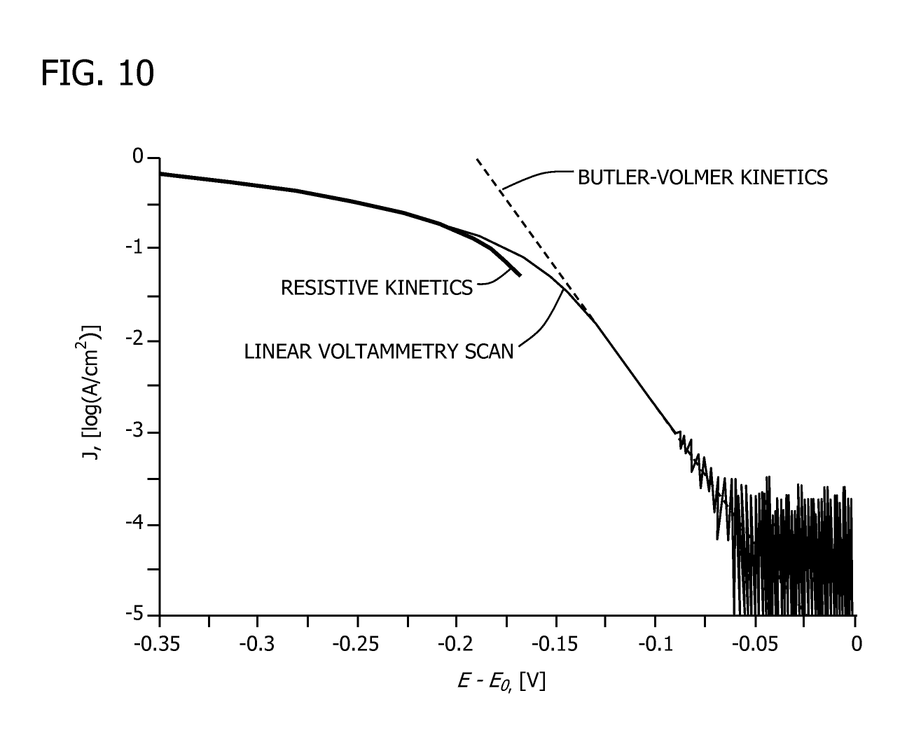

The electrodeposition conditions of NiFe oxide catalysts were explored for optimal hydrogen evolution reaction kinetics. The electrodeposition conditions optimal for oxygen evolution kinetics were empirically determined to also be optimal for hydrogen evolution kinetics. FIG. 10 is a Tafel plot of the hydrogen kinetics on a NiFe₍ₐ₎ oxide catalyst measured with linear voltammetry scan at a scan rate of −1 mV/sec in 1 M KOH. The NiFe₍ₐ₎ oxide hydrogen evolution kinetic parameters illustrated in FIG. 10 correspond to an α_{c} of 0.895, a J₀ of −1.85×10⁻⁶ A/cm², a Rₗᵢₘ, of 0.293 Ohm·cm², and a J_{b} of 0.522 A/cm².

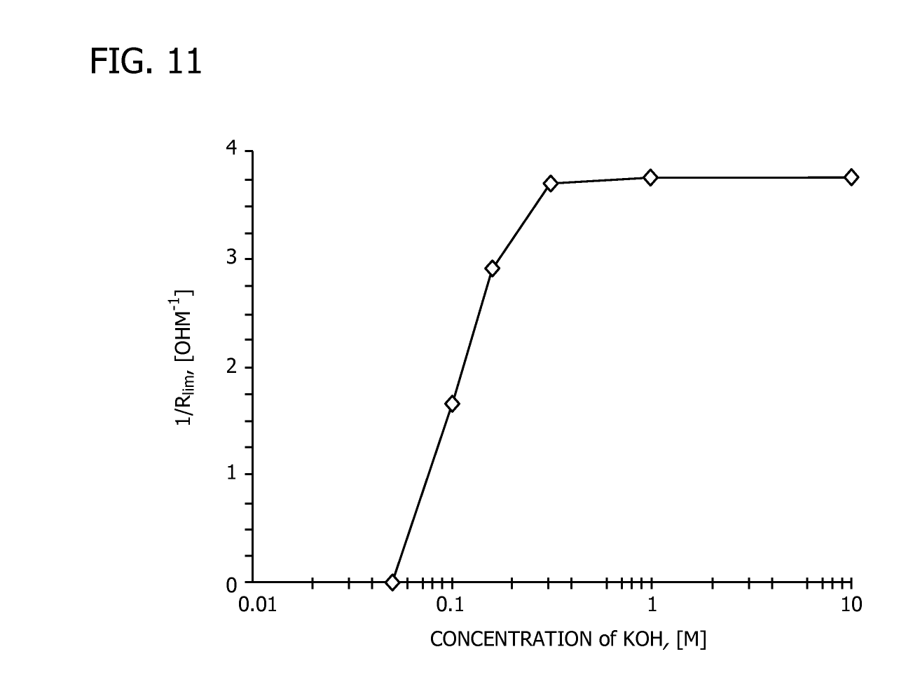

NiFe oxide's oxygen evolution performance was examined by varying the concentration of KOH in the electrolysis solution. Linear voltammetry scans with a velocity of 1 mV/sec were collected on a NiFe oxide in 0.050, 0.100, 0.158, 0.316, 1.00, and 10.000 M KOH electrolytes. The αₐ and J₀ of the NiFe oxide catalyst did not appear to significantly change with respect to KOH concentration. The Rim remained constant above 0.316 M KOH yet became smaller at lower concentrations of KOH. FIG. 11 illustrates the change in Rₗᵢₘ with respect to the KOH concentration by plotting the inverse of Rₗᵢₘ against the log of [KOH]. The dependence of Rₗᵢₘ on the conductivity of the electrolyte was examined by adding KCl to the KOH solution. The presence of chloride ions did not appear to significantly affect oxygen evolution kinetics when [OH⁻]≧[Cl⁻]. The oxygen evolution reaction was severely inhibited when [OH⁻]<[Cl⁻] and the evolution of Cl₂ is dominant as detected by linear voltammetry and olfaction. Other catalyst compositions demonstrated similar pH dependence and reactivity with Cl⁻ despite elemental composition.

Cyclic voltammetry and electrochemical impedance spectroscopy were performed on the NiFe oxide oxygen evolution catalyst to identify active half-reactions in the NiFe oxide. Cyclic voltammetry scans of the metal oxide catalysts did not produce peaks that resulted from the net charge transfer of oxidation-reduction couples active within the catalyst. The metal oxide catalysts developed in this work produced oscillating signals in response to linear changes in working potential and for constant potentials at low current densities. An oscillating current in response to linear changes in working potential indicates charge movement and rearrangement within the metal oxide rather than net charge transfer between the metal oxide catalyst and the KOH electrolyte. The amplitude and frequency of the oscillation signal of FIG. 12 can result in over a coulomb of charge rearrangement within a second for slower scan rates. Analysis of the oscillations revealed that the height of the signals decreased at higher cycle velocities by 1 mA/cm² per mV/sec for the range of 1 mV/sec to 200 mV/sec.

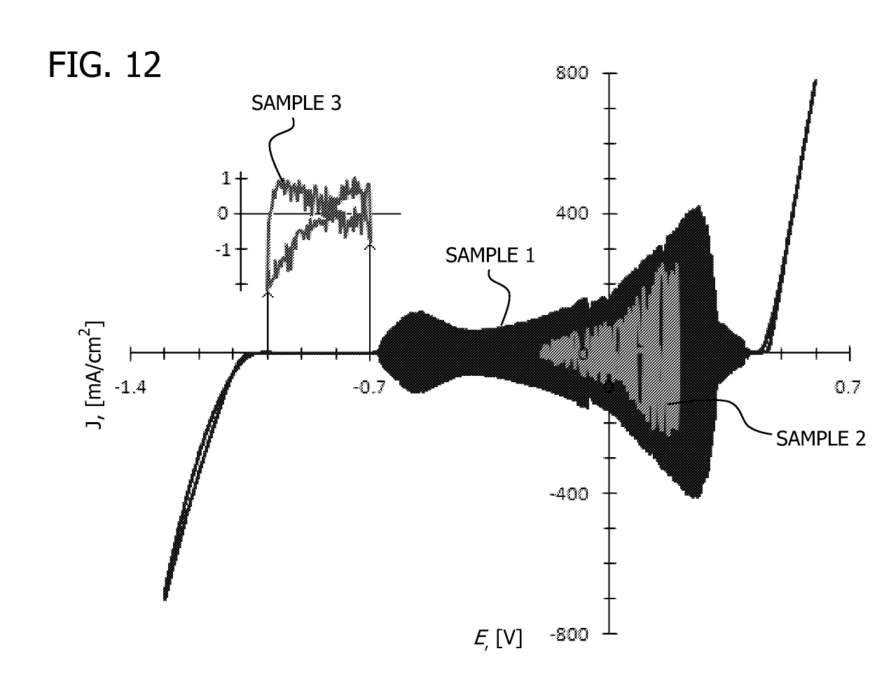

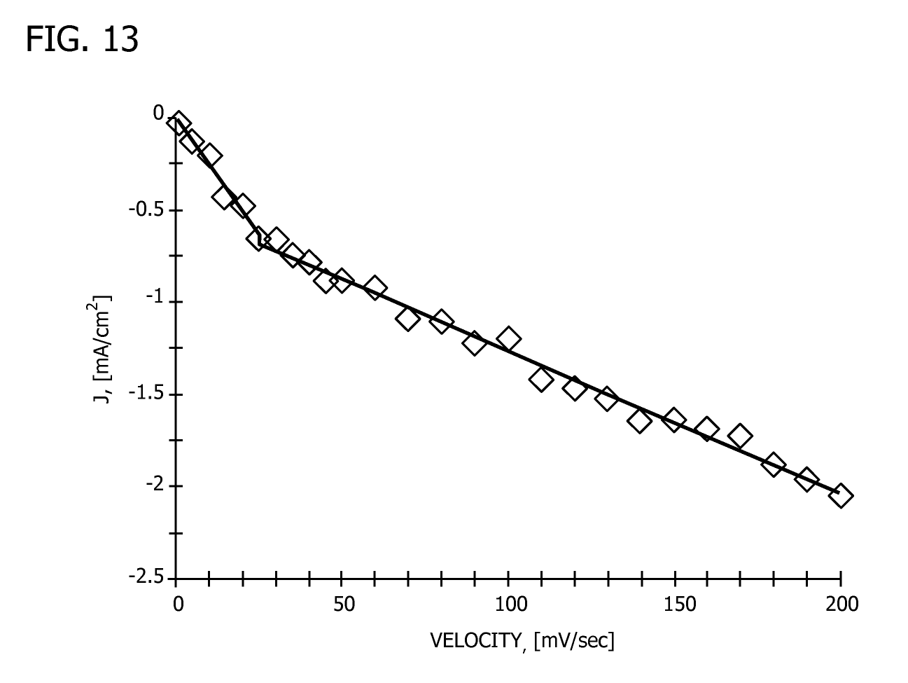

The surface morphology of the NiFe oxide catalyst was electrochemically assessed with cyclic voltammetry where the catalyst demonstrated the most capacitive behavior (line 3 of FIG. 12) according to the procedure of Da Silva et al. (Electrochemica Acta, 2001, 47, 395-403). The current densities of the negative current peak are plotted against cycle velocity in FIG. 13. The reported current densities represent the average current density of the negative peak between −0.975 and −1.000 V due to the noise of the system observed for all cycle velocities. The NiFe oxide catalyst demonstrated two regions of linear capacitance characteristic of rugged electrode films (Da Silva et al., supra). The total differential capacitance, C_{d}, was measured to be 25.7 mF, the external differential capacitance, C_{d,e}, was measured to be 7.8 mF, and the morphology factor, φ, was determined to be 0.70.

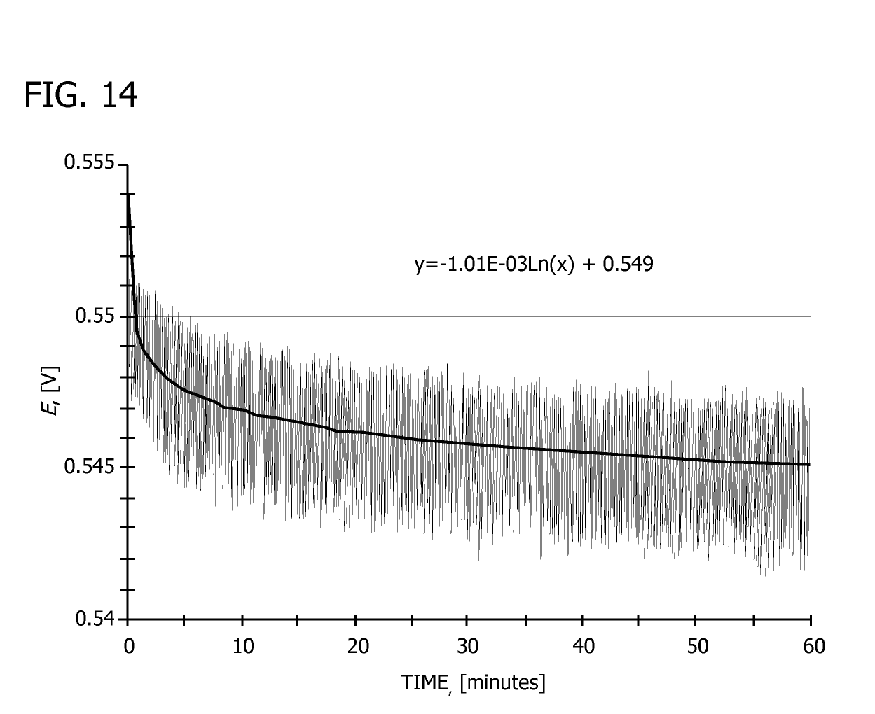

Chronopotentiometry scans were performed on the NiFe oxides to demonstrate that the catalyst was sufficiently stable throughout the period of time required to collect an impedance spectrum. FIG. 14 is a chronopotentiometry scan recorded for a NiFe_{(b)} oxide catalyst at 500 mA/cm² for one hour. The short-term stability indicates that the catalyst demonstrates reasonably constant behavior during the time required to collect impedance spectra and is also promising for long-term durability. The NiFe oxide catalysts underwent an apparent relaxation through which the catalyst became more efficient with time.

Electrical impedance spectroscopy (EIS) was used to analyze the frequency-dependant kinetics of the NiFe oxide matrix in 1 M KOH at room temperature and pressure. Each impedance scan measured from 10⁵ to 10⁻² Hz (20 data points per decade) with a 5 mV perturbation amplitude. While portions of some of the electrochemical impedance features are observed to extend to higher frequencies, the electrochemical workstation was limited to 10⁵ Hz. Impedance scans were recorded at working potentials ranging from 0.300 V to 0.600 V in 10 mV increments. Each impedance scan was preceded with a 1.0 minute chrono coulometry scan at the respective working potential to establish pre-equilibrium. An electrochemical workstation safety mechanism response of “current disjunction” was found to cease the data collection program at both lower potentials and frequencies.

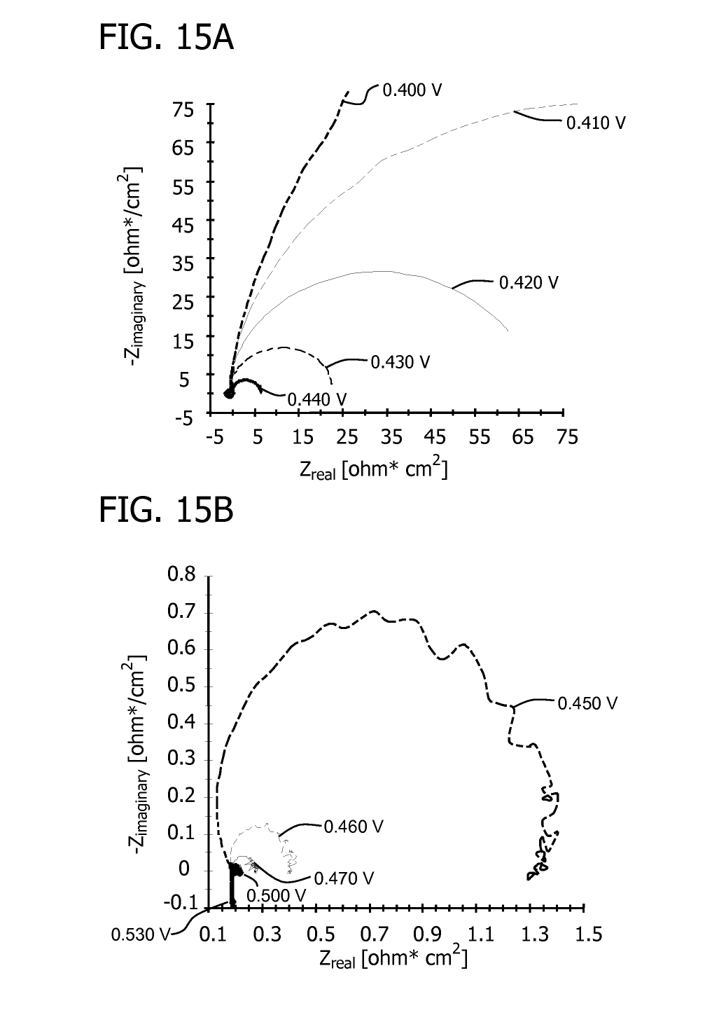

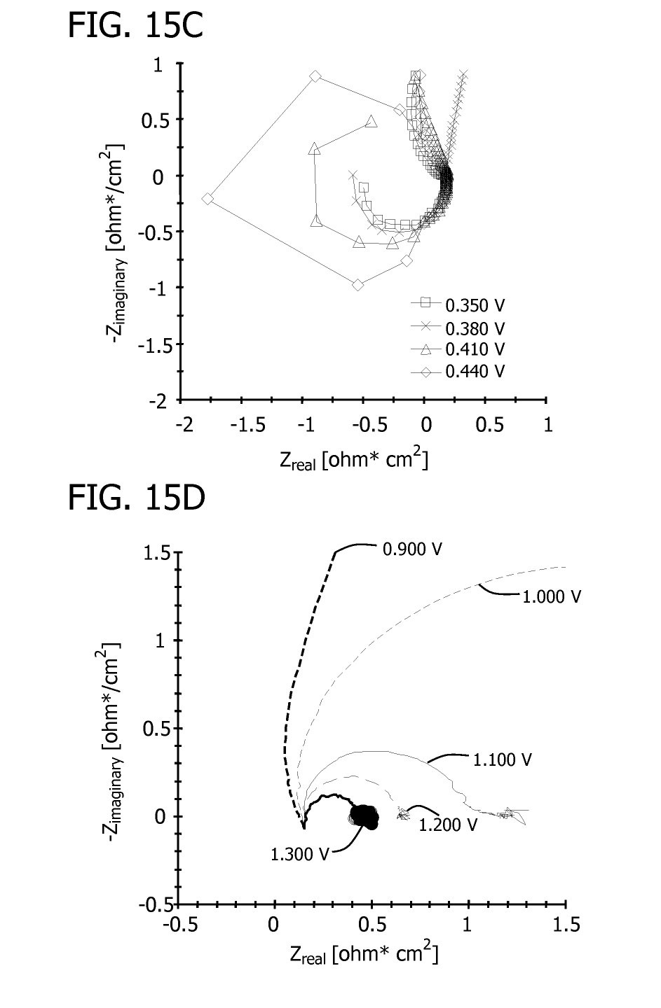

Nyquist plots present the real versus imaginary resistance components of the impedance-area for the electrode. Nyquist plots of 0.400-0.440 V and 0.450-0.530 V potential ranges are presented in FIGS. 15A and 15B, respectively. The higher frequencies appear in the inductive loop and the lower frequencies appear in the capacitive loop. The inductive loop for 0.350-0.440 V is more clearly represented in FIG. 15C. One feature of the Nyquist plots for the catalysts is that the real resistance, Zᵣ, of the capacitive loop becomes negative from 0.400 to 0.440 V and ˜3.0 to 0.5 Hz in the capacitive loop (FIG. 15C). The inductive loop spans from >10⁵ Hz to ˜20² Hz and was considered a relatively significant part of the spectra. Only one arc and therefore one time domain was observed in the inductive loop below 0.380 V while two distinct arcs and therefore two time domains were observed above 0.380 V in FIG. 15C. EIS was performed on the pure platinum support including the insulating backing from 0.900-1.500 V in 50 mV intervals. The inductive loop was not observed in the EIS spectra of the platinum without catalyst and was not considered an artifact of the experimental setup (FIG. 15D).

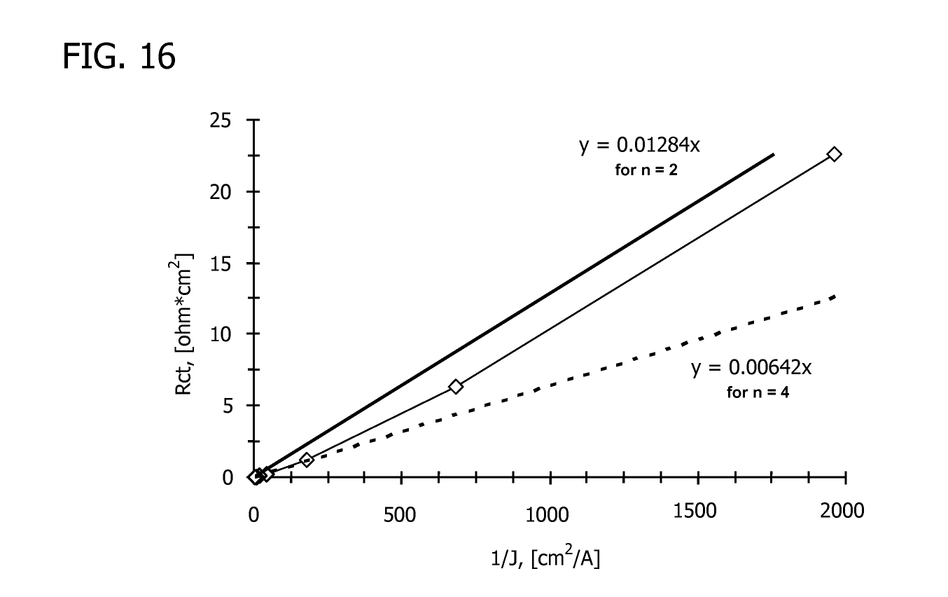

The electrolyte solution resistance, Rₛₒₗₙ, and charge transfer resistance, R_{ct}, were measured according to the Nyquist plots. The Rₛₒₗₙ measured from EIS was determined to be 0.187±0.001 Ohm*cm². The Rₛₒₗₙ measured from EIS was in fair agreement to the Rₛₒₗₙ measured as 0.177 Ohm*cm² from the slope of the linear portion of the linear voltammetry scan illustrated in FIG. 4. The R_{ct} is presented in FIG. 16 with respect to the inverse of current density for potentials 0.430-0.500 V. The R_{ct} is related to current density, I, according to equation (8) where n is the number of electron(s) per transfer in the rate-limiting step within the context of the resolution in time scale of EIS:

R_{ct}=R T/n F I (8)

Theoretical lines and their respective slopes are included in FIG. 16 where the number of electrons, n, is equal to 2 or to 4 of equation (8). The experimental slope of FIG. 16 indicated that 2 electrons were transferred at a time at the smaller current densities where R_{ct}>>Rₛₒₗₙ and the kinetics demonstrated a linear free energy relationship which extends up to 0.450 V. The slope of the data points corresponding to working potentials above 0.450 V indicated that all four electrons of the water oxidation reaction were transferred simultaneously in the rate limiting step.

The electrochemical workstation measured the current density in addition to the phase angle and the corresponding scalar component for each data point. Positive current densities were recorded at all frequencies ranging from 10⁵ to 10⁻² Hz and working potentials ranging from 0.300 to 0.600 V. The current densities observed at 0.450 V and below were composed of two, three, or four discreet values ranging from 1.241×10⁻³ A/cm² (at 0.300 V) to 1.31×10⁵ A/cm² (at 0.360 V). Only one discreet current density value was observed for working potentials above 0.450 V. The current density of 1.094×10⁻³ A/cm² was measured at 0.430 V from 10⁵ to 10^{0.2} Hz and was the only current density which, when applied to equation (8), yielded a circumstance where n=1.0 electron(s) transferred in the rate-limiting step.

Electrochemical impedance spectroscopy (EIS) oscillates the working potential voltage with a set perturbation signal through a range of frequencies and measures phase angle, θ, and the impedance resistance scalar, Z, by which the resulting voltage and current sine waves are out of phase. The phase angle, θ, is reported here in radians and the impedance resistance, Z, has units Ohm*cm². FIGS. 17A and 17B are Bode plots which represent θ and Z, respectively, against frequency and applied working potential. Data point values which could not be measured due to “current disjunction” were entered as −π radians and 0 Ohm*cm² in FIGS. 17A and 17B, respectively, due to the nature of the graphics program. Either chaotic or complex signal structure is observed at 0.300-0.320 V for frequencies below 1 Hz in FIGS. 17A and 17B which may be related to the observed ‘current disjunction’ which prevented measurements at the voided data points. Also, the graphics program could not faithfully illustrate the ∓ radian transition which occurs at the highest frequencies of working potentials at 0.380 V and above and so the negative radian values are entered at +Tr.

FIG. 17A clearly illustrates how the inductive loop dominated the higher frequencies. FIG. 17B also illustrates two more prominent time domains in the capacitive loop. The higher frequency time domain of the capacitive loop was most apparent at potentials below the midpoint potential of water oxidation and the phase angle, θ, reaches a minimum of −2.37 Radians at 0.300 V. The lower frequency time domain of the capacitive loop was less clearly illustrated at the lowest measured potentials due to current disjunction. The phase angle, θ, of the lower frequency time domain reaches a minimum of −1.78 Radians at 0.430 V. The higher frequency time domain slowed down and the lower frequency time domain sped up at higher working potentials. The rate of the low and high frequency time domains aligned and became similar as θ approached the limit of 0 Radians at 0.470 V. The impedance resistance, Z, was observed to be largest at the lower frequencies and working potentials and reached 360 Ohm*cm² at 0.360 V and 10⁻² Hz. The rate at which the impedance resistance, Z, became smaller with respect to potential was observed to pass through an inflection point at approximately 0.400 V and Z quickly approached the limit of the solution resistance by 0.470 V in FIG. 17B.

Ohm's Law was then applied in the impedance analysis. By multiplying the impedance scalar, Z (Ohm*cm²), with the measured current density, J (A/cm²), according to equation (9) the resulting impedance potential, Q, now had units in volts.

Q=J×Z (9)

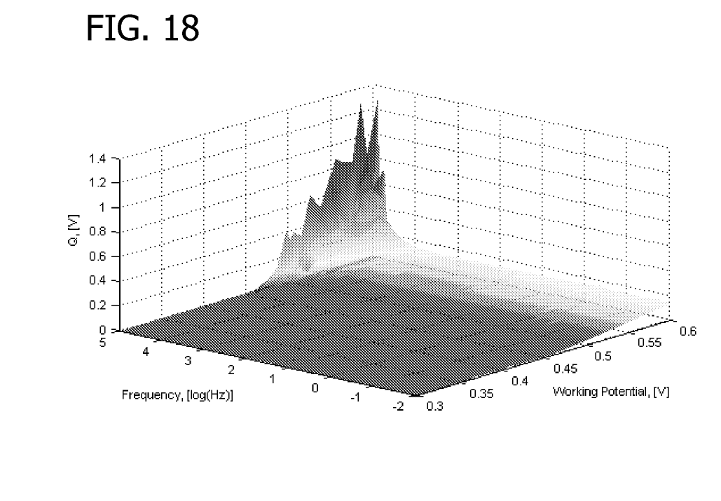

FIG. 18 illustrates the relationship of the impedance potential, Q, with frequency and working potential where, as in FIG. 17B, the voided values are entered as zero. FIGS. 17B and 18 indicate the distinct difference between the impedance resistance, Z, and the impedance potential, Q. FIG. 18 illustrates the impact of the inductive loop time domain which appeared at working potential of 0.390 V and above in the higher frequencies. The peak found in the high frequency and high working potential range represented a very dynamic region whose topographical resolution appears limited by the electrochemical workstation's frequency resolution limit of 20 data points per frequency decade. FIG. 18 also indicates that the impedance potential, Q, increased linearly with respect to applied working potential at 0.470 V and above.

The application of Ohm's Law allowed real and imaginary impedance potential components to be reported as the electric potential, E, and magnetic potential, F, of the electromagnetic spectrum according to equations (10), (11), and (12).

E=Q×cos(θ) (10)

F=Q×sin(θ) (11)

Q²=E²+F² (12)

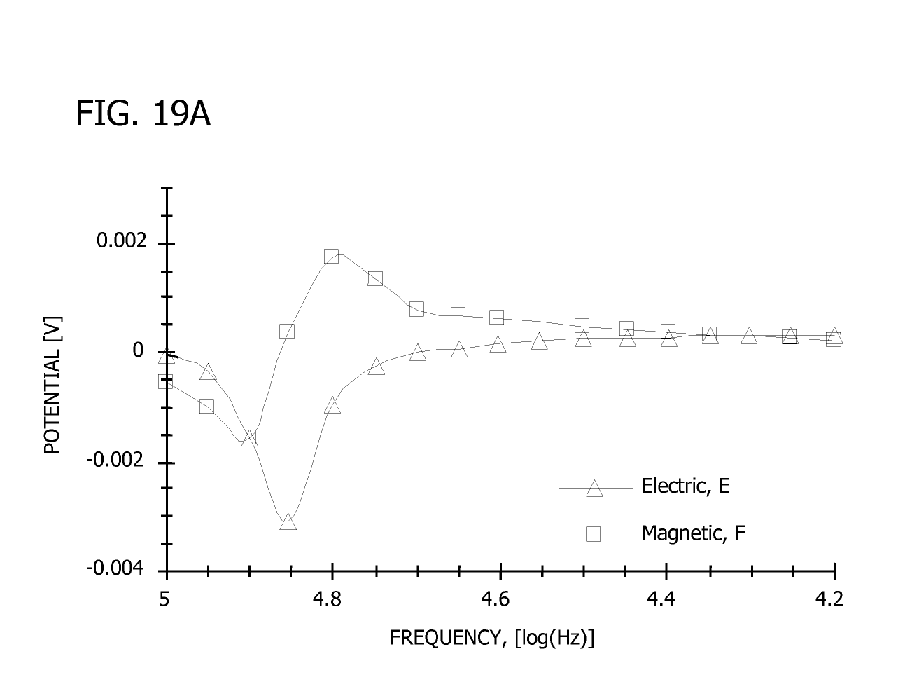

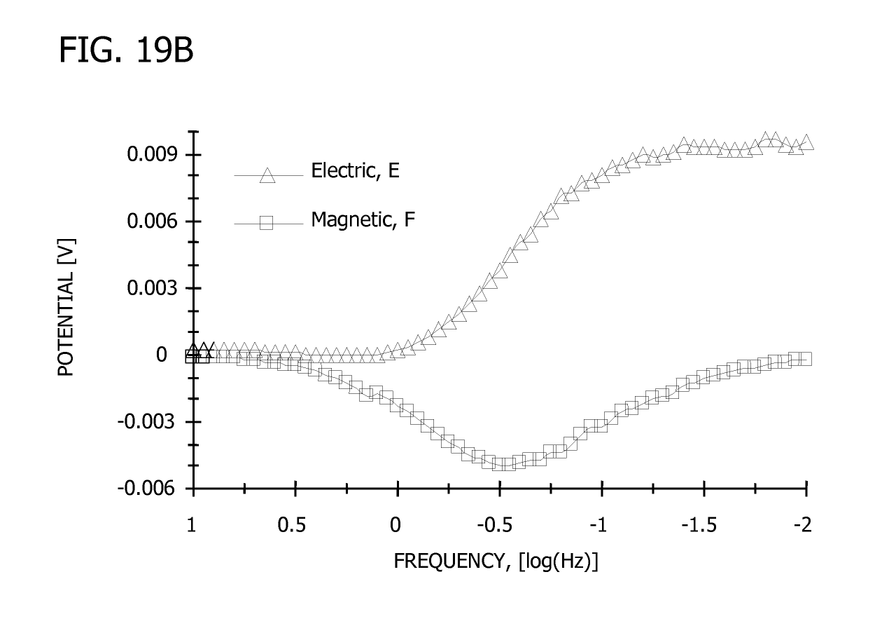

The magnetic potential was retained in units of volts so that the electric and magnetic values were of the same scale and to facilitate numerical conversion. Two main features were now observed in the electrochemical impedance spectra, one at high frequency and one at low frequency (FIGS. 19A and 19B, respectively). In both features the electric and magnetic potentials were observed to be π/2 radians out of phase with each other. A complete wave for electric and magnetic components appears in FIG. 19A and the electric component limits at the potential resulting from solution resistance. In FIG. 19B a complete wave appears for the magnetic component while only ½ of a wave appears for the electric component. The potential of the electric component resulted from not completing the wave results from charge transfer resistance.

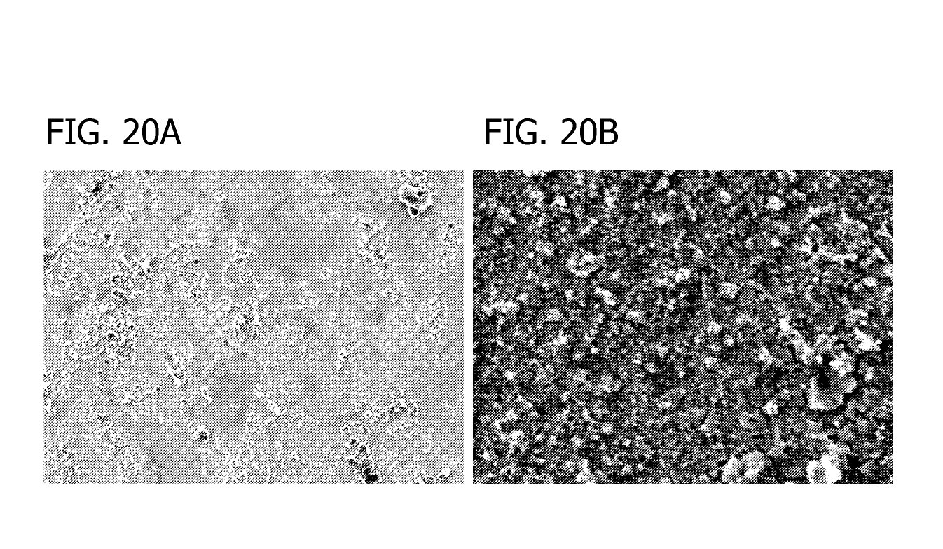

Elemental analysis and scanning electron microscope (SEM) images of optimized NiFe oxide electrodes were obtained with a Joel JSM-5900 Scanning Electron Microscope at 30 KeV. The elemental analysis reported % 72.1±0.4 Ni and % 27.8±0.5 Fe. SEM images at 100× and 2,000× magnification are presented in FIGS. 20A and 20B, respectively. Elemental analysis also verified that the purity of the platinum support was greater than 99.95% Pt.

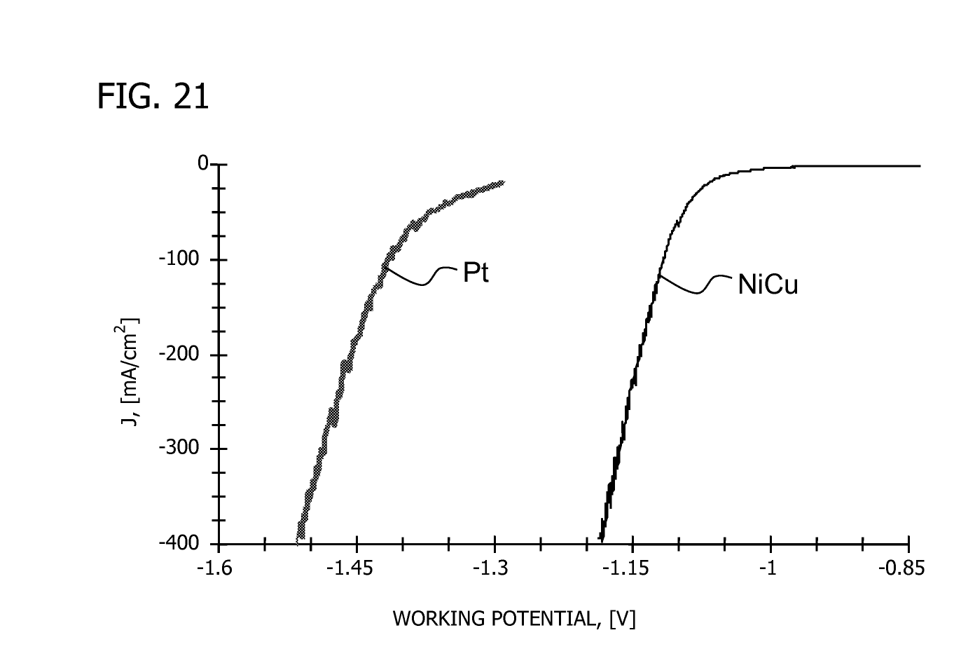

The metal oxides developed according to the above-described processes can also be used for the evolution of hydrogen gas through water reduction in 1 M KOH (see also Example 2). Linear voltammetry scans at a rate of −1 mV/sec were used to present the relationship of current density generated from hydrogen evolution with respect to the working potential for the NiCu oxide in comparison with the pure platinum (see FIG. 21). The NiCu oxide improved the efficiency of the hydrogen evolution reaction. The heat of formation, ΔH_{f}, of water was 285.84 kJ or 1.481 V at room temperature and pressure. Equation (13) was used to calculate the hydrogen evolution midpoint potential considering a pH of 13.84 and an atmospheric H₂ partial pressure of 5×10⁻⁷ atm.

E_{H2}=1.228 V−0.0591*pH−1.481 V−0.0295*(pH₂)=−0.885 V (13)

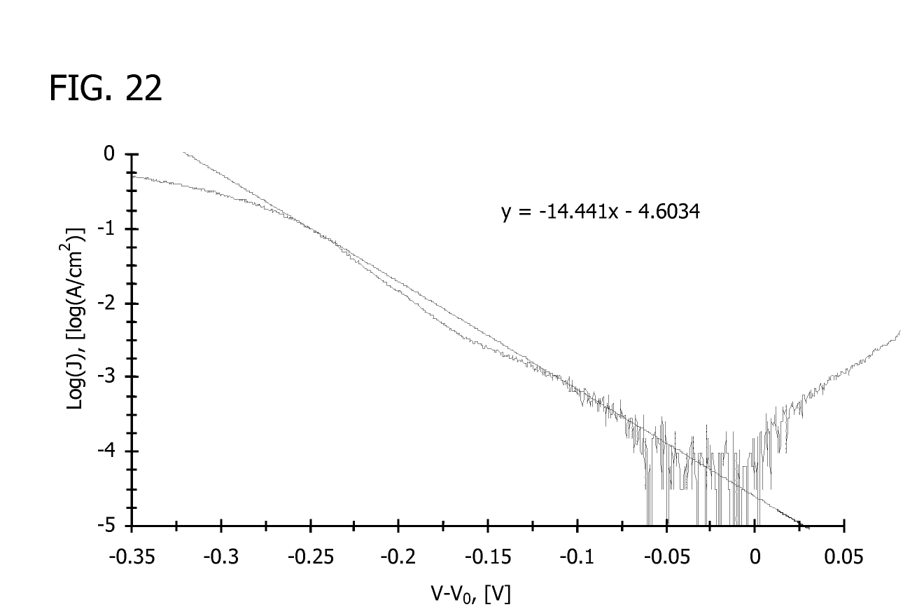

A Tafel plot for hydrogen evolution on a NiCu oxide is presented in FIG. 22. The kinetics followed a roughly linear free energy relationship down to −0.25 V in excess of the hydrogen midpoint potential and yielded an α of 0.427 and an α of 2.49×10⁻² mA/cm². In comparison, the pure platinum produced a linear free energy relationship from −0.41 V to −0.60 V excess of the hydrogen midpoint potential and yielded an α of 0.183.

1.4 Metal Oxide Development and Optimization

Catalyst optimization consisted of adjusting buffer composition, buffer concentration, pH, relative metal ion concentrations, metal ion oxidation states, metal salt counter-ion, current density, and current duration. The interaction of the electrodeposition variables and their effects upon catalytic efficiency were considered complex but resilient. Numerous different combinations of variables including buffer concentration, anion identity, pH, metal cation elemental ratio, and metal ion oxidation state were found which yielded similar catalytic efficiencies. The curves represented in FIG. 4 were selected from a data set composed of over 500 different combinations of the listed electrodeposition variables. The relationship of current density to applied working potential was linear at the higher currents of the linear voltammetry scans illustrated in FIG. 4 because the reaction kinetics were limited by the resistance of the electrolyte solution. A common indication that the catalyst has achieved near-optimal efficiency is that the slope of the linear relationships at high currents, and therefore solution resistance, are similar despite catalyst composition. The relationship of current density to applied working potential was exponential at lower currents because the reaction kinetics were limited by the resistance of charge transfer within the catalyst. The exponential portion of the FIG. 4 curves at lower currents differed substantially according to the metal composition if the catalyst. The exponential portion of the curves can be distinguished more readily in Tafel plots (as in FIG. 2) and quantitatively characterized according to the α and I₀ values of equation (7) which were presented in Table 2.

For oxygen evolution catalysts, all of the catalytic compositions demonstrated greater efficiency than the 99.95% pure platinum support upon which the oxides were formed; the Ni, Co, Fe, NiCo, CoFe, and NiFe oxides all demonstrated similar catalytic efficiencies while the inclusion of Mn or Cu generally yielded somewhat lesser performance. For oxygen electrodes, the NiFe composition was characterized with the highest electron transfer coefficient as well as one of the fastest equilibrium water exchange rates. The efficiencies for the metal oxides other than NiFe illustrated in FIG. 4 are considered to fairly represent optimal efficiency although the vast number of electrodeposition variables inhibits exhaustive analysis.

1.5 Efficiency of Catalysts

The nickel-iron oxides demonstrated particularly efficient oxygen evolution catalysis, and were therefore selected for further analysis. The evolution of oxygen was shown to directly coincide with the midpoint potential for water oxidation of 0.399 V in FIG. 2 which suggested that O₂ was produced directly into the triplet state. The electron transfer coefficient, α, was determined to be 0.854 when the kinetics demonstrated a linear free energy relationship for a range of ˜50 mV above the water oxidation midpoint potential where R_{ct}>>Rₛₒₗₙ. Above 0.450 V the Rₛₒₗₙ began to affect and then dominate the current density kinetics as the α and R_{ct} became exponentially smaller at higher working potentials (see FIG. 16).

A complete alkaline water electrolysis cell was constructed by combining the nickel-iron oxide catalyst for oxygen evolution with the nickel-copper oxide catalyst for hydrogen evolution. The evolution of hydrogen was shown to directly coincide with the calculated midpoint potential for water reduction of −0.885 V on the NiCu oxide. Water was therefore achieved at the thermodynamic limit of water's heat of formation. The heat of formation is the minimum amount of energy required to break the intramolecular bonds of water. It may not be possible to observe water electrolysis at the limit of free energy of formation if the favorable entropic contribution of water formation is not conserved during catalysis. The apparent lack of favorable entropic contribution was associated with the hydrogen evolution reaction rather than the oxygen evolution reaction and is thought to occur because the KOH in the electrolyte polarizes water's electrochemical domain of stability towards oxygen evolution.

1.6 Nickel-Iron Catalytic Mechanism of Water Oxidation

Pourbaix reported the stoichiometric equations describing the oxidation by water of these first-row transition metals in aqueous solid oxide complexes (Pourbaix, supra). The greatest efficiencies were demonstrated by iron, cobalt, and nickel oxides and their combinations. The solid, stable, higher oxidation states which are shared by iron, cobalt, and nickel are MO, M₃O₄, and M₂O₃. Each of the possible oxidations is achieved with the consumption of one reactant water molecule and the production of two electrons and two protons. The possibility of metal ions clustering in the molecular level is supported by an observation made during preparation of the electrodeposition solution. An improvement in catalytic efficiency resulted when the nickel and iron were buffered and pH-adjusted before combination with the other metal of the pair.

A total of four time domains were identified through EIS of the nickel-iron oxide from 0.300-0.600 V. Two time domains appeared in the inductive loop (see FIG. 15C) and two time domains appeared in the capacitive loop (see FIG. 17A). The four time domains and their behavior with respect to potential were found to correlate with known redox reactions for nickel and iron (Pourbaix, supra). Reactions (14) through (18) are used to construct a model for the catalytic mechanism and identify all four time domains. The aqueous electrochemical potentials are calculated considering a pH of 13.84 in 1 M KOH at 25° C. and 1 atm.

3NiO+H₂O→Ni₃O₄+2H⁺+2e⁻ (14a)

E₍₁₄₎⁰=0.897 V−0.0591*pH=0.079 V₍₁₄₎ (14b)

2Fe₃O₄+H₂O→3Fe₂O₃+2H⁺+2 e⁻ (15a)

E₍₁₅₎⁰=1.208 V−0.0591*pH=0.390 V₍₁₅₎ (15b)

4 e⁻+4H⁺Ni₃O₄+3Fe₂O₃→3NiO+2Fe₃O₄+2H₂O (16a)

E₍₁₆₎=−[0.079 V₍₁₄₎+0.390 V₍₁₅₎]=−0.469 V₍₁₆₎ (16b)

Ni₃O₄+3Fe₂O₃→3NiO+2Fe₃O₄+O₂ (17a)

E₍₁₇₎=0.399 V₍₅₎+−0.469 V₍₁₆₎=−0.070 V₍₁₇₎ (17b)

Ni₃O₄+2Fe₃O₄⇄3NiO+3Fe₂O₃ (18a)

E₍₁₅₎=0.390 V₍₁₅₎−0.079 V₍₁₄₎=0.311 V₍₁₈₎ (18b)

Reactions (14) and (15) represent how the nickel and iron obtain oxygen from the reactant water molecules and produce electrons for the anodic current. Reactions (14) and (15) are assigned to the two high frequency inductive loop time domains. The assignment of these two reactant-binding reactions to the inductive loop is supported by the observation that the solution resistance, Rₛₒₗₙ, is a product of the inductive loop. The nickel oxidation reaction (14) was assigned to the inductive loop time domain which occurred at all measured potentials from 0.300 to 0.600 V. The iron oxidation reaction (15) is assigned to the inductive loop time domain which appears at 0.390 V and above in accordance with the potential requirement of reaction (15).

The combination of both metals in their more oxidized states can proceed in the reverse direction according to reaction (16). The proposed O₂ evolution reaction (17) could occur through the combination of reaction (16) with water oxidation as seen in reaction (5). The reductive elimination of O₂ by reaction (17) is spontaneous by −0.070 V when both nickel and iron are in their more oxidized state. The O₂ evolving reaction (17) is assigned to the lowest frequency capacitive loop time domain. The assignment of the proposed O₂ evolution reaction (17) to the lowest frequency peak is supported by the observation that the resistance of charge transfer, R_{ct}, is a product of this time domain. The time domain of reaction (17) is exceeding slow at lower potentials and moves to much higher frequencies upon surpassing the O₂ evolution midpoint potential.

Reaction (18) is the forward half-reaction of (14) combined with the reverse reaction of (15) and is assigned to the higher frequency capacitive loop time domain (˜10^{2.5} Hz in FIG. 17A). Reaction (18) exchanges oxygen atoms and electrons between nickel and iron. Reaction (18) can produce iron in the higher oxidation state above 0.311 V as the potential is insufficient for reaction (15) to proceed in the forward direction independently. The O₂ evolving reaction (17) adopts the same frequency domain as the oxygen exchanging reaction (18) because the rate of oxygen evolution is limited by the rate at which iron reaches the higher oxidation state at the lower potentials. The time domain of reaction (18) disappears in FIG. 17A as the applied working potential becomes sufficient to drive both reactions (14) and (15) simultaneously. The ability of iron to reach the higher oxidation state through reaction (18) is supported by the observation that positive current densities were measured for all applied working potentials, including 0.300 V, despite the possibility that the reduction of atmospheric O₂ on the catalyst could generate a negative current density below the oxygen evolution midpoint potential of 0.399 V. Iron can preferentially oxidize through reaction (15) at 0.390 V and above so the disappearance of the peak assigned to (18) correlates with the appearance of the peak assigned to (15) at V₍₁₅₎. Evidence supporting reaction (18) can also be found in FIG. 6 where the potential is lowered after oxygen evolution with a linear voltammetry scan. The electrochemical signal in FIG. 6 is centered about −0.311 V and is thought to be generated by the reverse of reaction (18). A net current would have been produced if the iron reduction proceeded through reverse of reaction (15). Reaction (18) is considered labile as the presence of 1 M KCl was used to dampen the signal of FIG. 6 so that signal structure could be more easily determined visually because the signal amplitude can be over 100× larger in the absence of KCl.

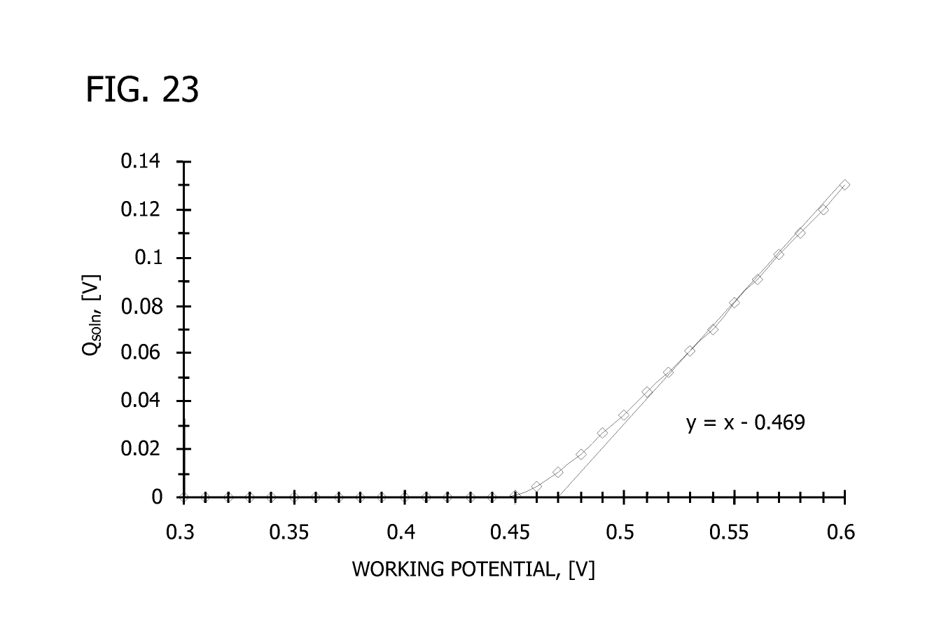

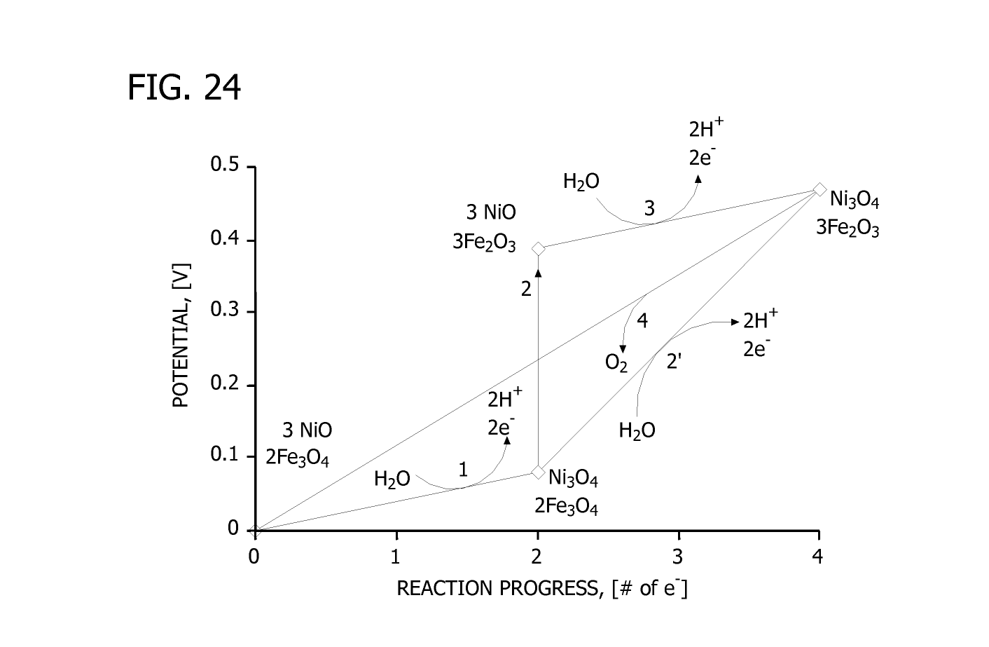

The role of 0.469 V from reaction (16) was considered in terms of working potential applied to the catalyst versus working potential applied to the electrolyte. To do so the working potential was compared to the solution impedance potential, Qₛₒₗₙ. The solution impedance potential, Qₛₒₗₙ, was defined as the impedance potential where the magnetic component, F, equals zero as the inductive loop transitions to the capacitive loop in FIG. 23. The solution impedance potential is a function of the solution resistance and represented the working potential applied to the electrolyte solution rather than to the catalyst. It was observed from the slope provided in FIG. 23 that working potential in excess of 0.469 V was transferred not to the catalyst but to the solution electrolyte in a 1:1 ratio. This relationship further supports reaction (16) which indicates that 0.469 V is the potential at which the NiFe oxide catalyst is fully activated in the oxidized states.

The proposed catalytic mechanism illustrated in FIG. 24 was constructed from the electrochemical data. FIG. 16 indicated that the rate-determining step of the catalytic cycle is a two-electron transfer during linear free energy kinetics and becomes a four-electron transfer at higher working potentials. The catalytic cycle is therefore thought to occur by sets of two-electron transfers which is consistent with reactions (14) to (18). Steps 1 and 3 correspond to reaction (14), step 2 corresponds to reaction (18), step 4 corresponds to reaction (17) and step 2′ corresponds to reaction (15). The simultaneous occurrence of steps 1 and 2′ represent the mechanism whereby four electrons occur in the rate limiting step. The illustrated mechanism is also consistent with FIG. 15C in that the majority of the solution resistance results from the nickel oxidation reaction (14). The oxidation of two molecules of water to O₂ by a mechanism with paired electron transfer would circumvent the requirement of the high energy superoxide ion intermediate.

As noted above, elemental analysis indicated that the oxide matrix was composed of 72.1%±0.4% Ni and 27.8%±0.5% Fe. This atomic ratio indicates that reactions (14) and (15) are in a ratio of approximately 5:1. The empirical optimization process has yielded an electrode in which the nickel and iron are in an electrochemical potential equilibrium with each other according to reaction (19):

0.390 V₍₁₅₎≈5×0.079 V₍₁₄₎ (19)

This circumstance of potential equilibrium suggests that when iron is in its higher oxidation state, the evolution of O₂ through reaction (17) will be more favorable than the oxidation of a nickel group through the reverse of reaction (18). Forcing the forward progress of reaction (18) by a total of five nickel components guarantees the successful production of O₂ by reaction (17). An anodic working potential greater than the oxygen evolution potential of 0.399 V_{O2} will favor the oxidized state of all five nickel components even after a transient, localized −0.070 V₍₁₇₎ potential drop caused by the reductive elimination of O₂. An efficient catalytic cycle capable of sustaining high current densities depends on rapid, forward exchange between the Fe₃O₄ and Fe₂O₃ states provided that the nickel oxidation reaction (14) occurs even faster to ensure directional electrochemical flux. The presence of the ancillary nickel, which were not included in FIG. 24, ensures the directional flux of two electrons and one oxygen atom in opposite directions.

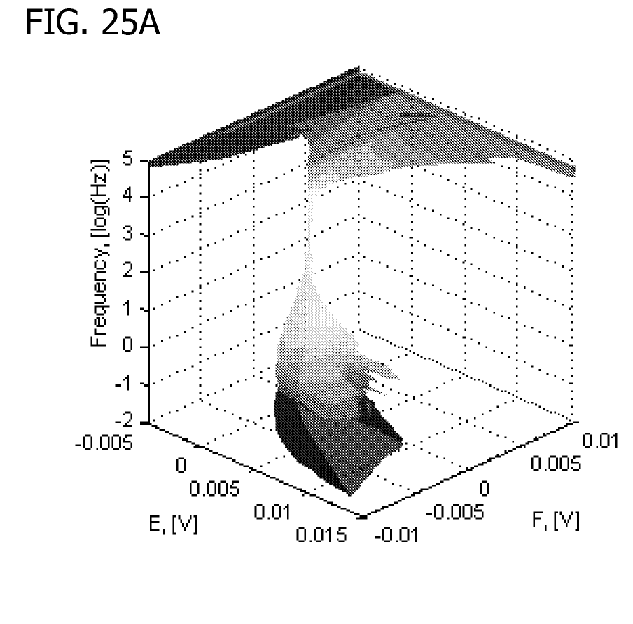

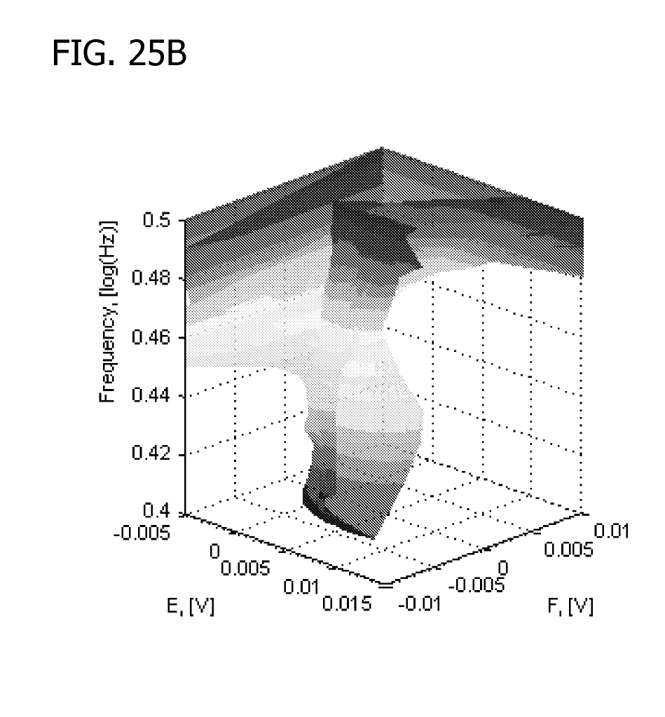

The number of electrons transferred per step is preferably considered with respect to the resolution in time scale of EIS. The Born-Oppenheimer approximation indicates that that electronic rearrangement occurs on a time scale much faster than the time scale of nuclei rearrangement. It is believed that the electrochemical impedance spectroscopy data reflects the rearrangement of nuclei and so the time scale is limited to the number of electrons transferred per nuclei rather than individual electrons. The relationship of how the electric and magnetic component change with respect to frequency and applied working potential is presented in FIGS. 25A and 25B, respectively. The electric potential resulting from solution resistance has been subtracted from the values represented in FIGS. 25A and 25B so that the electromagnetic components of energy transfer during catalysis can be more clearly observed. FIG. 25A illustrates how the inductive loop demonstrates right-handed rotation and the capacitive loop demonstrates left-handed rotation when going from low frequency to high frequency along the Z-axis. It was observed that the inductive loop expands to lower frequencies and the capacitive loop expands to higher frequencies at higher potentials. The electromagnetic components of the capacitive loop achieve a minimum limit at 0.470 V and then noise appears at the low frequency limit of the capacitive loop at higher potentials in FIG. 25B. Also in FIG. 25B it was observed that the inductive loop became larger than the capacitive loop at 0.450 V and above which is consistent with the deviation from the linear free energy relationship (see FIG. 2). As the solution impedance had been subtracted from FIGS. 25A and 25B it was concluded that electromagnetic potential energy was conserved through the inductive loop despite the apparent size and noise.

1.7 X-Ray Powder Crystallography and SQUID Analysis

XPS binding energies were measured both before and after 5 minute sputtering with Argon ions (1keV) at 200 nA using a vacuum Generator ESCA 2 X-ray photoelectron spectrometer with an Al—Kα source. Powder X-ray crystallography was performed with theta/2-theta scans at 2°/min were performed on a Siemens D500 Diffraktometer with a Cu source. Oxide samples created on the 20 cm² electrodes were scraped off, dried in ambient conditions overnight, and disbursed with ethanol and examined with a Jeol 2011 TEM at 200 kV (2.5 pm wavelength) with a lanthanum hexaboride electron source. SEM/EDX analysis of the optimized NiFe oxide and the bare platinum support were obtained with a Jeol JSM-5900 Scanning Electron Microscope at 30 KeV. SQUID (Superconducting Quantum Interference Device) experiments were conducted using a Quantum Design MPMS XL with a helium cooled cryostat. Oxide samples created on the 20 cm² electrodes were scraped off, dried in ambient conditions overnight, and then encased between 2 layers of Katon tape and inserted into the center of a clear plastic straw.

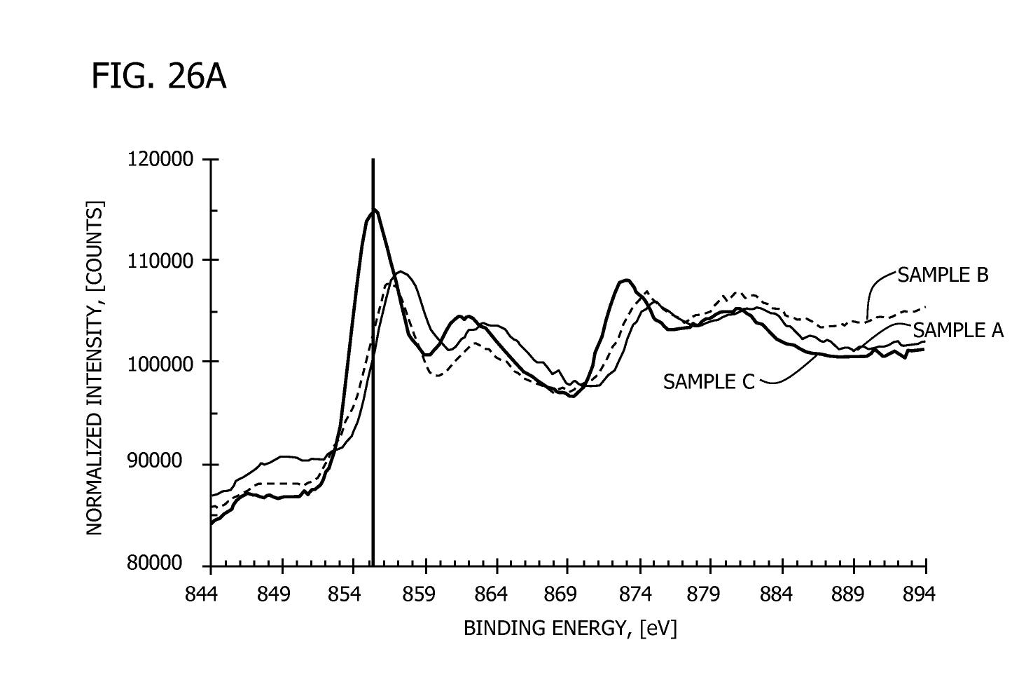

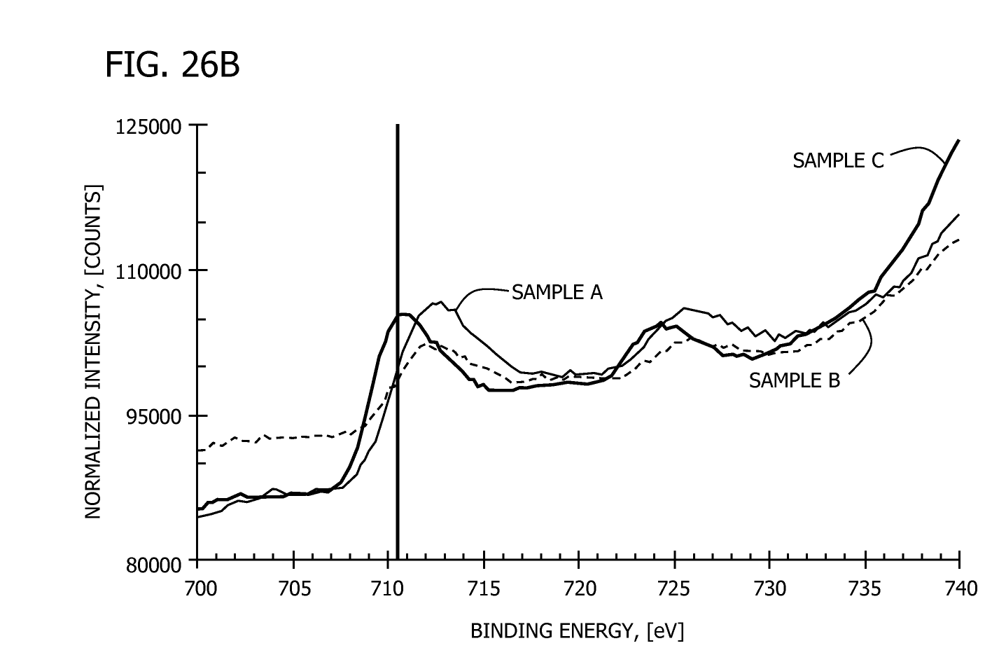

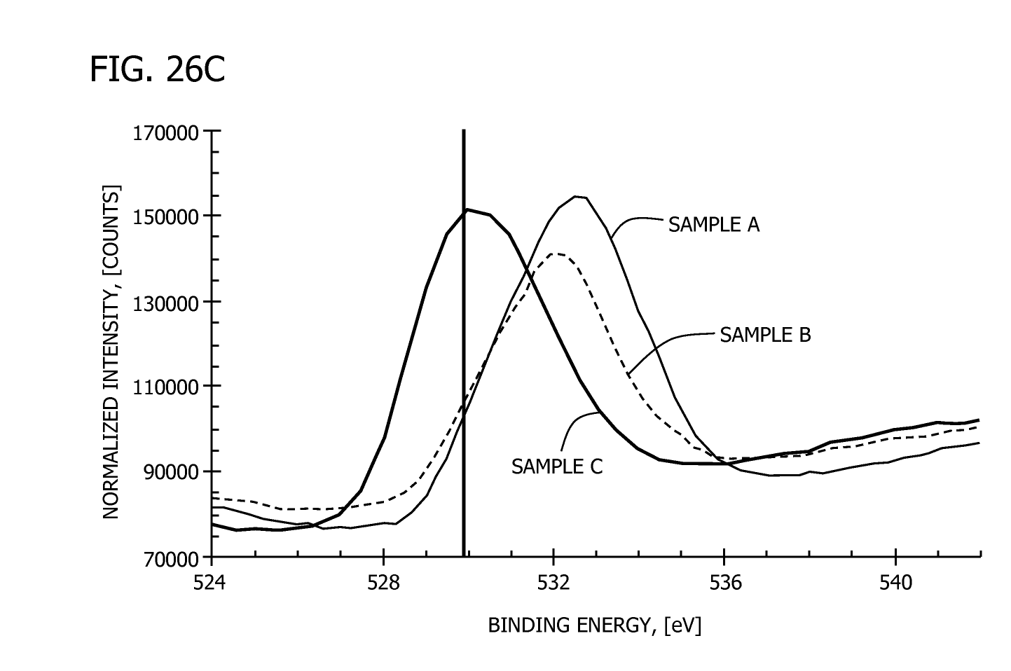

XPS was used to determine if the use of higher current densities and an ammonium sulfate electrolyte affected the composition of the NiFe oxide catalyst. The NiFe oxide catalysts were created from solutions containing 9 mM NiSO₄, 9 mM FeSO₄, and the electrodeposition current densities and ammonium sulfate concentrations indicated in Table 5. The analysis of the NiFe oxide catalysts with XPS produced the Ni 2p^{3/2}, Fe 2p^{3/2}, and O 1s multiplets illustrated in FIGS. 26A-C, respectively. The intensity of the multiplets illustrated in FIGS. 26A-C were normalized so that the average intensity was 100,000 counts. The XPS multiplets did not appear to change significantly after a 5 minute sputtering with 1 KeV Argon ions at 200 nA stage. The XPS peaks were broad but did not appear to include any of the metallic states. Both the higher electrodeposition current density (A) and the ammonium sulfate electrolyte (B) shifted the peaks of all three multiplets from binding energies dominated by the hydrated Ni(OH)₂ and FeOOH states to binding energies dominated by the un-hydrated NiO and Fe₂O₃ states (C). The broad multiplet peaks of catalyst C encompass the NiO, Ni₃O₄, FeO, Fe₃O₄, and the Fe₂O₃ oxidation states (Ni₃O₄ binding energies are not available in the NIST database). The peaks of catalyst C are also only 0.1-0.2 eV greater than the binding energies of the NiFe₂O₃ oxidation state, which has been indicated with a black line in the Ni 2p^{3/2}, Fe 2p^{3/2}, and O 1s multiplets.

TABLE 5
NIFE OXIDE ELECTRODEPOSITION CONDITIONS
FOR XPS AND SQUID ANALYSIS.

| | Current density | |
|---|---|---|
| Catalyst | (mA/cm²) | mM (NH₄)₂SO₄ |
| A | 25 | 25 |
| B | 250* | 0 |
| C | 250 | 25 |

*105 mA/cm² for SQUID.

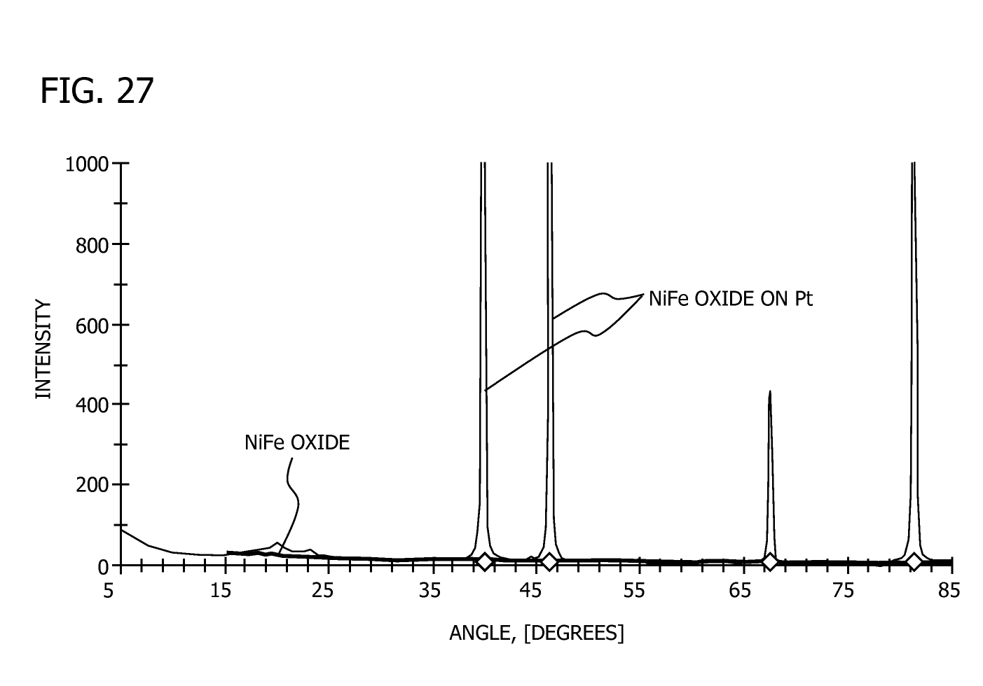

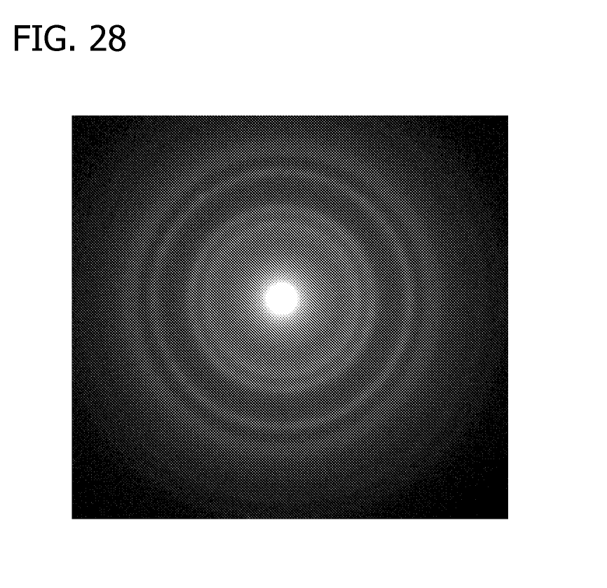

The optimized NiFe oxide catalyst on the 1 cm² platinum support was examined by X-ray powder crystallography both with and without the platinum support. No signals corresponding nickel or iron could be detected in the noise either with or without the platinum support (FIG. 27). Another sample of the optimized NiFe oxide deposited with the 20 cm² platinum support was analyzed with TEM and produced diffraction patterns with broad, diffuse rings (FIG. 28). Three diffraction patterns contained different sets of the same d-spacings, which include: 2.55 (±0.02) Å, 2.44 (±0.04) Å, 2.32 (±0.02) Å, 2.02 (±0.02) Å, 1.51 (±0.02) Å, 1.45 (±0.02) Å, and 1.24 (±0.02) Å. These d-spacings correspond to at least one or more nickel oxide and at least one or more iron oxide, where values for all known anhydrous and hydrous nickel and iron non-metallic oxidation states were represented two or more times. Diffraction patterns with the same d-spacings were also produced when a second NiFe oxide was prepared from an electrodeposition solution containing the same nickel and iron concentrations and no ammonium sulfate. The deposition current was 25 mA/cm².

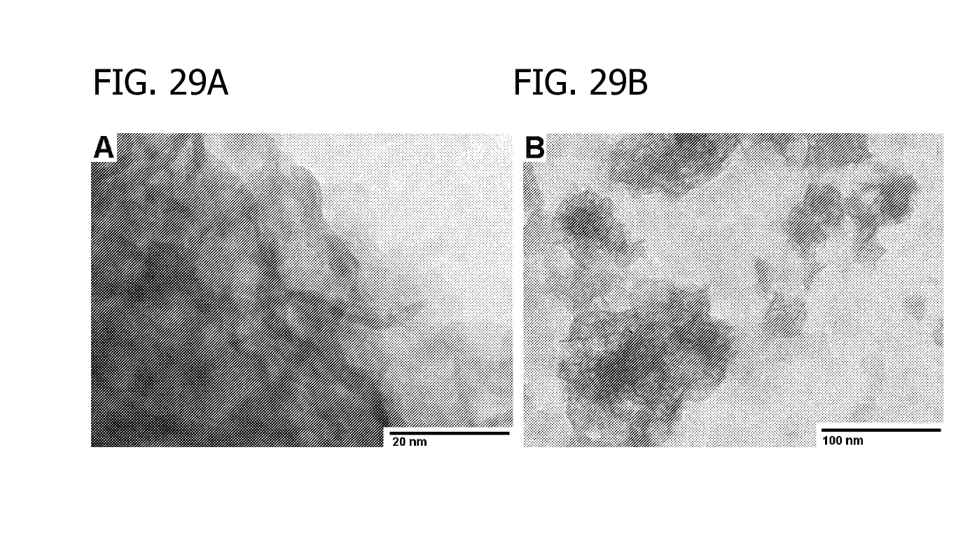

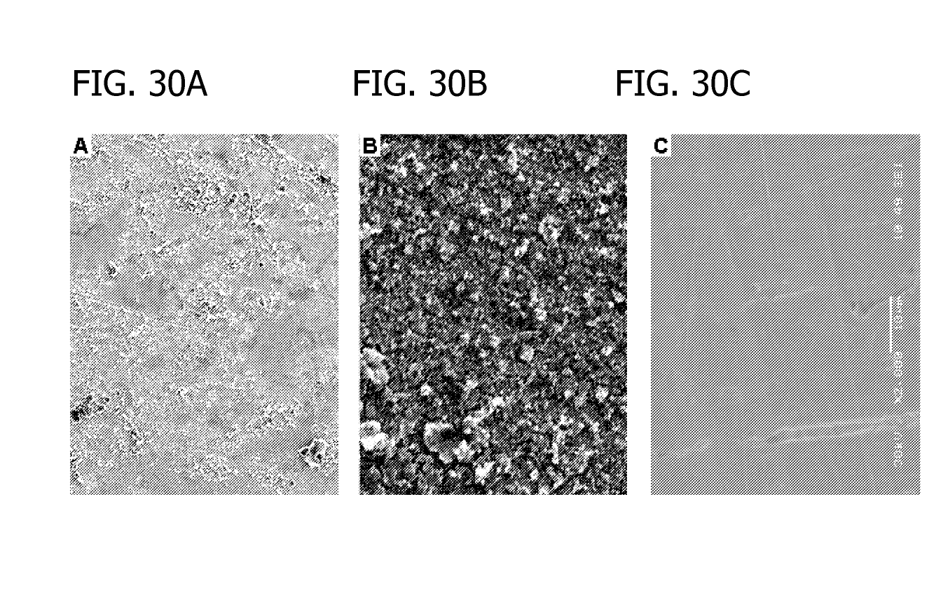

TEM images indicated that the optimized NiFe oxide is polycrystalline with crystals ˜1 nm and smaller that are well-connected with an amorphous phase (FIG. 29A). TEM images of the NiFe oxide deposited at 25 mA/cm² and without ammonium sulfate indicated crystals sizes up to 5 nm connected with an amorphous phase and that the oxide is prone to fragmenting into loose particles (FIG. 29B). SEM images of the NiFe_{(b)} oxide catalyst at 100× and 2,000× magnification and the bare platinum support at 2000× magnification are presented in FIGS. 30A-C, respectively. The elemental analysis averaged from five areas of the catalyst indicated that the NiFe₍ₐ₎ oxide had an atomic ratio of 68.9±2.2% Ni and 32.2±1.9% Fe and the NiFe_{(b)} oxide had an atomic ratio of 72.1±0.4% Ni and 27.8±0.5% Fe. Potassium did not appear to significantly bind or become impregnated into the NiFe oxide after use in 1 M KOH because only one area because it was only detected in one area at 0.17%. Elemental analysis verified that the purity of the platinum (Hauser and Miller) was greater than 99.95% Pt even after repeated catalyst depositions and subsequent cleaning with concentrated sulfuric acid.

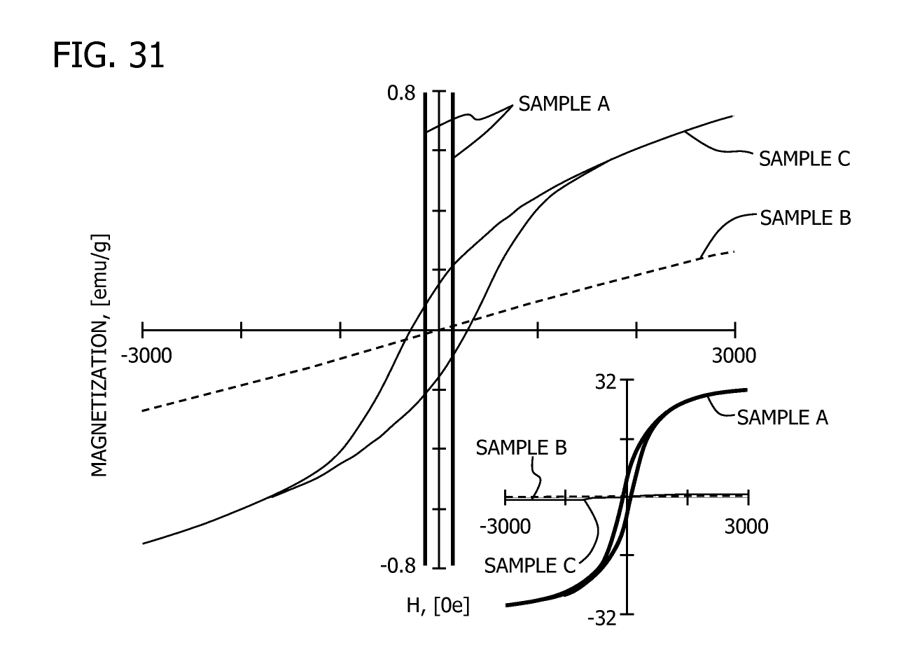

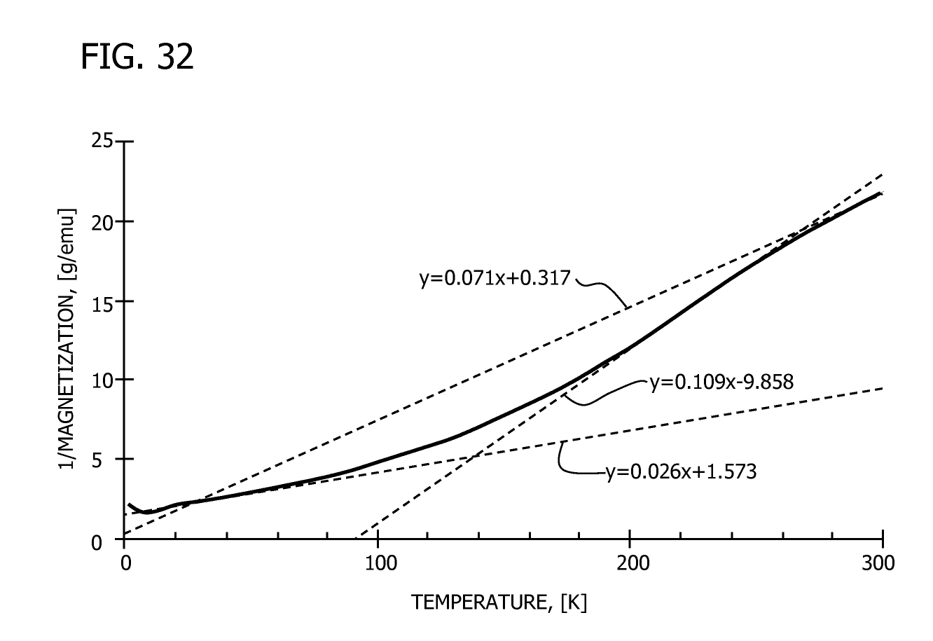

NiFe oxide samples prepared according to the electrodeposition conditions indicated in Table 5 were also analyzed with a SQUID magnetometer. The sample deposited with ammonium sulfate (C) required 38 V for a current density of 250 mA/cm² whereas the sample without ammonium sulfate (B) could only be deposited at 105 mA/cm² at 40 V, the maximum voltage of the Agilent power system. Samples A and C had magnetization at 300 K with hysteresis loops on field sweeps. Sample B was paramagnetic (FIG. 31). Sample A had the largest magnetization (5.79 emu/g); sample C (0.16 emu/g) required the largest coercive force to bring the induced magnetization back to 0 (283 Oe) compared to sample A (113 Oe). Together, the use of a higher current density and an electrolyte containing transition metal nucleophiles (e.g., NH₃) caused the magnetic behavior of the NiFe oxide sample C to be more complex. FIG. 32 illustrates a temperature sweep of sample C at 100 gauss where the sample showed two anti-ferromagnetic exchange interactions with temperature intercepts of −60.5 K and less than −4.5 K and a paramagnetic exchange interaction with a temperature intercept of 90.4 K. This behavior reflects the chemical and physical complexity of these catalytic systems.

1.8 Discussion

The systematic optimization of first row transition metal oxide oxygen evolution catalysts was consistent with the assessment of Photosystem II and cytochrome C oxidase because the preferred catalysts were found in the range of Mn through Cu on the periodic table of elements. Formation of Fe, Co, and Ni oxides and their combinations gave the greatest overall catalyst performance. Pourbaix shows that these three elements share the following stable solid oxide states: MO, M₃O₄, and M₂O₃ (Pourbaix, M., Atlas of Electrochemical Equilibria in Aqueous Solution, 1974, Cebelcor, Brussels). Mn, which catalyzes oxygen evolution in Photosystem II, also forms these stable solid oxide states (Pourbaix, supra). The systematic analysis of first-row transition metals yielded NiFe oxides that produced the greatest current densities at a given working potential in 1 M KOH. The NiFe oxide was able to achieve the best values for each of the four oxygen evolution kinetic parameters that describe catalyst performance, although each parameter was obtained from different electrodeposition conditions. The hydrogen evolution kinetic parameters demonstrated by the NiFe oxide may mean that the cathodic electrodeposition method may be useful for creating catalysts effective for other reactions of interest. The Mn₄ cluster at the heart of Photosystem II exists in an S₂ state (see, e.g., Koulougliotis et al., Biochem. 2007, 36, 9735). Thus, effective catalysts for production of oxygen from water or other singlet sources are magnetically active materials.

The NiFe oxide catalyst in Table 1 had considerably better performance than the NiFe oxides developed by Corrigan et al., which were also created with cathodic electrodeposition. See, e.g., Corrigan, D. A., J. Electrochem. Soc., 1987. 134 (2), 377-384; U.S. Pat. No. 4,882,024 to Corrigan; Desilvestro et al., J. Phys. Chem. 1986. 90, 6408-6411; Corrigan et al., J. Phys. Chem., 1987. 91: 5009-5011; Desilvestro et al., J. Electrochem. Soc., 1988, 135 (4) 885-892; and Corrigan et al., J. Electrochem. Soc., 1989. 136 (3), 723-728. In comparison with the work of Corrigan et al., among the improvements in the cathodic electrodeposition method developed here are: 1) the use of an approximately 30× greater electrodeposition current densities, and 2) the inclusion of extra nucleophilic electrolytes in the electrodeposition solution which result in production of catalysts with magnetization. Both a higher electrodeposition current density and the inclusion of an ammonium sulfate electrolyte in the electrodeposition solution caused the Ni 2p^{3/2}, Fe 2p^{3/2}, and O 1s multiplet peaks to shift from predominantly hydrated nickel and iron oxide binding energies to the predominantly un-hydrated binding energies and near the NiFe₂O₄ state.

Analysis of the optimized NiFe oxide with a SQUID magnetometer showed that the magnetic interactions were complex, demonstrating ferromagnetic/ferrimagnetic, anti-ferromagnetic, and paramagnetic behavior at 300 K. The ammonium sulfate buffer caused the ferromagnetic/ferrimagnetic behavior at room temperature (FIG. 31). This is an expected result because examples of high spin Mn²⁺, Fe²⁺, Co²⁺, Ni²⁺, and Cu²⁺ ions with ammonium or other nucleophilic ligands in aqueous solution are abundant in both inorganic (e.g., Figgis et al., Ligand Field Theory and Its Applications. 2000, Wiley-VCH New York:, pp. 92-111, 155-167) and enzymatic literature (e.g., Nelson et al., Lehninger Principles of Biochemistry. 2000, Worth Publishers, New York). Theoretical modeling and experiments indicate that the CaMn₃O₄ cluster of Photosystem II transitions through high spin states during the catalytic cycle (Lundberg et al., Chem. Phys. Letts. 2005, 401, 347-351; Isobe et al., Polyhedron, 2005, 24: 2767-2777). The iron of the heme a₃/Cu_{B} catalytic site of cytochrome C oxidase is high spin in the resting state and possibly also in intermediate states (Schmidt et al., Biochim. Biophys. Acta 2004, 1655, 248-255; Han et al., J. Biol. Chem., 2000, 275(3): 1910-1919). Oxygen-activating enzymes commonly have high spin heme iron, non-heme iron, and copper catalytic sites (Decker et al. Current Opinion in Chemical Biology, 2005, 9: 152-63; Holm et al., Chem. Rev., 1996, 96:2239-2314). The correlation of ferromagnetic character with approximately ideal electron transfer by the optimized NiFe oxide is evidence that the high spin states in the catalyst facilitated the electron spin inversion required for oxygen evolution.

Corrigan reported a Tafel slope with as little as 17 mV/decade current density (Corrigan, D. A., J. Electrochem. Soc., 1987. 134 (2), 377-384; U.S. Pat. No. 4,882,024 to Corrigan) whereas the αₐ of 0.008 reported herein corresponds to 14.8 mV/decade current density for the oxygen evolution reaction. While the Tafel slopes were somewhat similar for both catalysts, the smaller J₀ value caused Corrigan's catalyst to operate at ˜200 mV greater working potentials (Corrigan, D. A., J. Electrochem. Soc., 1987. 134 (2), 377-384; U.S. Pat. No. 4,882,024 to Corrigan). It is believed that the relative difference in performance arises because the NiFe oxides J₀ values reported in this work are inferred to be over four orders of magnitude greater than the NiFe oxide J₀ values developed by Corrigan et al. See, e.g., Corrigan, D. A., J. Electrochem. Soc., 1987. 134 (2), 377-384; U.S. Pat. No. 4,882,024 to Corrigan; Desilvestro et al., J. Phys. Chem. 1986. 90, 6408-6411; Corrigan et al., J. Phys. Chem., 1987. 91: 5009-5011; Desilvestro et al., J. Electrochem. Soc., 1988, 135 (4) 885-892; and Corrigan et al., J. Electrochem. Soc., 1989. 136 (3), 723-728. The J₀ values of Corrigan et al. and most other authors are not reported and the exchange current densities must be inferred from graphical representations. Accurate comparisons of catalytic performances between different work requires the report of all four αₐ, J₀, Rₗᵢₘ, and J_{b} values.

The deposition of the metal oxides onto the cathode may have been caused by the reduction of protons from H₂O and OH⁻ ligands of the aqueous metal ions rather than hydroxide precipitation produced from the decomposition of hard anion electrolytes as suggested by Corrigan (Desilvestro et al., J. Electrochem. Soc., 1988, 135 (4) 885-892; and Corrigan et al., J. Electrochem. Soc., 1989. 136 (3), 723-728). The potentials required for high electrodeposition current densities are well in excess of the reduction potential of hydrogen evolution from water (38 V for 250 mA/cm² on the 20 cm² electrodes). It is believed that electrodeposition at higher current densities would cause the dehydration of the metal oxides observed with XPS by reducing the protons of aqueous ligands to hydrogen gas and leaving oxygen. NH₃ is a stronger base than H₂O, displacing water ligands on the aqueous metal ions in the electrodeposition solution and may also cause the dehydration of the metal oxides as observed with XPS. NiFe oxides created from electrodeposition solutions containing only Cl⁻ anions produced catalytic kinetics similar to other hard anions (FIG. 9). It is believed that the NiFe oxide would be difficult to form by hydroxide precipitation through the decomposition of hard anion electrolytes if only Cl⁻ was in the electrodeposition solution.

The optimized NiFe oxide is polycrystalline with crystals 1 nm and smaller well-connected with amorphous material. The size of the crystals was too small to give a diffraction pattern with X-ray powder crystallography. The d-spacings measured with TEM could correspond to any of the non-metallic oxidation states. The Ni 2p^{3/2}, Fe 2p^{3/2}, and O 1s XPS multiplet peaks for the optimized NiFe oxide indicated that the NiFe₂O₄ oxidation state may be dominant although the peaks were broad enough to encompass all of the other non-metallic oxidation states available in the NIST database. The dehydration of the NiFe oxide with the use of higher current densities and ammonium electrolytes may have been responsible for increased structural stability and the lack of loose particles observed in FIG. 29B. The optimized NiFe oxide has a highly disordered structure. Structural defects are known to correlate with catalytic activity (Lankhorst et al., J. Amer. Chem. Soc. 1997, 80(9), 2175-98; Merkle et al., Topics in Catalysis 2006, 38, 141-145).

The NiFe catalyst had relatively mobile charged species in the metal oxide structure. The high frequencies and large amplitudes observed in current density when the working potential was constant or changed with a small velocity (FIG. 12) was evidence of highly mobile charged species (de Paula et al., Physical Chemistry, 7^{th} Edition. 2001, W. H. Freeman, New York). Oscillations in current density were spontaneous because the oscillation frequencies observed in FIG. 12 correspond to the EIS frequency values (3.0-0.5 Hz) for negative real resistance (-Z_{R}) in the capacitive loop illustrated in FIG. 15C. Defects in transition-metal oxides are known to cause electric and ionic conductivity and enable the transport of neutral oxygen atoms through the matrix (Lankhorst et al., J. Amer. Chem. Soc. 1997, 80(9), 2175-98).

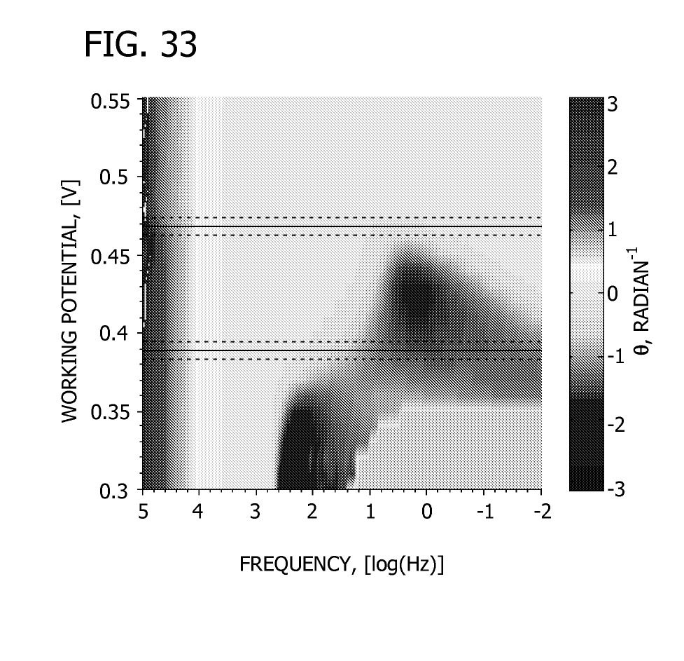

Electrochemical potentials in aqueous solutions are well known and therefore changes in impedance spectra with respect to applied working potentials may be correlated with the redox potentials of known half-reactions. Reduction potentials for stable Ni and Fe hydrated oxidation states were calculated for pH 13.84 according to the equations reported in Pourbaix's Atlas of Electrochemical Equilibria in Aqueous Solutions, supra, because the catalytic sites are expected to be in contact with the aqueous electrolyte. Phase angle, θ, changes with respect to working potential (FIG. 33) correlated particularly well with impedance spectra. Distinct correlations between the spectra and working potential occurred at ˜0.390 V and ˜0.470 V for the NiFe oxide catalyst during oxygen evolution. The iron redox reaction of equation (20) correlated with both the phase angle change observed in FIG. 32 as well as the appearance of the second arc in the high frequency inductive loop (FIG. 15C). The combination of both reactions (20) and (21) is equal to 0.467 V and correlated with the change in impedance observed at ˜0.470 V. Reaction (23) is proposed as a basic catalytic mechanism for oxygen evolution by the NiFe oxide.

3Fe₂O₃+2H⁺+2 e⁻→2Fe₃O₄+H₂O (20)

E₍₂₀₎=1.208 V−0.0591·pH=0.389 V₍₂₀₎

Ni₃O₄+2H⁺+2 e⁻→3NiO+H₂O (21)

E₍₂₁₎=0.897 V−0.0591·pH=0.078 V₍₂₁₎

O₂+4H⁺+4e⁻→2H₂O (22)

E₍₂₂₎=1.228−0.0591·pH+0.0147·log(pO₂)=0.399 V₍₂₂₎

Ni₃O₄+3Fe₂O₃→3NiO+2Fe₃O₄+O₂ (23)

E(23)=0.389 V₍₂₀₎+0.078 V₍₂₁₎+−0.399 V₍₂₂₎=0.068 V₍₂₃₎

All three of the MO, M₃O₄, and M₂O₃ oxidation states observed in equation (10) are only stable for Ni, Co, Fe, and Mn (Pourbaix, supra). Empirical optimization of first-row transition metal oxides for catalysis of the oxygen evolution reaction produced the best efficiencies when the catalyst contained Ni, Co, Fe, Mn, or combinations thereof (Table 3) and the implied involvement of these three oxidation states in the catalytic mechanism is consistent with the experimentally demonstrated optimization procedures. The detection of reactions that include the M₃O₄ oxidation state of Mn, Fe, Co, or Ni is consistent with the literature concerning alkaline oxygen evolution with Ni (Arulraj et al., J. Hydrogen Energy, 1989, 14(12), 893-898) and NiFe oxide oxygen evolution catalysts (Corrigan, supra) and other catalysts that included these metals (Singh et al., Electrochemica Acta, 2002, 47, 3873-3879; Godinho et al., Electrochemica Acta, 2002, 47, 4307-4314; Elizaide et al., J. Electrochem. Soc., 1997, 144(9), 263-266; Ponce et al., Electrochemica Acta, 2001, 46, 3373-3380; Rashkova et al., Electrochemica Acta, 2002, 47, 1555-1560; Ponce et al., Journal of Solid State Chemistry, 1999, 145, 23-32; Cattarin et al., Electrochemica Acta, 2001, 46, 4229-4234; Rios et al., Electrochemica Acta, 2001, 47, 559-566; and Prakash et al., J. Electrochem. Soc, 1999, 146(11), 4145-4151). Corrigan et al. presented evidence supporting the involvement of Ni(OH)₂ (hydrated NiO) in NiFe oxide catalytic cycles studied by angle-resolved infrared spectroelectrochemistry (Nazri et al., Langmuir, 1989, 5, 17-22), surface-enhanced Raman scattering (Desilvestro et al., J. Phys. Chem. 1986. 90, 6408-6411), and in situ surface Raman spectroscopy (Desilvestro et al., J. Electrochem. Soc., 1988, 135 (4) 885-892) as well as FeOOH (hydrated Fe₂O₃) by in situ Mössbauer spectroscopy (Corrigan et al., J. Phys. Chem., 1987. 91: 5009-5011). The NiO₂ oxidation state could correspond to the ˜2.44 Å and ˜2.02 Å d-spacings and was observed with XPS (FIG. 26A) in this work and also by Corrigan et al. (Desilvestro et al., J. Electrochem. Soc., 1988, 135 (4) 885-892; Corrigan et al., J. Electrochem. Soc., 1989, 136(3), 613-619; and Carpenter et al., J. Electrochem. Soc., 1989, 136(4), 1022-1026) although the impedance technique did not indicate that this state actively participated in catalysis.

Small values of inductance have been regularly observed in EIS and were usually dismissed as an experimental artifact resulting from the wiring in the electrochemical cell if the source was not reported as unknown. The high frequency inductive loop of the NiFe oxide catalyst observed here spanned over 3 decades of frequency (>10⁵ Hz to ˜10² Hz). The inductive loop was not observed in the EIS spectra of the platinum without catalyst although a small amount of inductance was observed (FIG. 15D) and was therefore not considered an artifact of the experimental setup. High frequency inductance in combination with negative capacitance and negative resistance has been theoretically explained and modeled by Boukamp to result from multi-electron transfer processes under biased conditions due to multiple species competing for adsorption sites (Boukamp, B., Solid State Ionics, 2001, 143, 47-55). Experimentally observed high frequency inductive loops have also been attributed to disordered movement of charge carriers through metal oxide structures by da Silva et al (da Silva et al., J. Electroanal. Chem., 2002, 532, 141-150). These explanations may be related to the high frequency inductive loop presented here.

The preparation and properties of a series of transition metal oxide electrolysis catalysts useful in the production of molecular oxygen are described in Example 1. One preferred catalyst included a NiFe oxide mixture (i.e., at least one metal oxide having the formula: MₓO_{y}, wherein M is a first, second, or third row transition metal, x is a positive integer from 1 to 3, and y is a positive integer from 1 to 7, and at least one metal oxide having the formula LₓO_{y}, wherein L is a first, second, or third row transition metal, x is a positive integer from 1 to 3, and Y is a positive integer from 1 to 7, wherein one of M and L is Ni and the other of M and L is Fe). When deposited on an inert conductive substrate (e.g., Pt foil), this catalyst contained all of the commonly encountered oxides of nickel and iron. The sample did not appear to give an x-ray power diffraction pattern, but it did possess magnetization at room temperature. With the use of catalysts of this type alone or in combination with a suitable hydrogen evolution catalyst, it is believed to be possible to produce hydrogen and oxygen gas from water at or very near the thermodynamic limit.

### Example 2

### Hydrogen Evolution Catalysts

2.1 Catalyst Synthesis

Catalysts were synthesized from an electrodeposition solution containing a final concentration of 18 mM total metal ion concentration (where M=VO²⁺, VO₃⁻, VO₄³⁻, Cr²⁺, Cr³⁺, CrO₄²⁻, Cr₄O₇²⁻, Mn²⁺, Mn³⁺, MnO⁴⁻, MnO₄²⁻Fe⁺, Fe³⁺, Co²⁺, Co³⁺, Ni²⁺, Ni³⁺, Cu¹⁺ or Cu²⁺) for oxides composed of of one transition metal element or combinations thereof. The electrodeposition solutions also contained a final concentration of 5-250 mM NH₄A (where A=SO₄²⁻, NO₃⁻, PO₄³⁻, Cl⁻, or ClO₄⁻) electrolyte buffer and a final pH 0.0-14.0. The metal oxide catalysts were deposited with a >100 mA/cm² current density for 3-180 sec onto a square 1 cm²×25 μm pure platinum foil (Hauser and Miller) cathode. The back side of the Pt electrode and the 30 ga Pt connecting wire (Hauser and Miller) were insulated with Starbrite Liquid Electrical Tape. Water electrolysis was performed in 100 ml samples of KOH electrolyte at room temperature (22-25° C.) and pressure and in contact with the atmosphere (1 atm) during performance testing. All solutions were prepared with purified water (Barnstead, EASYpure UV).

Electrochemical experiments were performed on a Radiometer Analytical PGZ100 potentiostat/galvanostat using VoltaMaster 4.0 software with a Fisher Scientific saturated Ag/AgCl reference electrode. The three-electrode electrochemical cell consisted of a working (1 cm²), a counter electrode (1 cm²), and an Accument saturated Ag/AgCl reference electrode (13-620-53). The tip of the reference electrode was placed in contact with the catalyst/electrolyte interface of the working electrode. The working and counter electrodes were square 1 cm×1 cm×25 μm platinum foil with Starbrite Liquid Electrical Tape insulating the back side of the platinum and the 30 ga platinum connecting wire so that only one flat surface, 1 cm², is exposed to the electrolyte. Larger samples of catalysts were deposited by an Agilent N2766A power source onto both sides of a 4 cm×2.5 cm×25 μm platinum foil with two parallel, equally sized counter electrodes placed 0.5 cm away on both sides. Platinum (Hauser and Miller) was selected for use as both a control as well as a recyclable, electrically conductive support upon which the metal oxide catalysts were deposited.

Linear voltammetry scans of freshly prepared electrodes were preceded by an identical scan to polarize and discharge the electrode. The electrochemical impedance data was collected over the range of −0.450 to −1.250 V in 10 mV steps with each step proceeded by a 1.0 minute chrono coulometry scan. Impedance was measured from 10⁵-10⁻² Hz with a 5 mV signal perturbation. A Jeol JSM-5900 Scanning Electron Microscope operating at 30 KeV was used for scanning electron microscopy.

The procedure for creating a catalyst includes preparing an electrodeposition solution containing dissolved metal salts with an electrolyte and adjusted pH as generally described in Example 1. The aqueous transition metal ions are deposited as metal oxides onto the working electrode with chronopotentiometry at high current densities. The standard electrodeposition conditions refer to the electrodeposition of catalysts at a current density of 250 mA/cm² for 30 s from a solution containing 18 mM of a first row transition metal sulfate salt (exceptions: TiOSO₄, VOSO₄, and Cr(ClO₄)₃), or 9 mM each for a pair of metals, 10 to 100 mM NH₄⁺ from a secondary electrolyte (NH₄ClO₄, NH₄NO₃, or (NH₄)₂SO₄), and adjusted from 0 to 9 pH with H₂SO₄ or NH₄OH. The electrodes and catalyst are thoroughly rinsed with water immediately following electrodeposition. Purified water (Barnstead, EASYpure UV) was used in all aspects of every experimental procedure. Linear voltammetry scans at rates of 1 to 3 mV/s are performed on the catalysts in 100 mL samples of 1 M KOH in atmospheric equilibrium and room temperature (295-298 K). Catalysts are discharged with a linear voltammetry scan from 0.400 to 0.500 V at 2 mV/s in the KOH electrolyte immediately preceding all reported linear voltammetry scans unless otherwise noted. Electrical impedance spectroscopy was measured from 10⁵ to 10⁻² Hz (20 data points per decade) with a ±5 mV perturbation amplitude. The high frequency limit and resolution represent the maximum capability of the Voltalab 10. Impedance scans were recorded in 10 mV increments of working potential and each scan was preceded with a 1.0 minute chrono coulometry scan to establish pre-equilibrium. Elemental analysis and SEM images of the optimized NiFe oxide and the bare platinum support were obtained with a Joel JSM-5900 Scanning Electron Microscope at 30 KeV.

As noted above, all experimental procedures concerning efficiency were carried out in 1M KOH at room temperature (22-25° C.) and pressure. Ambient 1M KOH was considered to have a pH of 13.84 as determined theoretically and experimentally by the ionic activity coefficients correlated with the Khoshkbarchi-Vera equation and New Hydration Theory (Rodil et al., AlChE Journal, (2001) 47(12): 2807-2818). Equation (24) was used to calculate the water reduction midpoint potential, E_{H2}, of −0.945 V when considering an atmospheric H₂ partial pressure of 5×10⁻⁵ atm (Pourbaix, supra):

E_{H2}=1.228 V−0.0591*pH−1.481 V−0.0295*log(pH₂)=−0.945 V (24)

Linear voltammetry scans at a rate of 1 mV/sec were used to measure the relationship of current density generated from oxygen evolution with respect to the working potential according to the method and technique of Example 1.

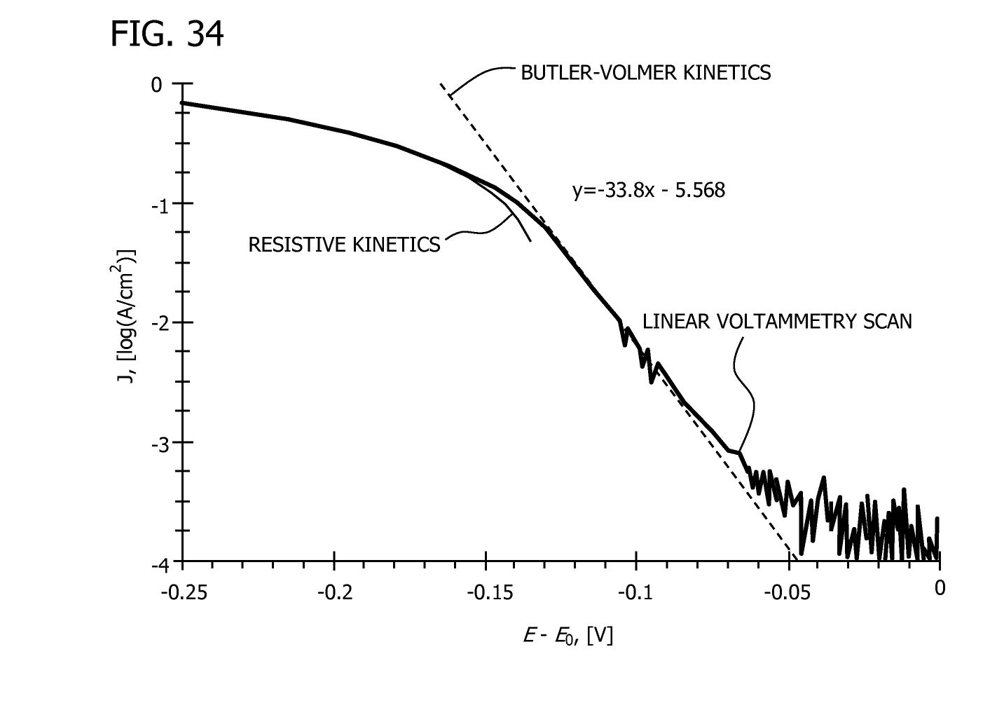

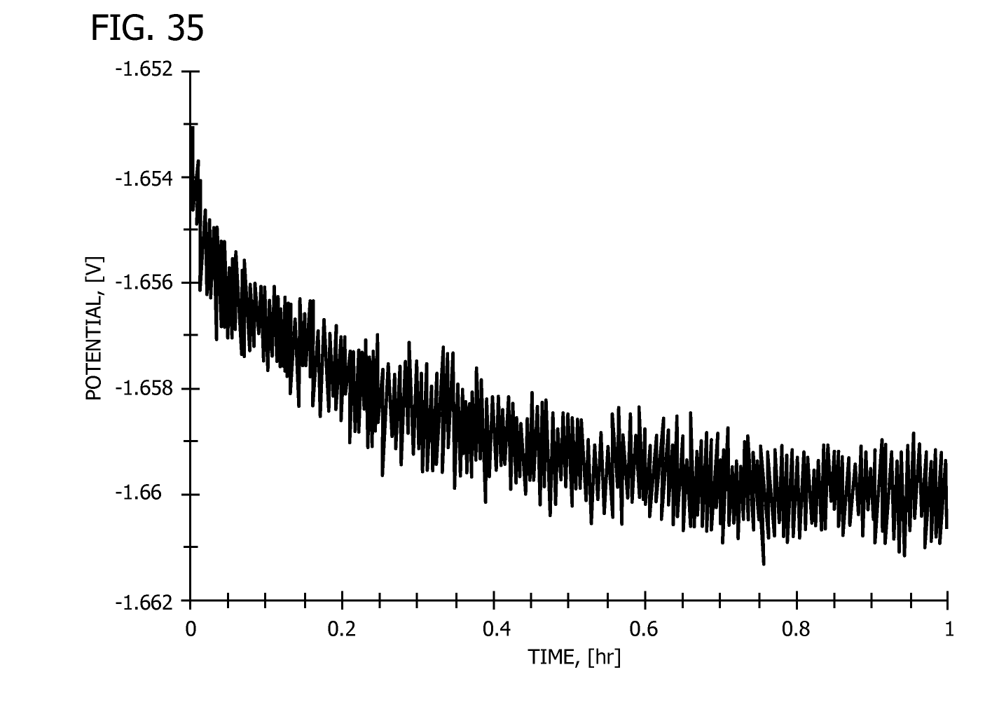

Current density was plotted against the difference between the midpoint potential for a reaction and the working potential applied to the electrode as a Tafel plot. A Tafel plot considering a hydrogen evolution midpoint potential, V₀, of −0.945 V is presented in FIG. 34 for the NiV oxide electrode (i.e., an electrode including an electrocatalytic film including a mixture of metal oxides having the formulae M¹O, (M²)₂O₃, (M³)₃O₄, and MO₂ and (L³)₃O₄, wherein M¹, M², M³, M⁴ and L³ are selected from Ni and V, provided L³ and M³ are not the same). Linear regression is performed on the experimental values for the over-potential in the range of −0.050 to −0.120 V where the kinetics follow a linear free energy relationship. The linear regression trendline and the corresponding equation are also presented in FIG. 34. The slope and Y-intercept of the Tafel plot trendline are applied to equation (4) where n=2 and produces an α of 1.00 and an exchange current, 10, of 1.24×10⁻³ mA/cm². The 99.9% pure platinum support alone yielded an α of 0.182 from −0.79 to −1.00 V. The NiV oxide catalyst was analyzed for stability with chrono potentiometry at a constant current density of 500 mA/cm² (see FIG. 35).

2.2 Catalyst Analysis

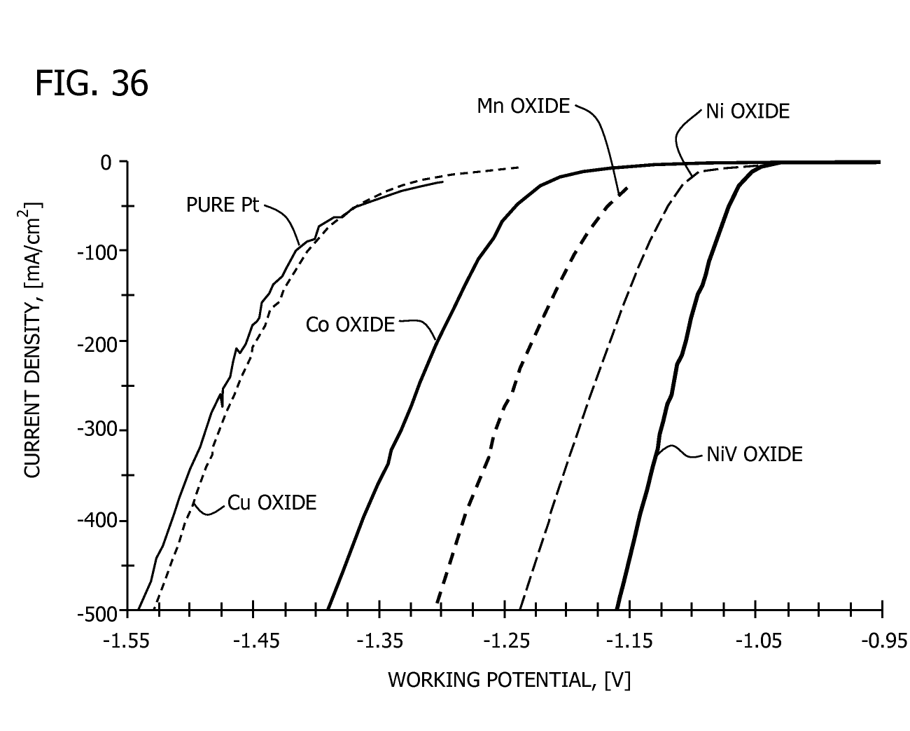

V, Cr, Mn, Fe, Co, Ni, Cu, NiFe, NiCo, VCr, NiV, NiCr, NiMn, CuCo and CuNi oxide catalysts were produced which demonstrated greater catalytic efficiency than the pure platinum control. The NiV oxide was found to have a particularly high catalytic efficiency and is thereby characterized as an example. The efficiencies of five selected thin metal oxide compositions are illustrated in FIG. 36. The α and I₀ values of all thirteen optimized metal compositions are provided in Table 6 so that the linear free energy relationship portion of Tafel plots can be reconstructed according to equation (13) for all metal compositions.

TABLE 6
LINEAR FREE ENERGY RELATIONSHIP A AND LOG(I₀)
PARAMETERS FOR OXYGEN EVOLUTION.

| Catalyst | | |
|---|---|---|
| composition | α | Log (I₀) |
| V | 0.542 | −4.65 |
| Cr | 0.535 | −4.82 |
| Mn | 0.418 | −3.30 |
| Co | 0.302 | −4.37 |
| Ni | 0.413 | −3.86 |
| Cu | 0.204 | −4.23 |
| VCr | 0.558 | −4.42 |
| NiV | 1.000 | −5.57 |
| NiFe | 0.987 | −6.16 |
| NiCo | 0.397 | −4.10 |
| NiCr | 0.844 | −5.86 |
| NiCu | 0.364 | −3.45 |
| NiMn | 0.907 | −5.52 |

Electrical impedance spectroscopy (EIS) was used to analyze the frequency-dependant kinetics of the NiV oxide matrix in 1 M KOH at room temperature and pressure. Each impedance scan measured from 10⁵ to 10⁻² Hz (20 data points per decade) with a 5 mV perturbation amplitude. While portions of some of the electrochemical impedance features are observed to extend to higher frequencies, the electrochemical workstation was limited to 10⁵ Hz. Impedance scans were recorded at working potentials ranging from −1.250 to −0.450 V in 10 mV increments. Each impedance scan was preceded with a 1.0 minute chrono coulometry scan at the respective working potential to establish pre-equilibrium. An electrochemical workstation safety mechanism response of “current disjunction” was found to cease the data collection program at both lower potentials and frequencies.

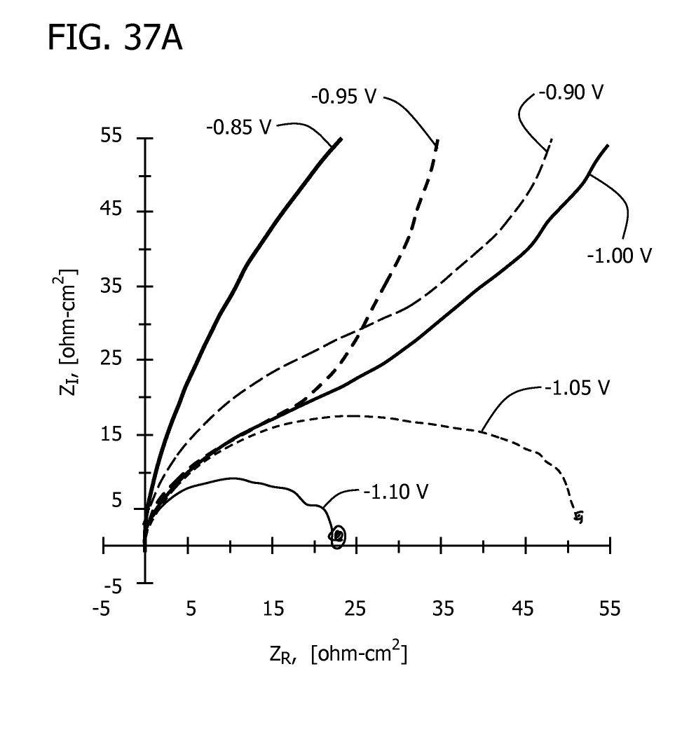

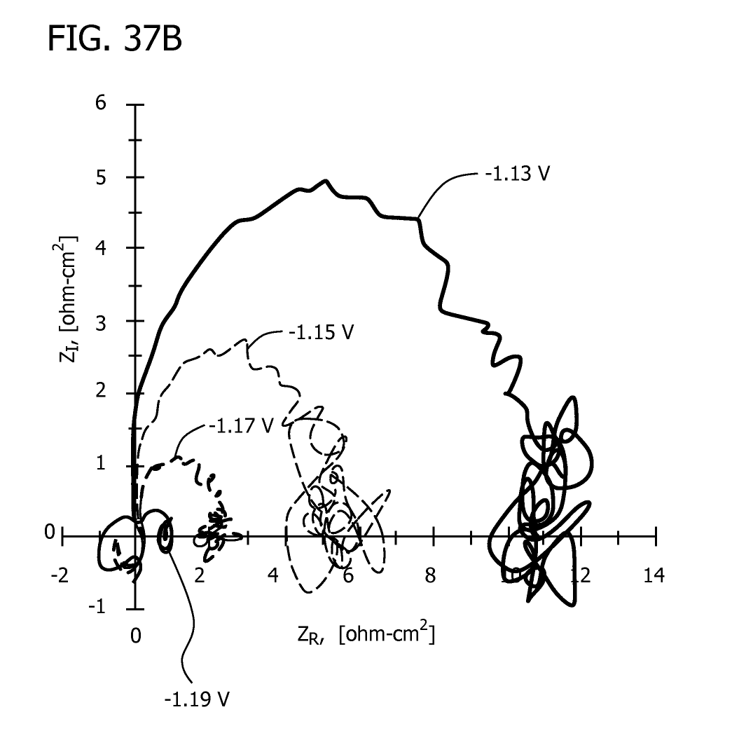

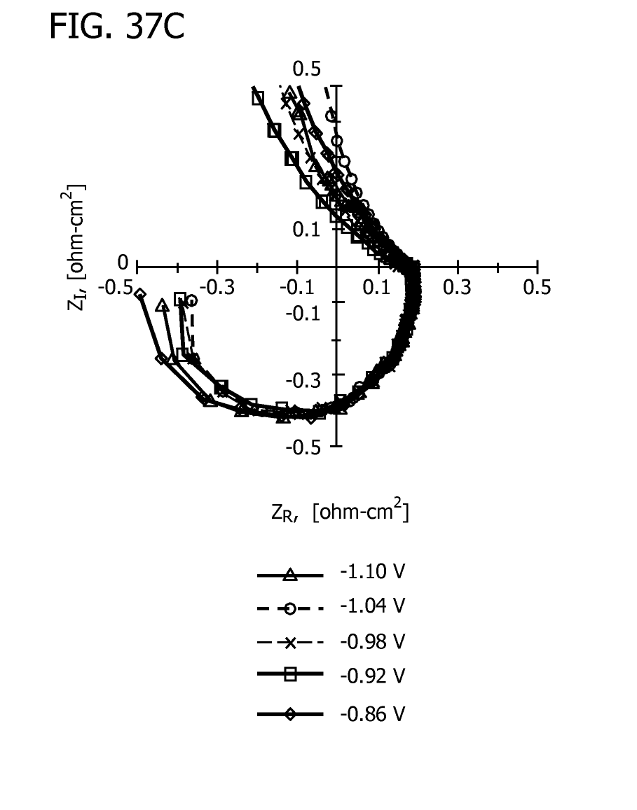

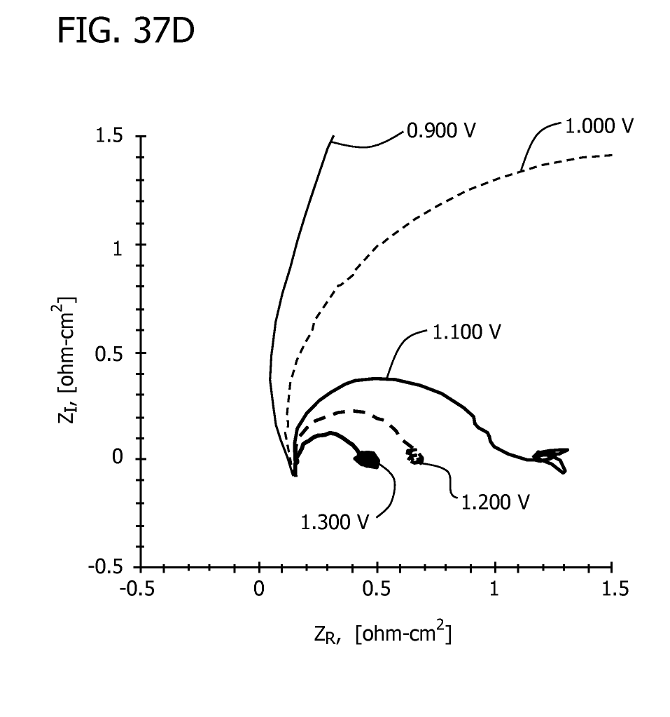

Nyquist plots present the real versus imaginary resistance components of the impedance-area for the electrode. Nyquist plots of −0.850 to −1.100 V and −1.130 to −1.190 V potential ranges are presented in FIGS. 37A and 37B, respectively. The higher frequencies appear in the inductive loop and the lower frequencies appear in the capacitive loop. The inductive loop for −0.860 to −1.100 V is more clearly represented in FIG. 37C. The inductive loop spans from >10⁵ Hz to ˜20² Hz and was considered a relatively significant part of the spectra. EIS was performed on the pure platinum support including the insulating backing from 0.900-1.500 V in 50 mV intervals. The inductive loop was not observed in the EIS spectra of the platinum without catalyst and was not considered an artifact of the experimental setup (FIG. 37D).

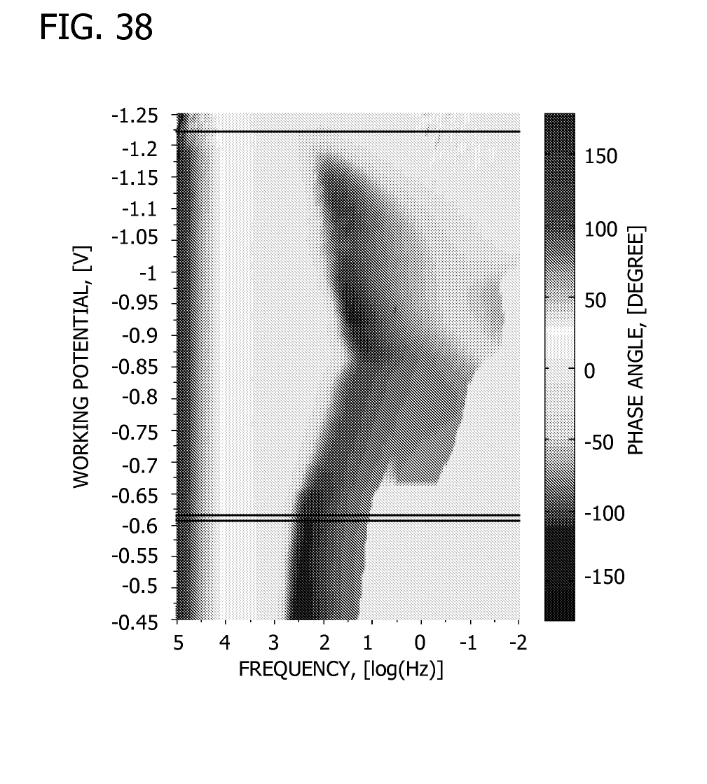

Electrochemical impedance spectroscopy (EIS) oscillates the working potential voltage with a set perturbation signal through a range of frequencies and measures phase angle, θ, and the impedance resistance scalar, Z, by which the resulting voltage and current sine waves are out of phase. The phase angle, θ, is reported here in degrees. FIG. 38 is a graph presenting the phase angle measured during impedance spectroscopy with respect to the log of frequency and the working potential. Data point values which could not be measured due to “current disjunction” were entered as −180° in FIG. 38, due to the nature of the graphics program.

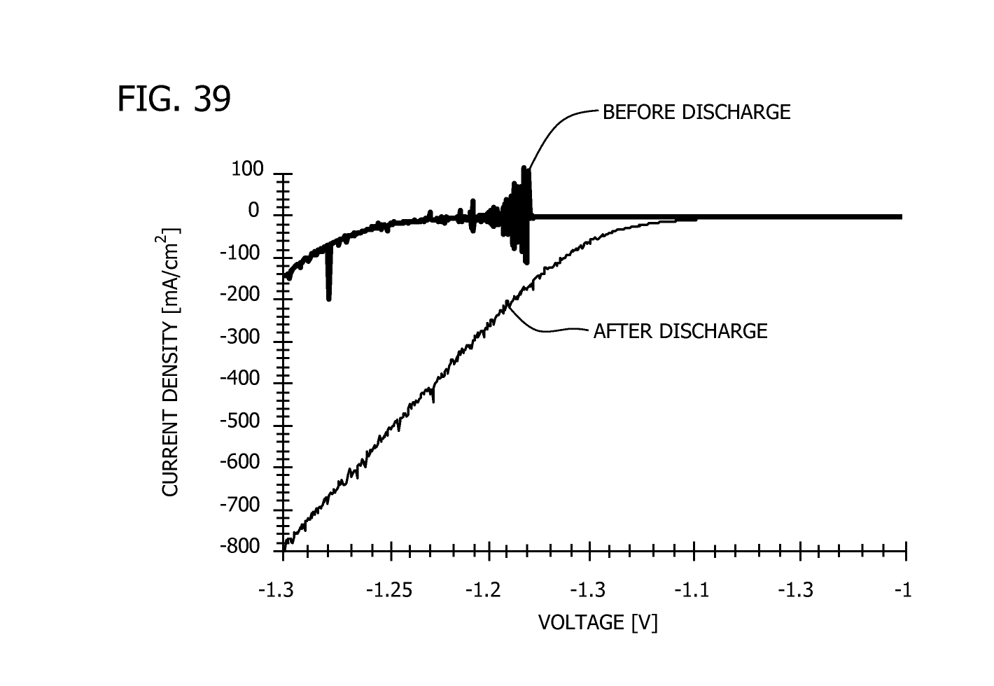

The effective catalysts are formed through a cathodic electrodeposition of aqueous first-row transition metal ions onto 1 cm² platinum foil at high current density. Elemental analysis verified that the purity of the platinum was greater than 99.95% Pt both prior to catalyst electrodeposition and after removal of the catalyst. An excess of positive charge results from the reductive electrodeposition for the hydrogen evolution catalysts. The excess charge is released from the catalyst by applying a sufficiently positive charge so that the catalyst evolves oxygen in the KOH electrolyte, similar to the oxygen evolution electrodes. The effect of the discharge on catalytic efficiency is illustrated in FIG. 39 with before and after linear voltammetry scans of a NiCo oxide catalyst. The efficiency of the catalysts were generally improved by discharging the catalysts after deposition with a linear voltammetry scan from 0.400 to 0.500 V at 2 mV/s in the KOH electrolyte.

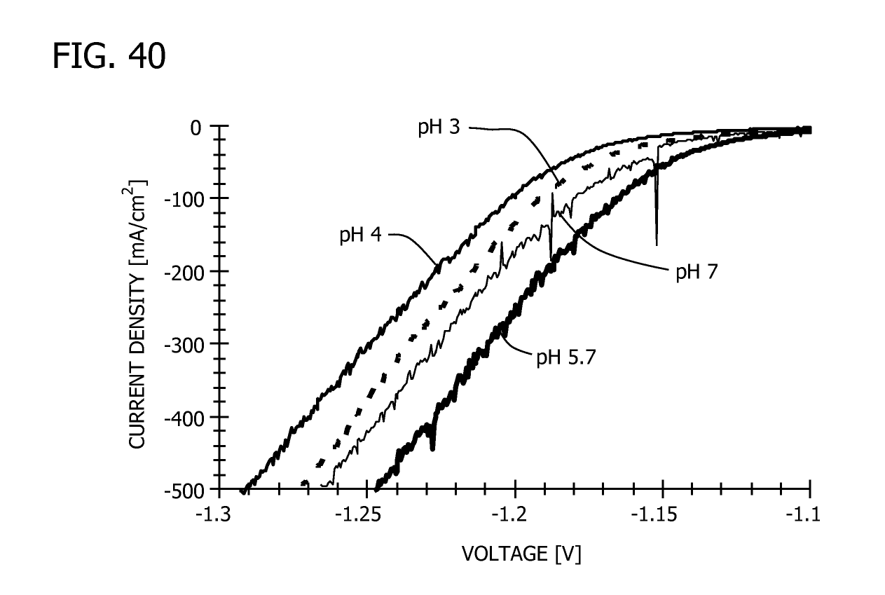

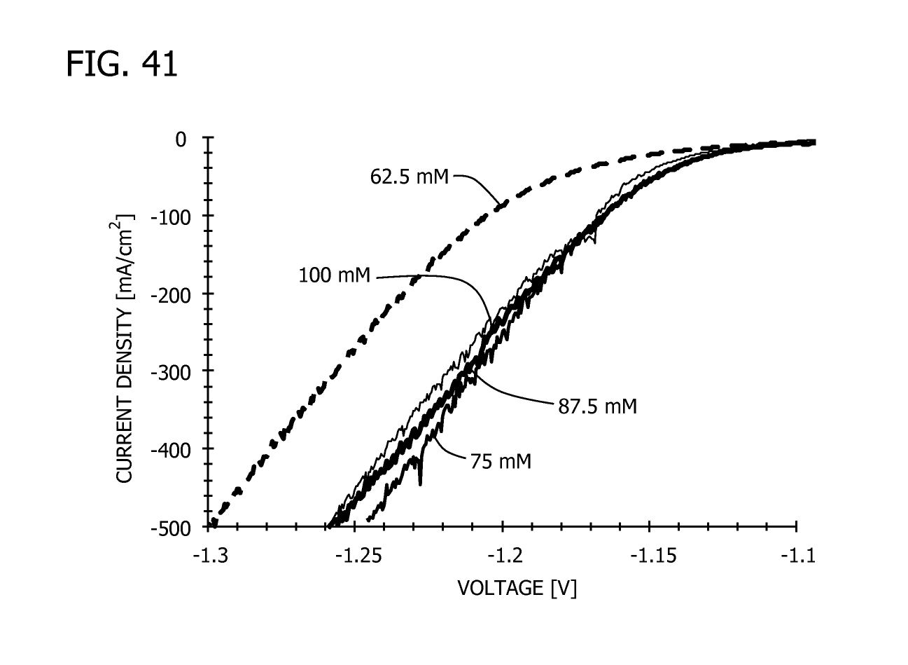

The catalytic efficiency of first-row transition metal elemental compositions was screened with an initial optimization procedure in which the pH and electrolyte concentrations of the electrodeposition solution are systematically adjusted. It has been determined that the inclusion of ammonium/hard anion electrolytes (such as, NH₄ClO₄, NH₄NO₃, and (NH₄)₂SO₄) in the electrodeposition solution yields superior catalytic efficiencies. The concentration of metal ions in the electrodeposition solution and the electrodeposition current density and duration are kept constant at standard conditions developed in previous work (see dissertation or oxygen evolution patent application). These standard conditions (18 mM for individual metal-oxides and 9 mM each for pairs of metal-oxides and an electrodeposition current density of 250 mA/cm² for 30 s) are empirically derived to minimize variables in the initial screening process. FIGS. 40 and 41 illustrate how the systematic adjustments of pH and ammonium electrolyte concentration affect hydrogen evolution efficiency for NiCo oxide catalysts.

2.3 Metal Oxide Development and Optimization

Catalyst optimization variables were similar to those described in Example 1. For hydrogen evolution catalysts, V, Cr, Mn, Fe, Co, Ni, Cu, NiFe, NiCo, VCr, NiV, NiCr, NiMn, CuCo and CuNi oxide catalysts were produced which demonstrated greater catalytic efficiency than the pure platinum control; the Ni oxide demonstrated the best catalytic efficiency when only a single transition metal element was in the catalyst. The addition of V, Cr, and Cu to nickel increased the catalytic efficiency of the catalysts.

2.4 Efficiency of Catalysts

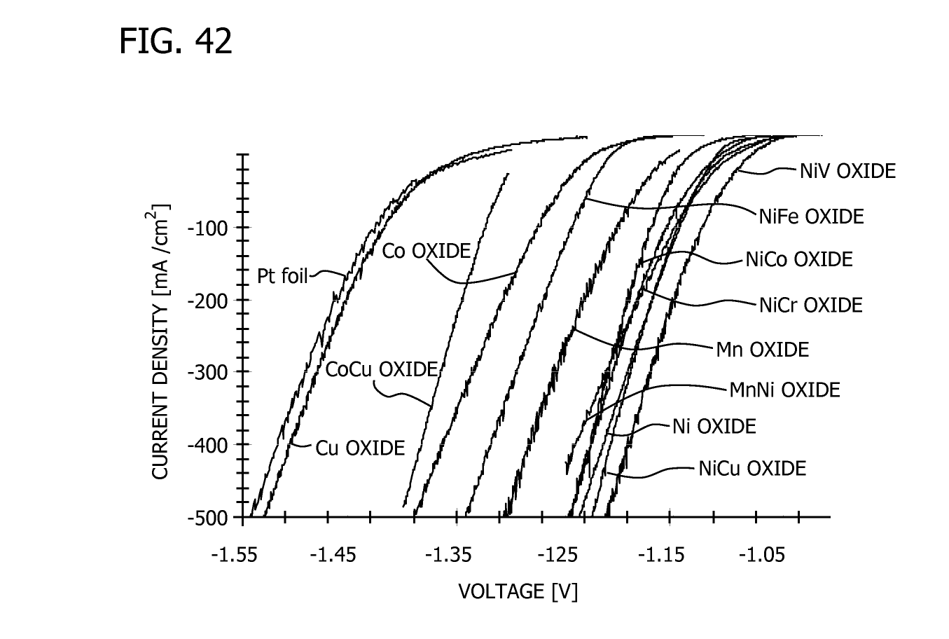

The nickel-vanadium oxides demonstrated particularly efficient hydrogen evolution catalysis, and were therefore selected for further analysis. The optimized NiV oxide catalyst demonstrated an electron transfer coefficient of 1 for the hydrogen evolution reaction and represents ideal electron transfer. Individual and pairs of first row transition metal oxide compositions have undergone the initial optimization process for screening hydrogen evolution efficiency. Ten of the eleven elemental compositions resulted in improved hydrogen evolution catalytic efficiencies as compared to the >99.95% pure platinum foil support without catalyst. The metal oxides which contained nickel resulted in particularly efficient hydrogen evolution catalysts (see FIG. 42).

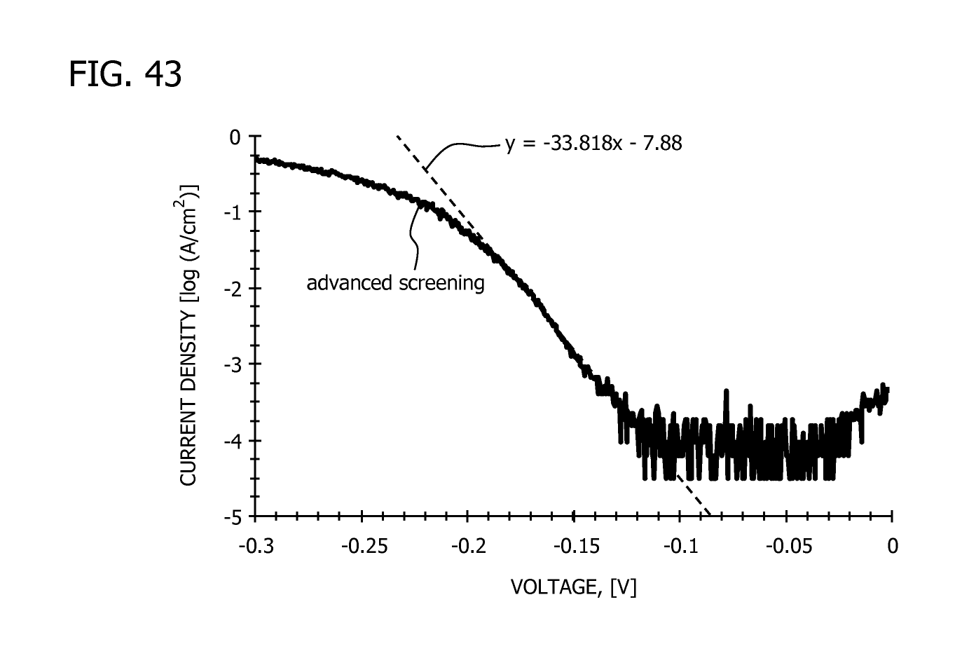

NiV oxide resulted in the best efficiency for hydrogen evolution catalysis and was selected to undergo a more thorough optimization procedure. This optimization procedure included investigating smaller incremental changes in pH and secondary electrolyte concentrations, investigating other electrolyte compositions and additional electrolytes, variations in the ratio of nickel to vanadium concentration in the electrodeposition solution, and variation in the metal salt composition (such as Ni(NO₃)₂ and NH₄VO₃). It was empirically determined that the electrodeposition solutions that produced the preferred NiV oxide catalysts included both an ammonium electrolyte ((NH₄)₂SO₄) and an organic non-electrolyte (C₂H₅OH). The resulting catalytic efficiency is illustrated as a Tafel plot in FIG. 43. Equation (13) is used to calculate the Tafel plot's hydrogen evolution midpoint potential (V₀). Equation (13) considers the pH of 1 M KOH to 13.84, an atmospheric H₂ partial pressure of 5×10⁻⁷ atm, and that water electrolysis occurs at water's ΔH (higher heating value) rather than water's ΔG (lower heating value) at room temperature. The Butler-Volmer model for electrode kinetics described by equation (25) assumes a negligible reverse current and is used to quantitatively assess catalytic efficiency. The Butler-Volmer model relates electrolysis kinetics with applied working potential based on semi-classical concepts according to equation (7) in which the rate of the reverse reaction is considered negligible, α_{c} is the cathodic charge transfer coefficient, I₀ is the exchange current density, and (V−V₀) is the overpotential. The line drawn in FIG. 43 represents a slope in which the cathodic charge transfer coefficient, α_{c}, is ideal (1) and n=2 for the hydrogen evolution reaction.

$$\begin{matrix}\begin{matrix}{E}_{H 2} = 1.228 V - 0.0591 \cdot pH - 1.481 V - \\ 0.0295 \cdot log ( {pH}_{2} ) \\ = - 0.885 V\end{matrix} & ( 13 ) \\ ln ( \frac{I}{{I}_{o}} ) = \frac{- {α}_{c} n F}{RT} & ( 25 )\end{matrix}$$

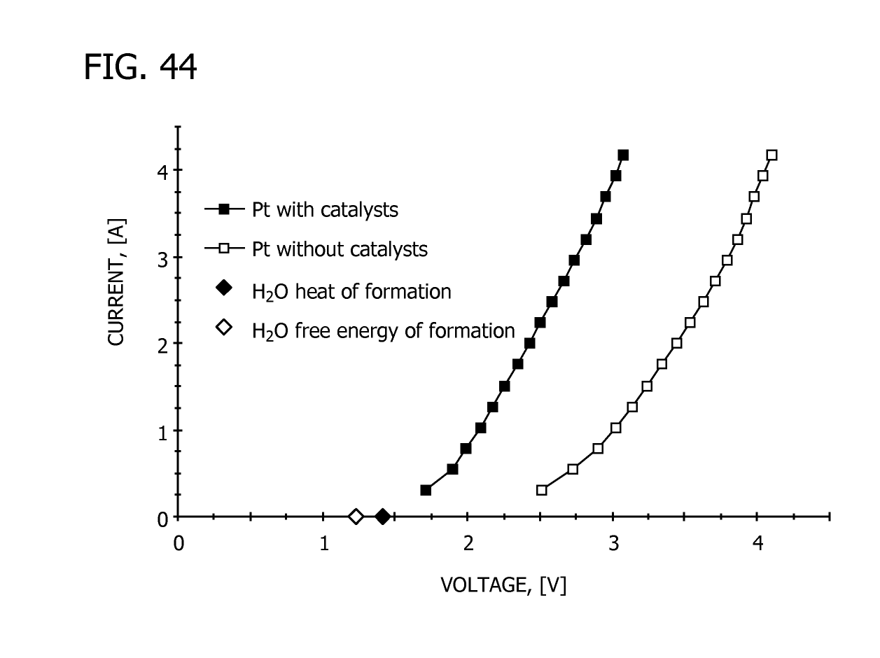

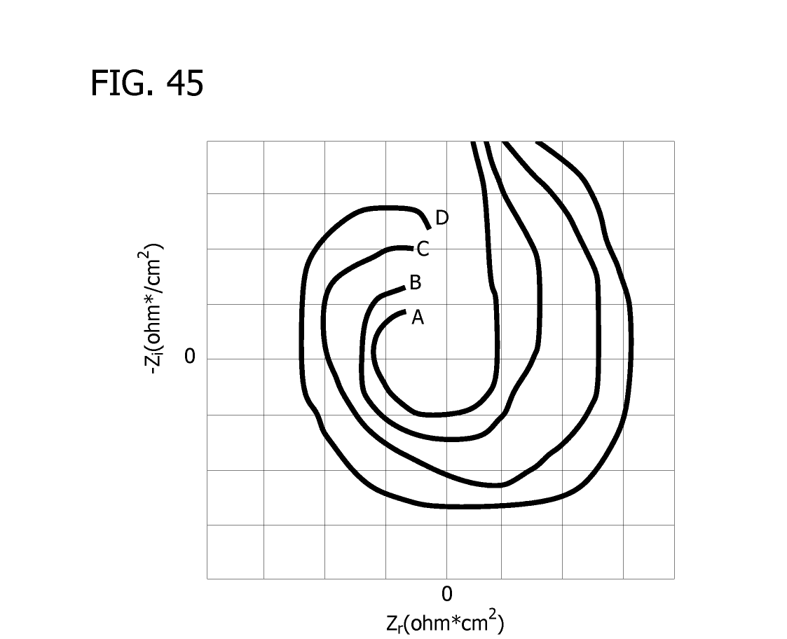

The efficiency of alkaline water electrolysis was obtained combining the NiV oxide hydrogen evolution catalyst of this work with the NiFe oxide oxygen evolution catalysts of previous work. The catalysts were each deposited onto both the front and back of a 4 cm×2.5 cm×250 μm platinum foil for a total cathodic and anodic surface area of 20 cm2 each. The electrodes were immersed into a 400 ml volume of fresh KOH and spaced 1 cm apart. The efficiency of water electrolysis was measured though an automated program comprised of a series of chronopotentiometric scans in which any drift in voltage was accounted for with a moving average. The voltage was recorded and presented in FIG. 44 was obtained for each current density when working voltage was equal to the average voltage for the preceding 5 minutes with a resolution of 0.00125 V. The presence of the metal oxide catalysts improves voltage required for water electrolysis by 22 to 29%. The voltages considered for ΔG_{H2O} (1.228 V) and ΔH_{H2O} (1.428 V) are also indicated in FIG. 44.

2.5 Nickel-Vanadium Catalytic Mechanism of Water Oxidation

Pourbaix reported the stoichiometric equations describing the oxidation by water of these first-row transition metals in aqueous solid oxide complexes (Pourbaix, supra). The greatest efficiencies were demonstrated by the nickel oxide and combination of nickel oxides with other first row transition metal oxides. The solid, stable, higher oxidation states which are shared the first row metals ranging from V to Cu are the MO, M₃O₄, M₂O₃ and MO₂ states. Each of the possible oxidations is achieved with the consumption of one reactant water molecule and the production of two electrons and two protons. The possibility of metal ions clustering in the molecular level is supported by an observation made during preparation of the electrodeposition solution. An improvement in catalytic efficiency resulted when the nickel and vanadium were buffered and pH-adjusted before combination with the other metal of the pair.

The phase angle measured in impedance spectroscopy changes with respect to the applied working potential and frequency. Changes in the phase angle with respect to working potential can be correlated with the potentials of known redox reactions to identify reactions involved with the catalytic mechanism(s). FIG. 38 illustrates how the phase angle changes correlate with the reverse of reaction (26), reaction (27), and reaction (28). Reaction (28) is the combination of the reverse of reaction (26) and reaction (27). Reaction (29) is the proposed catalytic mechanism. Reaction (29) is the combination of reaction (28) and the hydrogen evolution reaction. The catalytic mechanisms of the other catalyst compositions are not necessarily the same as the NiV oxide catalytic mechanism.

2NiO₂+2H⁺+2 e⁻→Ni₂O₃+H₂O (26a)

E₍₂₆₎=1.434 V−0.0591*pH=0.615 V₍₂₆₎ (26b)

2VO₂+2H⁺+2 e⁻→V₂O₃+H₂O (27a)

E₍₂₇₎=0.210 V−0.0591*pH=−0.608 V₍₂₇₎ (27b)

Ni₂O₃+2VO₂+2H⁺+2e⁻→NiO₂+V₂O₃+2e⁻ (28a)

E₍₂₈₎=−0.608 V₍₂₇₎−0.615 V₍₂₆₎=−1.223 V₍₂₈₎ (28b)

Ni₂O₃+2VO₂+2H⁺+2e⁻→NiO₂+V₂O₃+H₂ (29a)

E₍₂₉₎=−0.608 V₍₂₇₎−0.615 V₍₂₆₎−−0.945 V_{(H2)}=−0.278 V₍₂₉₎ (29b)

2.6 Discussion

The methods for optimizing hydrogen evolution catalytic efficiency were derived from the methods developed for optimizing oxygen evolution catalytic efficiency (see Example 1). The electrodeposition variables for hydrogen evolution catalysts have resulted in optimal conditions very similar to the oxygen evolution catalysts (see dissertation or previous patent) including electrodeposition current density and duration, electrolyte compositions and concentrations, and pH.

The initial screening process for determining the best metal oxides for catalyzing alkaline hydrogen evolution resulted in a NiV oxide. A more thorough optimization of the NiV oxide electrodeposition variables further improved the higher current densities ˜20 mV and has produced approximately ideal charge transfer coefficients (see FIG. 43). FIG. 43 does indicate that an overpotential of 0.075 to 0.100 V is associated with the NiV oxide catalyst. This overpotential may result from using an atmospheric partial pressure of 5×10⁻⁷ ATM H₂ in equation (13) where even small currents can increase the partial pressure of H₂ at the catalyst therefore shifting the reduction potential to more negative values. The cell potential measured for water electrolysis using a NiV oxide hydrogen evolution catalyst and a NiFe oxide oxygen evolution catalyst indicates little overvoltage when compared to either the ΔG or even the ΔH of water formation. The currents illustrated in FIG. 44 represent the smallest current and current increments available for the power supply.

What is claimed is:

1. A composite comprising a substrate having an electrically conductive region and a film deposited on a surface of the electrically conductive region, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

2. The composite of claim 1 wherein the film further contains at least one metal oxide having the formula LₓO_{y}, wherein L is a first, second, or third row transition metal, x is a positive integer from 1 to 3, and Y is a positive integer from 1 to 7, provided that M and L are not the same transition metal.

3. The composite of claim 2 wherein the film contains at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, M⁴, L¹, L², L³, and L⁴ are independently selected from first row transition metals, provided that (i) M¹ and L¹; (ii) M² and L²; (iii) M³ and L³; and (iv) L⁴ and M⁴ are not the same transition metal.

4. The composite of claim 1 wherein the film contains a mixture of metal oxides having the formulae: M¹O, (M²)₂O₃, and (M³)₃O₄, wherein M¹, M², and M³, independently selected from first row transition metals.

5. The composite of claim 1 wherein the film contains a mixture of metal oxides having the formulae: M¹O, (M²)₂O₃, (M³)₃O₄, and (L³)₃O₄, wherein M¹, M², M³, and L³ are independently selected from first row transition metals, provided that L³ and M³ are not the same transition metal.

6. The composite of claim 1 wherein the film contains a mixture of metal oxides having the formulae: (M²)₂O₃, (M⁴)O₂, (L²)₂O₃, and (L⁴)O₂, wherein M², M⁴, L², and L⁴ are independently selected from first row transition metals, provided that (i) M² and L², and (ii) M⁴ and L⁴ are not the same transition metal.

7. The composite of claim 4 wherein M¹, M², and M³ are the same transition metal and are selected from V, Cr, Mn, Fe, Co, Ni, and Cu.

8. The composite of claim 5 wherein M¹ and M³ are the same transition metal and are selected from V, Cr, Mn, Fe, Co, Ni, and Cu; and M² and L³ are the same transition metal and are selected from V, Cr, Mn, Fe, Co, Ni, and Cu, provided that (i) M¹ and M², and (ii) M³ and L³ are not the same transition metal.

9. The composite of claim 6 wherein M² and M⁴ are the same transition metal and are selected from V, Cr, Mn, Fe, Co, Ni, and Cu; and L² and L⁴ are the same transition metal and are selected from V, Cr, Mn, Fe, Co, Ni, and Cu, provided that (i) M² and L², and (ii) M⁴ and L⁴ are not the same transition metal.

10. The composite of claim 5 wherein the mixture of metal oxides is selected from the group consisting of:
(1a) MnO, Fe₂O₃, Fe₃O₄, and Mn₃O₄;
(1b) FeO, Mn₂O₃, Mn₃O₄, and Fe₃O₄;
(2a) CoO, Fe₂O₃, Co₃O₄, and Fe₃O₄;
(2b) FeO, Co₂O₃, Fe₃O₄, and Co₃O₄;
(3a) NiO, Fe₂O₃, Ni₃O₄, and Fe₃O₄;
(3b) FeO, Ni₂O₃, Fe₃O₄, and Ni₃O₄;
(4a) NiO, Co₂O₃, Ni₃O₄, and Co₃O₄;
(4b) CoO, Ni₂O₃, Co₃O₄, and Ni₃O₄;
(5a) CuO, Fe₂O₃, Cu₃O₄, and Fe₃O₄;
(5b) FeO, Cu₂O₃, Fe₃O₄, and Cu₃O₄;
(6a) CuO, Ni₂O₃, Cu₃O₄, and Ni₃O₄; and
(6b) NiO, Cu₂O₃, Ni₃O₄, and Cu₃O₄.

11. The composite of claim 10 wherein the mixture of metal oxides is selected from (3a) NiO, Fe₂O₃, and Ni₃O₄, and Fe₃O₄; (3b) FeO, Ni₂O₃, Fe₃O₄, and Ni₃O₄; and combinations thereof.

12. The composite of claim 6 wherein the mixture of metal oxides is selected from the group consisting of
(7) Ni₂O₃, VO₂, NiO₂, and V₂O₃;
(8) Ni₂O₃, CrO₂, NiO₂, and Cr₂O₃;
(9) Co₂O₃, CuO₂, CoO₂, and Cu₂O₃;
(10) Mn₂O₃, NiO₂, MnO₂, and Ni₂O₃;
(11) Ni₂O₃, FeO₂, NiO₂, and Fe₂O₃;
(12) Ni₂O₃, CoO₂, NiO₂, and Co₂O₃; and
(13) Cu₂O₃, NiO₂, CuO₂, and Ni₂O₃.

13. The composite of claim 12 wherein the mixture of metal oxides is (7) Ni₂O₃, VO₂, NiO₂, and V₂O₃.

14. The composite of claim 1 wherein the electrically conductive region of the substrate comprises a metal selected from the group consisting of aluminum, titanium, vanadium, chromium, manganese, iron, cobalt, nickel, copper, zinc, zirconium, niobium, molybdenum, ruthenium, rhodium, palladium, silver, tantalum, tungsten, osmium, iridium, platinum, gold, tin, and bismuth and metal oxides, mixtures of said metals and metal oxides, and alloys of said metals.

15. A process for the preparation of a composite, the process comprising depositing a film on a surface of an electrically conductive region of a substrate, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

16. The process of claim 15 wherein the composite is prepared by an electrodeposition process comprising:
(i) immersing the electrically conductive region in an electrolytic deposition bath containing first, second, or third row transition metal ions; and
(ii) passing an electric current through the electrically conductive region to electrodeposit at least one metal oxide having the formula: MₓO_{y} on the surface of the electrically conductive region, wherein the density of the current at the surface of the region is at least 25 mA/cm².

17. The process of claim 16 wherein the film further contains at least one metal oxide having the formula LₓO_{y}, wherein L is a first, second, or third row transition metal, x is a positive integer from 1 to 3, and Y is a positive integer from 1 to 7, provided that M and L are not the same transition metal.

18. The process of claim 16 wherein the film contains at least one metal oxide selected from those having the formulae: M¹O, (M²)₂O₃, (M³)₃O₄, and (M⁴)O₂; and at least one metal oxide selected from those having the formulae: L¹O, (L²)₂O₃, (L³)₃O₄, and (L⁴)O₂; wherein M¹, M², M³, M⁴, L¹, L², L³, and L⁴ are independently selected from first row transition metals, provided that (i) M¹ and L¹; (ii) M² and L²; (iii) M³ and L³; and (iv) L⁴ and M⁴ are not the same transition metal.

19. The process of claim 16 wherein the transition metal ions are selected from ions of V, Cr, Mn, Fe, Co, Ni, and Cu and combinations thereof.

20. An electrode, the electrode comprising a layer deposited on a surface of an electrically conductive support, the layer containing at least one metal oxide having the formula: MₓO_{y}, wherein M is a first, second, or third row transition metal, x is a positive integer from 1 to 3, and y is a positive integer from 1 to 7, wherein the layer is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

21. The electrode of claim 20 wherein the layer further contains at least one metal oxide having the formula: LₓO_{y}, wherein L is a first, second, or third row transition metal, x is a positive integer from 1 to 3, and Y is a positive integer from 1 to 7, provided that M and L are not the same transition metal.

22. A fuel cell comprising an anode, a cathode, a proton exchange membrane between the anode and the cathode, and an electrocatalyst for the catalytic oxidation of a hydrogen-containing fuel, the fuel cell characterized in that the electrocatalyst comprises a film deposited on a surface of an electrically conductive region of (i) the anode, (ii) the cathode, or (iii) both the anode and the cathode, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

23. The fuel cell of claim 22 wherein the film further contains at least one metal oxide having the formula LₓO_{y}, wherein L is a first, second, or third row transition metal, x is a positive integer from 1 to 3, and Y is a positive integer from 1 to 7, provided that M and L are not the same transition metal.

24. A method for the electrochemical conversion of a hydrogen-containing fuel and oxygen to water and electricity in a fuel cell comprising an anode, a cathode, a proton exchange membrane between the anode and the cathode, and an electrically conductive external circuit connecting the anode and the cathode, the method comprising contacting the hydrogen-containing fuel with an electrocatalyst to catalytically oxidize the fuel, the method characterized in that the electrocatalyst comprises a film deposited on a surface of an electrically conductive region of (i) the anode, (ii) the cathode, or (iii) both the anode and the cathode, the film containing at least one metal oxide having the formula: MₓO_{y}, wherein M is a first, second, or third row transition metal, x is a positive integer from 1 to 3, and y is a positive integer from 1 to 7, wherein the film is ferromagnetic, ferrimagnetic, or both ferromagnetic and ferrimagnetic at temperatures greater than 0° C. and has a zero field magnetization of 0.001 emu/g or greater at a temperature of 26.85° C. (300 K).

25. The method of claim 24 wherein the film further contains at least one metal oxide having the formula LₓO_{y}, wherein L is a first, second, or third row transition metal, x is a positive integer from 1 to 3, and Y is a positive integer from 1 to 7, provided that M and L are not the same transition metal.
